(19) United States
(12) Patent Application Publication
(10) Pub. No.: US 2025/0054514 A1
(43) Pub. Date: Feb. 13, 2025

(54) SIGNAL PROCESSING DEVICE, MAGNETIC TAPE DRIVE, MAGNETIC TAPE, MAGNETIC TAPE CARTRIDGE, SIGNAL PROCESSING METHOD, MAGNETIC TAPE MANUFACTURING METHOD, AND PROGRAM

(71) Applicant: FUJIFIM Corporation, Tokyo (JP)

(72) Inventors: Toru NAKAO, Kanagawa (JP); Norihito Kasada, Kanagawa (JP); Junichi Nakamigawa, Kanagawa (JP)

(73) Assignee: FUJIFIM Corporation, Tokyo (JP)

(21) Appl. No.: 18/925,628

(22) Filed: Oct. 24, 2024

Related U.S. Application Data
(63) Continuation of application No. PCT/JP2023/014929, filed on Apr. 12, 2023.

(30) Foreign Application Priority Data
Apr. 27, 2022 (JP) 2022-073647

(51) Int. Cl. G11B 5/584; G11B 5/008

(52) U.S. Cl. CPC G11B 5/584; G11B 5/00813

(57) ABSTRACT

A processor acquires a first signal based on a first result of reading a servo pattern via a first servo reading element while a first servo reading element is positioned on a reference region of a magnetic tape, acquires a second signal based on a second result of reading a servo pattern via a second servo reading element while a second servo reading element is positioned on the reference region, and executes, based on a servo band interval signal corresponding to a servo band interval according to the first signal and the second signal, processing of skewing a magnetic head according to the servo band interval.

### CROSS-REFERENCE TO RELATED APPLICATIONS

This application is a continuation application of International Application No. PCT/JP2023/014929, filed Apr. 12, 2023, the disclosure of which is incorporated herein by reference in its entirety. Further, this application claims priority from Japanese Patent Application No. 2022-073647, filed Apr. 27, 2022, the disclosure of which is incorporated herein by reference in its entirety.

### BACKGROUND

### 1. Technical Field

The technology of the present disclosure relates to a signal processing device, a magnetic tape drive, a magnetic tape, a magnetic tape cartridge, a signal processing method, a magnetic tape manufacturing method, and a program.

### 2. Related Art

JP2020-170582A discloses a magnetic tape cartridge comprising: a magnetic tape including a plurality of servo bands on which servo patterns are recorded and a data band that is provided between the servo bands and on which data is recorded; and a recording medium on which servo band interval-related information is recorded, the servo band interval-related information including an interval in a direction corresponding to a width direction of the magnetic tape between adjacent servo recording elements in a plurality of servo recording elements for recording the servo patterns on each of the plurality of servo bands.

JP2021-039814A discloses a recording and reproducing apparatus comprising: a magnetic head which is used in a magnetic tape, in which a servo band on which a servo pattern is recorded and a data band having a plurality of data tracks on which data is recorded are alternately arranged along a width direction, and which includes a recording and reproducing element which records or reproduces data with respect to the data track and at least two servo reproducing elements which read servo patterns adjacent to each other in the width direction of the magnetic tape, respectively; a selection unit which selects one or two servo reproducing elements from the servo reproducing elements of the magnetic head according to a position of the data track, as a target of recording or reproducing of data in the data band, along the width direction; and a controller which controls positioning of the magnetic head along the width direction by using a result of reading of the servo patterns by the servo reproducing element selected by the selection unit.

### SUMMARY

One embodiment according to the technology of the present disclosure provides a signal processing device, a magnetic tape drive, a magnetic tape, a magnetic tape cartridge, a program, a signal processing method, and a magnetic tape manufacturing method that implement skew control taking into consideration a servo band interval between servo bands adjacent to each other in a width direction of a magnetic tape.

According to a first aspect according to the technology of the present disclosure, there is provided a signal processing device comprising: a processor that acquires and processes data read by a magnetic head from a magnetic tape on which a plurality of servo bands are formed, in which the plurality of servo bands are disposed at intervals in a width direction of the magnetic tape, a plurality of servo patterns are formed in each of the plurality of servo bands along a longitudinal direction of the magnetic tape, the magnetic head has a pair of servo reading elements corresponding to a pair of servo bands adjacent to each other in the width direction among the plurality of servo bands, a first servo reading element included in the pair of servo reading elements reads the servo pattern included in a first servo band included in the pair of servo bands, a second servo reading element included in the pair of servo reading elements reads the servo pattern included in a second servo band included in the pair of servo bands, and the processor acquires a first signal based on a first result of reading the servo pattern in the first servo band via the first servo reading element while the first servo reading element is positioned on a reference region of the magnetic tape, acquires a second signal based on a second result of reading the servo pattern in the second servo band via the second servo reading element while the second servo reading element is positioned on the reference region, and executes skew processing for a skew mechanism that skews the magnetic head based on a servo band interval signal corresponding to a servo band interval according to the first signal and the second signal, the skew processing being processing of skewing the magnetic head according to the servo band interval.

A second aspect according to the technology of the present disclosure provides the signal processing device according to the first aspect, in which the servo band interval is used in common for a plurality of division areas obtained by dividing a data band in the width direction of the magnetic tape, and is a representative interval between a first servo pattern, which is the servo pattern in the first servo band of the pair of servo bands adjacent to each other via the data band, and a second servo pattern, which is the servo pattern in the second servo band of the pair of servo bands.

A third aspect according to the technology of the present disclosure provides the signal processing device according to the second aspect, in which the representative interval is obtained by statistically processing results of measuring an interval between the first servo pattern and the second servo pattern for each of the division areas in a case where the magnetic tape is run.

A fourth aspect according to the technology of the present disclosure provides the signal processing device according to the second or third aspect, in which the representative interval is obtained by statistically processing results of measuring an interval between the first servo pattern and the second servo pattern in a partial section of the division areas along a running direction of the magnetic tape for each of the division areas in a case where the magnetic tape is run.

A fifth aspect according to the technology of the present disclosure provides the signal processing device according to the second or third aspect, in which the representative interval is obtained by statistically processing results of measuring an interval between the first servo pattern and the second servo pattern in an entire section of the division areas along a running direction of the magnetic tape for each of the division areas in a case where the magnetic tape is run.

A sixth aspect according to the technology of the present disclosure provides the signal processing device according to any one of the second to fifth aspects, in which the representative interval is an average value of results of measuring an interval between the first servo pattern and the second servo pattern for each of the division areas in a case where the magnetic tape is run.

A seventh aspect according to the technology of the present disclosure provides the signal processing device according to any one of the first to sixth aspects, in which the reference region is a BOT region.

An eighth aspect according to the technology of the present disclosure provides the signal processing device according to any one of the first to seventh aspects, in which the processor stores the servo band interval signal in a storage medium.

A ninth aspect according to the technology of the present disclosure provides the signal processing device according to the eighth aspect, in which the magnetic tape is accommodated in a magnetic tape cartridge, the magnetic tape cartridge is provided with a noncontact storage medium that is able to perform communication in a noncontact manner, and the storage medium includes the noncontact storage medium.

A tenth aspect according to the technology of the present disclosure provides the signal processing device according to the eighth or ninth aspect, in which the storage medium includes a partial region of the magnetic tape.

According to an eleventh aspect according to the technology of the present disclosure, there is provided a magnetic tape drive in which skew processing is performed by the signal processing device according to any one of the first to tenth aspects.

According to a twelfth aspect according to the technology of the present disclosure, there is provided a magnetic tape comprising: a plurality of servo bands formed thereon, in which the plurality of servo bands are disposed at intervals in a width direction of the magnetic tape, a plurality of servo patterns are formed in each of the plurality of servo bands along a longitudinal direction of the magnetic tape, and a servo band interval between a pair of servo bands adjacent to each other in the width direction among the plurality of servo bands corresponds to the servo band interval signal obtained from the signal processing device according to any one of first to tenth aspects.

A thirteenth aspect according to the technology of the present disclosure provides the magnetic tape according to the twelfth aspect, in which the servo band interval signal is stored in a partial region of the magnetic tape.

A fourteenth aspect according to the technology of the present disclosure provides the magnetic tape according to the thirteenth aspect, in which the partial region is a BOT region and/or an EOT region.

According to a fifteenth aspect according to the technology of the present disclosure, there is provided a magnetic tape cartridge comprising: the magnetic tape according to any one of the twelfth to fourteenth aspects accommodated therein.

According to a sixteenth aspect according to the technology of the present disclosure, there is provided a magnetic tape cartridge comprising: a noncontact storage medium that is able to perform communication in a noncontact manner, in which the servo band interval signal obtained from the signal processing device according to any one of the first to tenth aspects is stored in the noncontact storage medium.

According to a seventeenth aspect according to the technology of the present disclosure, there is provided a signal processing method comprising: acquiring and processing data read by a magnetic head from a magnetic tape on which a plurality of servo bands are formed, in which the plurality of servo bands are disposed at intervals in a width direction of the magnetic tape, a plurality of servo patterns are formed in each of the plurality of servo bands along a longitudinal direction of the magnetic tape, the magnetic head has a pair of servo reading elements corresponding to a pair of servo bands adjacent to each other in the width direction among the plurality of servo bands, a first servo reading element included in the pair of servo reading elements reads the servo pattern included in a first servo band included in the pair of servo bands, a second servo reading element included in the pair of servo reading elements reads the servo pattern included in a second servo band included in the pair of servo bands, and the signal processing method includes acquiring a first signal based on a first result of reading the servo pattern in the first servo band via the first servo reading element while the first servo reading element is positioned on a reference region of the magnetic tape, acquiring a second signal based on a second result of reading the servo pattern in the second servo band via the second servo reading element while the second servo reading element is positioned on the reference region, and executing skew processing for a skew mechanism that skews the magnetic head based on a servo band interval signal corresponding to a servo band interval according to the first signal and the second signal, the skew processing being processing of skewing the magnetic head according to the servo band interval.

According to an eighteenth aspect according to the technology of the present disclosure, there is provided a magnetic tape manufacturing method comprising: recording the servo pattern in accordance with the servo band interval signal obtained from the signal processing device according to any one of the first to tenth aspects.

According to a nineteenth aspect according to the technology of the present disclosure, there is provided a magnetic tape on which the servo pattern is recorded in accordance with the servo band interval signal obtained by using the signal processing method according to the seventeenth aspect.

According to a twentieth aspect according to the technology of the present disclosure, there is provided a magnetic tape manufacturing method comprising: recording the servo pattern on a magnetic tape in accordance with the servo band interval signal obtained by using the signal processing method according to the seventeenth aspect.

According to a twenty-first aspect according to the technology of the present disclosure, there is provided a program for causing a computer to execute signal processing comprising: acquiring and processing data read by a magnetic head from a magnetic tape on which a plurality of servo bands are formed, in which the plurality of servo bands are disposed at intervals in a width direction of the magnetic tape, a plurality of servo patterns are formed in each of the plurality of servo bands along a longitudinal direction of the magnetic tape, the magnetic head has a pair of servo reading elements corresponding to a pair of servo bands adjacent to each other in the width direction among the plurality of servo bands, a first servo reading element included in the pair of servo reading elements reads the servo pattern included in a first servo band included in the pair of servo bands, a second servo reading element included in the pair of servo reading elements reads the servo pattern included in a second servo band included in the pair of servo bands, and the signal processing includes acquiring a first signal based on a first result of reading the servo pattern in the first servo band via the first servo reading element while the first servo reading element is positioned on a reference region of the magnetic tape, acquiring a second signal based on a second result of reading the servo pattern in the second servo band via the second servo reading element while the second servo reading element is positioned on the reference region, and executing skew processing for a skew mechanism that skews the magnetic head based on a servo band interval signal corresponding to a servo band interval according to the first signal and the second signal, the skew processing being processing of skewing the magnetic head according to the servo band interval.

### BRIEF DESCRIPTION OF THE DRAWINGS

Exemplary embodiments according to the technique of the present disclosure will be described in detail based on the following figures, wherein:

FIG. 1 is a block diagram showing an example of a configuration of a magnetic tape system;

FIG. 2 is a schematic perspective view showing an example of an appearance of a magnetic tape cartridge;

FIG. 3 is a schematic configuration diagram showing an example of a hardware configuration of a magnetic tape drive;

FIG. 4 is a schematic perspective view showing an example of an aspect in which a magnetic field is released by a noncontact read/write device from a lower side of the magnetic tape cartridge;

FIG. 5 is a schematic configuration diagram showing an example of the hardware configuration of the magnetic tape drive;

FIG. 6 is a conceptual diagram showing an example of a relative relationship between a magnetic tape and a magnetic head in a case where data is recorded in a data band or a signal in the data band is reproduced while the magnetic head runs on the magnetic tape;

FIG. 7 is a conceptual diagram showing an example of a configuration of a data band formed on a front surface of the magnetic tape;

FIG. 8 is a conceptual diagram showing an example of a correspondence relationship between a data read/write element and a data track;

FIG. 9 is a conceptual diagram showing an example of an aspect in which the magnetic tape before and after a width of the magnetic tape contracts is observed from a front surface side of the magnetic tape;

FIG. 10 is a conceptual diagram showing an example of an aspect in which a state in which the magnetic head is skewed on the magnetic tape is observed from the front surface side of the magnetic tape;

FIG. 11 is a conceptual diagram showing an example of a function of a controller provided in the magnetic tape drive;

FIG. 12 is a conceptual diagram showing an example of an aspect of a first servo band signal and a second servo band signal output from the magnetic head;

FIG. 13 is a conceptual diagram showing an example of processing contents of a position detection device provided in the controller provided in the magnetic tape drive;

FIG. 14 is a conceptual diagram showing an example of processing contents of the control device provided in the controller provided in the magnetic tape drive;

FIG. 15 is a conceptual diagram showing an example of processing contents of the control device provided in the controller provided in the magnetic tape drive;

FIG. 16 is a conceptual diagram showing an example of BOT region processing and non-BOT region processing performed by the control device;

FIG. 17 is a conceptual diagram showing an example of processing contents of the control device provided in the controller provided in the magnetic tape drive;

FIG. 18 is a flowchart showing an example of a flow of control processing;

FIG. 19 is a flowchart showing an example of a flow of control processing;

FIG. 20 is a conceptual diagram showing an example of processing contents by the control device provided in the magnetic tape system according to a first modification example;

FIG. 21 is a conceptual diagram showing an example of processing contents by the control device provided in the magnetic tape system according to a second modification example;

FIG. 22 is a conceptual diagram showing a third modification example, and is a conceptual diagram showing a modification example of a magnetic tape according to an embodiment (conceptual diagram showing an example of an aspect in which the magnetic tape is observed from the front surface side of the magnetic tape);

FIG. 23 is a conceptual diagram showing the third modification example, and is a conceptual diagram showing a relationship between geometrical characteristics of an actual servo pattern and geometrical characteristics of an imaginary servo pattern;

FIG. 24 is a conceptual diagram showing the third modification example, and is a conceptual diagram showing an example of an aspect in which a state in which frames corresponding to each other between servo bands adjacent to each other in a width direction of the magnetic tape deviate from each other at a predetermined interval is observed from the front surface side of the magnetic tape;

FIG. 25 is a conceptual diagram showing the third modification example, and is a conceptual diagram showing an example of an aspect in which a state in which the servo pattern is read by a servo reading element provided in the magnetic head that is not skewed on the magnetic tape is observed from the front surface side of the magnetic tape;

FIG. 26 is a conceptual diagram showing the third modification example, and is a conceptual diagram showing an example of an aspect in which a state in which the servo pattern is read by a servo reading element provided in the magnetic head that is skewed on the magnetic tape is observed from the front surface side of the magnetic tape;

FIG. 27 is a conceptual diagram showing a fourth modification example, and is a conceptual diagram showing a modification example of the magnetic tape according to the embodiment (conceptual diagram showing an example of an aspect in which the magnetic tape is observed from the front surface side of the magnetic tape);

FIG. 28 is a conceptual diagram showing the fourth modification example, and is a conceptual diagram showing an example of an aspect of the servo pattern included in the magnetic tape;

FIG. 29 is a conceptual diagram showing a seventh modification example, and is a conceptual diagram showing a modification example of the magnetic tape according to the embodiment (conceptual diagram showing an example of an aspect in which the magnetic tape is observed from the front surface side of the magnetic tape);

FIG. 30 is a conceptual diagram showing a fifth modification example, and is a conceptual diagram showing an example of an aspect of the servo pattern included in the magnetic tape;

FIG. 31 is a conceptual diagram showing a sixth modification example, and is a conceptual diagram showing an example of an aspect in which a state in which the frames corresponding to each other between the servo bands adjacent to each other in the width direction of the magnetic tape according to the embodiment deviate from each other at the predetermined interval is observed from the front surface side of the magnetic tape;

FIG. 32 is a conceptual diagram showing a seventh modification example, and is a conceptual diagram showing a modification example of the magnetic tape according to the embodiment (conceptual diagram showing an example of an aspect in which the magnetic tape is observed from the front surface side of the magnetic tape);

FIG. 33 is a conceptual diagram showing the seventh modification example, and is a conceptual diagram showing a relationship between geometrical characteristics of an actual servo pattern and geometrical characteristics of an imaginary servo pattern;

FIG. 34 is a conceptual diagram showing the seventh modification example, and is a conceptual diagram showing an example of an aspect in which a state in which frames corresponding to each other between servo bands adjacent to each other in a width direction of the magnetic tape deviate from each other at a predetermined interval is observed from the front surface side of the magnetic tape;

FIG. 35 is a conceptual diagram showing the seventh modification example, and is a conceptual diagram showing an example of an aspect in which a state in which the servo pattern is read by a servo reading element provided in the magnetic head that is skewed on the magnetic tape is observed from the front surface side of the magnetic tape;

FIG. 36 is a conceptual diagram showing an eighth modification example, and is a conceptual diagram showing a modification example of the magnetic tape according to the embodiment (conceptual diagram showing an example of an aspect in which the magnetic tape is observed from the front surface side of the magnetic tape);

FIG. 37 is a conceptual diagram showing the eighth modification example, and is a conceptual diagram showing an example of an aspect of the servo pattern included in the magnetic tape;

FIG. 38 is a conceptual diagram showing a ninth modification example, and is a conceptual diagram showing a modification example of the magnetic tape according to the embodiment (conceptual diagram showing an example of an aspect in which the magnetic tape is observed from the front surface side of the magnetic tape);

FIG. 39 is a conceptual diagram showing the ninth modification example, and is a conceptual diagram showing an example of an aspect of the servo pattern included in the magnetic tape;

FIG. 40 is a conceptual diagram showing a tenth modification example, and is a conceptual diagram showing a modification example of the magnetic tape according to the embodiment (conceptual diagram showing an example of an aspect in which the magnetic tape is observed from the front surface side of the magnetic tape); and

FIG. 41 is a conceptual diagram showing an example of an aspect in which a program stored in a storage medium is installed in a computer of the control device.

### DETAILED DESCRIPTION

Hereinafter, examples of embodiments of a signal processing device, a magnetic tape drive, a magnetic tape, a magnetic tape cartridge, a program, a signal processing method, and a magnetic tape manufacturing method according to the technology of the present disclosure will be described with reference to the accompanying drawings.

First, the terms used in the following description will be described.

CPU is an abbreviation for “central processing unit”. NVM is an abbreviation for “non-volatile memory”. RAM is an abbreviation for “random access memory”. EEPROM is an abbreviation for “electrically erasable and programmable read only memory”. SSD is an abbreviation for “solid state drive”. HDD is an abbreviation for “hard disk drive”. ASIC is an abbreviation for “application specific integrated circuit”. FPGA is an abbreviation for “field-programmable gate array”. PLC is an abbreviation for “programmable logic controller”. SoC is an abbreviation for “system-on-a-chip”. IC is an abbreviation for “integrated circuit”. RFID is an abbreviation for “radio frequency identifier”. BOT is an abbreviation of “beginning of tape”. EOT is an abbreviation for “end of tape”. UI is an abbreviation for “user interface”. WAN is an abbreviation for “wide area network”. LAN is an abbreviation for “local area network”. PES is an abbreviation for “position error signal”. In addition, in the following description, geometrical characteristics refer to generally recognized geometrical characteristics such as a length, a shape, an orientation, and/or a position.

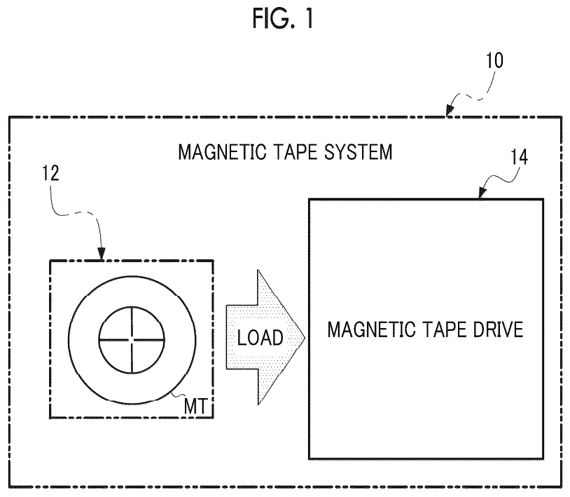

As shown in FIG. 1 as an example, a magnetic tape system 10 comprises a magnetic tape cartridge 12 and a magnetic tape drive 14. The magnetic tape drive 14 is loaded with the magnetic tape cartridge 12. The magnetic tape cartridge 12 accommodates a magnetic tape MT. The magnetic tape drive 14 extracts the magnetic tape MT from the loaded magnetic tape cartridge 12, and records data onto the magnetic tape MT or reads data from the magnetic tape MT while the extracted magnetic tape MT is running.

In the present embodiment, the magnetic tape MT is an example of a “magnetic tape” according to the technology of the present disclosure. In addition, in the present embodiment, the magnetic tape drive 14 is an example of a “magnetic tape drive” according to the technology of the present disclosure. In addition, in the present embodiment, the magnetic tape cartridge 12 is an example of a “magnetic tape cartridge” according to the technology of the present disclosure.

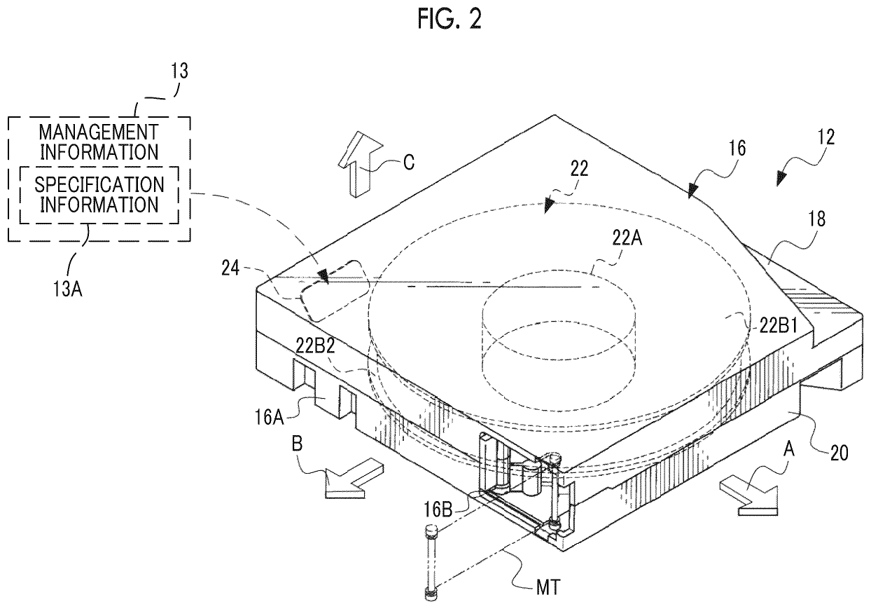

Next, an example of a configuration of the magnetic tape cartridge 12 will be described with reference to FIGS. 2 to 4. In the following description, for convenience of description, in FIGS. 2 to 4, a direction of loading the magnetic tape cartridge 12 into the magnetic tape drive 14 is indicated by an arrow A, a direction of the arrow A is defined as a front direction of the magnetic tape cartridge 12, and a side of the magnetic tape cartridge 12 in the front direction is defined as a front side of the magnetic tape cartridge 12. In the description of the structure to be shown below, “front” indicates the front side of the magnetic tape cartridge 12.

In addition, in the following description, for convenience of description, in FIGS. 2 to 4, a direction of an arrow B that is perpendicular to the direction of the arrow A is defined as a right direction, and a side of the magnetic tape cartridge 12 in the right direction is defined as a right side of the magnetic tape cartridge 12. In the description of the structure to be shown below, “right” indicates the right side of the magnetic tape cartridge 12.

In addition, in the following description, for convenience of description, in FIGS. 2 to 4, a direction opposite to the direction of the arrow B is defined as a left direction, and a side of the magnetic tape cartridge 12 in the left direction is defined as a left side of the magnetic tape cartridge 12. In the description of the structure to be shown below, “left” indicates the left side of the magnetic tape cartridge 12.

In addition, in the following description, for convenience of description, in FIGS. 2 to 4, a direction perpendicular to the direction of the arrow A and to the direction of the arrow B is indicated by an arrow C, a direction of the arrow C is defined as an upper direction of the magnetic tape cartridge 12, and a side of the magnetic tape cartridge 12 in the upper direction is defined as an upper side of the magnetic tape cartridge 12. In the description of the structure to be shown below, “upper” indicates the upper side of the magnetic tape cartridge 12.

In addition, in the following description, for convenience of description, in FIGS. 2 to 4, a direction opposite to the front direction of the magnetic tape cartridge 12 is defined as a rear direction of the magnetic tape cartridge 12, and a side of the magnetic tape cartridge 12 in the rear direction is defined as a rear side of the magnetic tape cartridge 12. In the description of the structure to be shown below, “rear” indicates the rear side of the magnetic tape cartridge 12.

In addition, in the following description, for convenience of description, in FIGS. 2 to 4, a direction opposite to the upper direction of the magnetic tape cartridge 12 is defined as a lower direction of the magnetic tape cartridge 12, and a side of the magnetic tape cartridge 12 in the lower direction is defined as a lower side of the magnetic tape cartridge 12. In the description of the structure to be shown below, “lower” indicates the lower side of the magnetic tape cartridge 12.

As shown in FIG. 2 as an example, the magnetic tape cartridge 12 has a substantially rectangular shape in a plan view and comprises a box-like case 16. The magnetic tape MT is accommodated in the case 16. The case 16 is made of resin such as polycarbonate and comprises an upper case 18 and a lower case 20. The upper case 18 and the lower case 20 are bonded by welding (for example, ultrasound welding) and screwing in a state in which a lower peripheral edge surface of the upper case 18 and an upper peripheral edge surface of the lower case 20 are brought into contact with each other. The bonding method is not limited to welding and screwing, and other bonding methods may be used.

A feeding reel 22 is rotatably accommodated inside the case 16. The feeding reel 22 comprises a reel hub 22A, an upper flange 22B1, and a lower flange 22B2. The reel hub 22A is formed in a cylindrical shape. The reel hub 22A is an axial center portion of the feeding reel 22, has an axial center direction along an up-down direction of the case 16, and is disposed in a center portion of the case 16. Each of the upper flange 22B1 and the lower flange 22B2 is formed in an annular shape. A center portion of the upper flange 22B1 in a plan view is fixed to an upper end portion of the reel hub 22A, and a center portion of the lower flange 22B2 in a plan view is fixed to a lower end portion of the reel hub 22A. The reel hub 22A and the lower flange 22B2 may be integrally molded.

The magnetic tape MT is wound around an outer peripheral surface of the reel hub 22A, and an end portion of the magnetic tape MT in a width direction is held by the upper flange 22B1 and the lower flange 22B2.

An opening 16B is formed on a front side of a right wall 16A of the case 16. The magnetic tape MT is extracted from the opening 16B.

A cartridge memory 24 is provided in the lower case 20. Specifically, the cartridge memory 24 is accommodated in a right rear end portion of the lower case 20. The cartridge memory 24 is a memory that can perform communication in a noncontact manner. An IC chip having an NVM is mounted in the cartridge memory 24. In the present embodiment, a so-called passive RFID tag is adopted as the cartridge memory 24, and various pieces of information are read and written with respect to the cartridge memory 24 in a noncontact manner. In the present embodiment, the form example has been described in which the cartridge memory 24 is provided in the lower case 20, but the technology of the present disclosure is not limited to this, and the cartridge memory 24 need only be provided in the case 16 at a position at which various pieces of information can be read and written in a noncontact manner.

The cartridge memory 24 stores management information 13 for managing the magnetic tape cartridge 12. The management information 13 includes, for example, information about the cartridge memory 24 (for example, information for specifying the magnetic tape cartridge 12), information about the magnetic tape MT, and information about the magnetic tape drive 14 (for example, information that indicates specifications of the magnetic tape drive 14 and a signal used in the magnetic tape drive 14). The information about the magnetic tape MT includes specification information 13A. The specification information 13A is information for specifying the specifications of the magnetic tape MT. In addition, the information about the magnetic tape MT also includes information that indicates an outline of the data recorded on the magnetic tape MT, information that indicates an item of the data recorded on the magnetic tape MT, information that indicates a recording format of the data recorded on the magnetic tape MT, and the like. In the present embodiment, the cartridge memory 24 is an example of a “storage medium” and a “noncontact storage medium” according to the technology of the present disclosure.

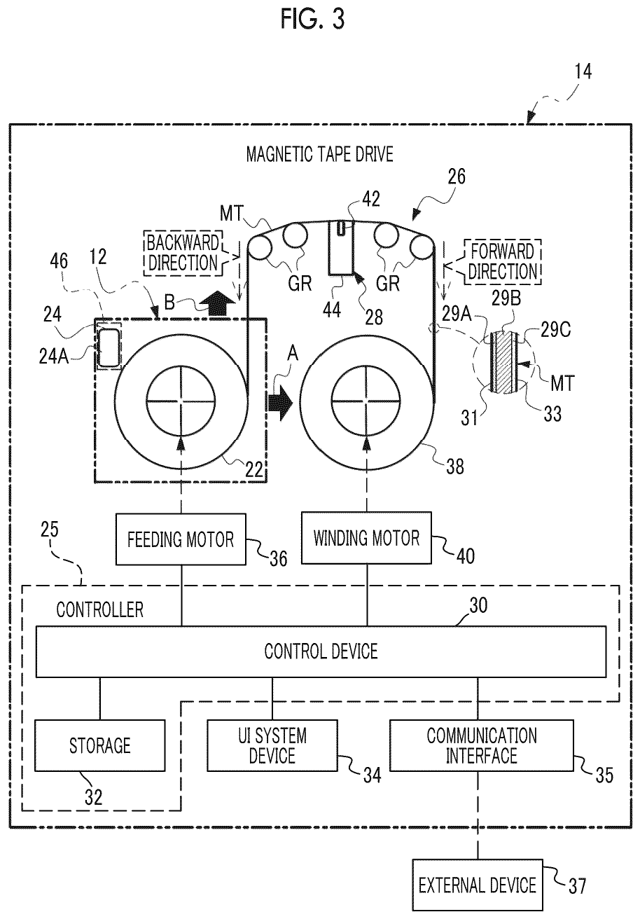

As shown in FIG. 3 as an example, the magnetic tape drive 14 comprises a controller 25, a transport device 26, a magnetic head 28, a UI system device 34, and a communication interface 35. The controller 25 comprises a control device 30 and a storage 32. In the present embodiment, the magnetic head 28 is an example of a “magnetic head” according to the technology of the present disclosure, and the controller 25 is an example of a “signal processing device”. In addition, the control device 30 is an example of a “processor” according to the technology of the present disclosure.

The magnetic tape cartridge 12 is loaded into the magnetic tape drive 14 along the direction of the arrow A. In the magnetic tape drive 14, the magnetic tape MT is used by being extracted from the magnetic tape cartridge 12. The controller 25 controls the entire magnetic tape drive 14 (for example, the magnetic head 28) by using the management information 13 and the like stored in the cartridge memory 24.

The magnetic tape MT has a magnetic layer 29A, a base film 29B, and a back coating layer 29C. The magnetic layer 29A is formed on one surface side of the base film 29B, and the back coating layer 29C is formed on the other surface side of the base film 29B. The data is recorded in the magnetic layer 29A. The magnetic layer 29A contains a ferromagnetic powder. As the ferromagnetic powder, for example, a ferromagnetic powder generally used in the magnetic layers of various magnetic recording media is used. Preferable specific examples of the ferromagnetic powder include a hexagonal ferrite powder. Examples of the hexagonal ferrite powder include a hexagonal strontium ferrite powder and a hexagonal barium ferrite powder. The back coating layer 29C is a layer containing a non-magnetic powder such as carbon black. The base film 29B is also referred to as a support, and is made of, for example, polyethylene terephthalate, polyethylene naphthalate, or polyamide. A non-magnetic layer may be formed between the base film 29B and the magnetic layer 29A. In the magnetic tape MT, a surface on which the magnetic layer 29A is formed is a front surface 31 of the magnetic tape MT, and a surface on which the back coating layer 29C is formed is a back surface 33 of the magnetic tape MT.

The magnetic tape drive 14 performs magnetic processing on the surface 31 of the magnetic tape MT by using the magnetic head 28 in a state in which the magnetic tape MT is running. Here, the magnetic processing refers to recording the data (that is, writing the data) on the front surface 31 of the magnetic tape MT and reading the data (that is, reproducing the data) from the front surface 31 of the magnetic tape MT. In the present embodiment, the magnetic tape drive 14 selectively performs the recording of the data on the front surface 31 of the magnetic tape MT and the reading of the data from the front surface 31 of the magnetic tape MT by using the magnetic head 28. That is, the magnetic tape drive 14 extracts the magnetic tape MT from the magnetic tape cartridge 12, and records the data on the front surface 31 of the extracted magnetic tape MT by using the magnetic head 28 or reads the data from the front surface 31 of the extracted magnetic tape MT by using the magnetic head 28.

The control device 30 controls the entire magnetic tape drive 14. In the present embodiment, although the control device 30 is implemented by an ASIC, the technology of the present disclosure is not limited to this. For example, the control device 30 may be implemented by an FPGA and/or a PLC. In addition, the control device 30 may be implemented by the computer including a CPU, a flash memory (for example, an EEPROM and/or an SSD), and a RAM. In addition, the control device 30 may be implemented by combining two or more of an ASIC, an FPGA, a PLC, and a computer. That is, the control device 30 may be implemented by a combination of a hardware configuration and a software configuration.

The storage 32 is connected to the control device 30, and the control device 30 writes various pieces of information to the storage 32 and reads out various pieces of information from the storage 32. Examples of the storage 32 include a flash memory and/or an HDD. The flash memory and the HDD are merely examples, and any memory may be used as long as the memory is a non-volatile memory that can be mounted in the magnetic tape drive 14.

The UI system device 34 is a device having a reception function of receiving an instruction signal indicating an instruction from a user and a presentation function of presenting the information to the user. The reception function is implemented by a touch panel, a hard key (for example, a keyboard), and/or a mouse, for example. The presentation function is implemented by a display, a printer, and/or a speaker, for example. The UI system device 34 is connected to the control device 30. The control device 30 acquires the instruction signal received by the UI system device 34. The UI system device 34 presents various pieces of information to the user under the control of the control device 30.

The communication interface 35 is connected to the control device 30. In addition, the communication interface 35 is connected to an external device 37 via a communication network (not shown) such as a WAN and/or a LAN. The communication interface 35 controls the exchange of various pieces of information (for example, data to be recorded on the magnetic tape MT, data read from the magnetic tape MT, and/or an instruction signal given to the control device 30) between the control device 30 and the external device 37. Examples of the external device 37 include a personal computer and a mainframe.

The transport device 26 is a device that selectively transports the magnetic tape MT along a predetermined path in a forward direction and a backward direction, and comprises a feeding motor 36, a winding reel 38, a winding motor 40, and a plurality of guide rollers GR. Here, the forward direction indicates a feeding direction of the magnetic tape MT, and the backward direction indicates a rewinding direction of the magnetic tape MT.

The feeding motor 36 rotates the feeding reel 22 in the magnetic tape cartridge 12 under the control of the control device 30. The control device 30 controls the feeding motor 36 to control a rotation direction, a rotation speed, a rotation torque, and the like of the feeding reel 22.

The winding motor 40 rotates the winding reel 38 under the control of the control device 30. The control device 30 controls the winding motor 40 to control a rotation direction, a rotation speed, a rotation torque, and the like of the winding reel 38.

In a case where the magnetic tape MT is wound by the winding reel 38, the control device 30 rotates the feeding motor 36 and the winding motor 40 such that the magnetic tape MT runs along the predetermined path in the forward direction. The rotation speed, the rotation torque, and the like of the feeding motor 36 and the winding motor 40 are adjusted in accordance with a speed at which the magnetic tape MT is wound around the winding reel 38. In addition, the rotation speed, the rotation torque, and the like of each of the feeding motor 36 and the winding motor 40 are adjusted by the control device 30, thereby applying the tension to the magnetic tape MT. In addition, the tension applied to the magnetic tape MT is controlled by adjusting the rotation speed, the rotation torque, and the like of each of the feeding motor 36 and the winding motor 40 via the control device 30.

In a case where the magnetic tape MT is rewound to the feeding reel 22, the control device 30 rotates the feeding motor 36 and the winding motor 40 such that the magnetic tape MT runs along the predetermined path in the backward direction.

In the present embodiment, the tension applied to the magnetic tape MT is controlled by controlling the rotation speed, the rotation torque, and the like of the feeding motor 36 and the winding motor 40, but the technology of the present disclosure is not limited to this. For example, the tension applied to the magnetic tape MT may be controlled by using a dancer roller, or may be controlled by drawing the magnetic tape MT into a vacuum chamber.

Each of the plurality of guide rollers GR is a roller that guides the magnetic tape MT. The predetermined path, that is, a running path of the magnetic tape MT is determined by separately disposing the plurality of guide rollers GR at positions straddling the magnetic head 28 between the magnetic tape cartridge 12 and the winding reel 38.

The magnetic head 28 comprises a magnetic element unit 42 and a holder 44. The magnetic element unit 42 is held by the holder 44 so as to come into contact with the running magnetic tape MT. The magnetic element unit 42 includes a plurality of magnetic elements.

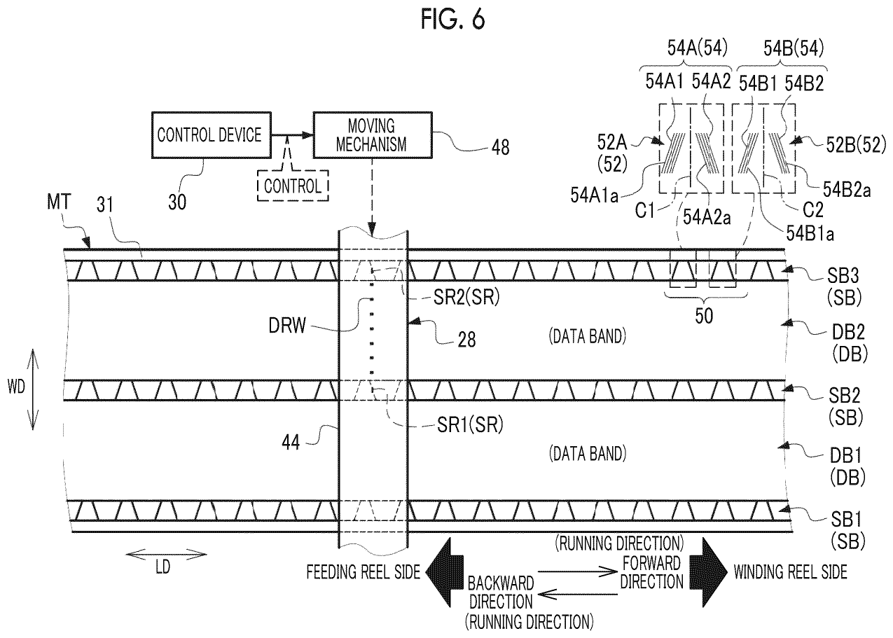

The magnetic element unit 42 records data on the magnetic tape MT transported by the transport device 26, and reads data from the magnetic tape MT transported by the transport device 26. Here, the data refers to, for example, a servo pattern 52 (see FIG. 6) and data other than the servo pattern 52, that is, data recorded in a data band DB (see FIG. 6). The data referred to here is an example of “data” according to the technology of the present disclosure.

The magnetic tape drive 14 comprises a noncontact read/write device 46. The noncontact read/write device 46 is disposed to face a back surface 24A of the cartridge memory 24 on the lower side of the magnetic tape cartridge 12 in a state in which the magnetic tape cartridge 12 is loaded, and reads and writes the information with respect to the cartridge memory 24 in a noncontact manner.

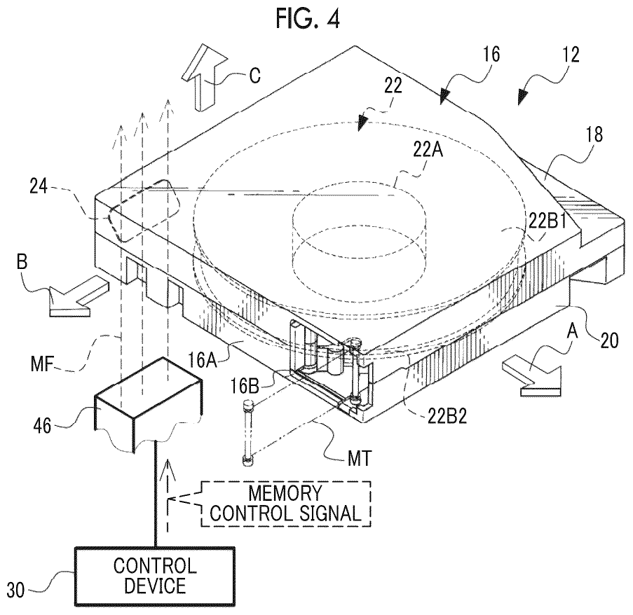

As shown in FIG. 4 as an example, the noncontact read/write device 46 releases a magnetic field MF from the lower side of the magnetic tape cartridge 12 toward the cartridge memory 24. The magnetic field MF passes through the cartridge memory 24.

The noncontact read/write device 46 is connected to the control device 30. The control device 30 outputs a memory control signal to the noncontact read/write device 46. The memory control signal is a signal for controlling the cartridge memory 24. The noncontact read/write device 46 generates the magnetic field MF in response to the memory control signal input from the control device 30, and releases the generated magnetic field MF toward the cartridge memory 24.

The noncontact read/write device 46 performs processing on the cartridge memory 24 in response to the memory control signal by performing noncontact communication with the cartridge memory 24 via the magnetic field MF. For example, under the control of the control device 30, the noncontact read/write device 46 selectively performs processing of reading the information from the cartridge memory 24 and processing of storing the information in the cartridge memory 24 (that is, processing of writing the information to the cartridge memory 24). In other words, the control device 30 reads the information from the cartridge memory 24 and stores the information in the cartridge memory 24 by performing communication with the cartridge memory 24 in a noncontact manner via the noncontact read/write device 46.

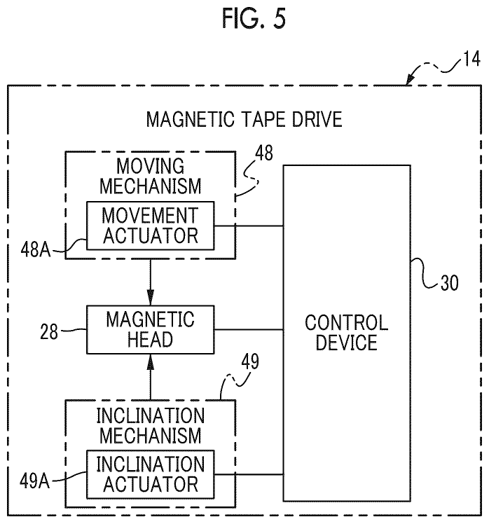

As shown in FIG. 5 as an example, the magnetic tape drive 14 comprises a moving mechanism 48. The moving mechanism 48 includes a movement actuator 48A. Examples of the movement actuator 48A include a voice coil motor and/or a piezo actuator. The movement actuator 48A is connected to the control device 30, and the control device 30 controls the movement actuator 48A. The movement actuator 48A generates power under the control of the control device 30. The moving mechanism 48 moves the magnetic head 28 in a width direction WD (see FIG. 6) of the magnetic tape MT by receiving the power generated by the movement actuator 48A.

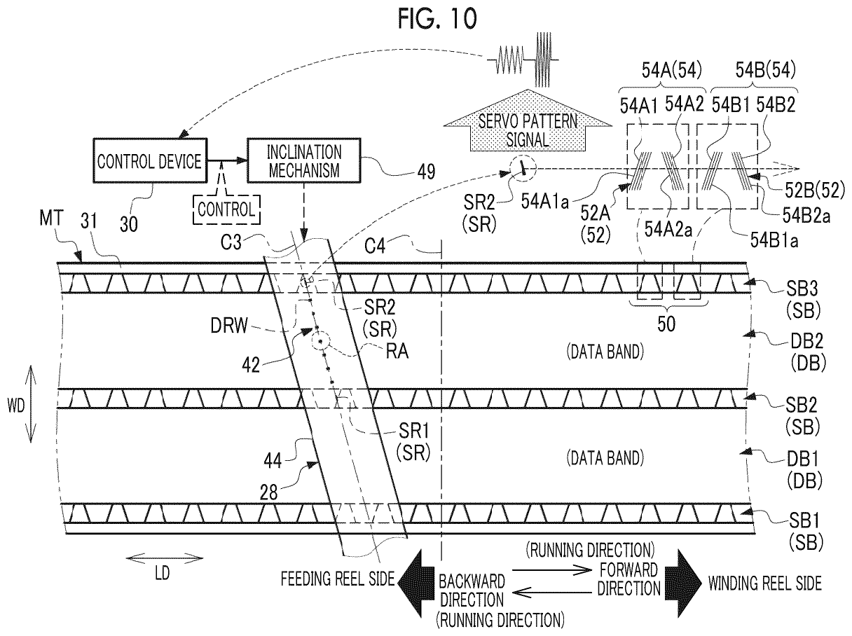

The magnetic tape drive 14 comprises an inclination mechanism 49. The inclination mechanism 49 is an example of a “skew mechanism” according to the technology of the present disclosure. The inclination mechanism 49 includes an inclination actuator 49A. Examples of the inclination actuator 49A include a voice coil motor and/or a piezo actuator. The inclination actuator 49A is connected to the control device 30, and the control device 30 controls the inclination actuator 49A. The inclination actuator 49A generates power under the control of the control device 30. The inclination mechanism 49 inclines the magnetic head 28 to a longitudinal direction LD side of the magnetic tape MT with respect to the width direction WD of the magnetic tape MT by receiving the power generated by the inclination actuator 49A (see FIG. 10). That is, the magnetic head 28 is skewed on the magnetic tape MT by the application of the power from the inclination mechanism 49 under the control of the control device 30.

As shown in FIG. 6 as an example, on the front surface 31 of the magnetic tape MT, servo bands SB1, SB2, and SB3 and data bands DB1 and DB2 are formed. In the following, for convenience of description, in a case where the distinction is not specifically needed, the servo bands SB1 to SB3 are referred to as a servo band SB, and the data bands DB1 and DB2 are referred to as a data band DB. The servo bands SB1 to SB3 are examples of a “servo band” according to the technology of the present disclosure.

The servo bands SB1 to SB3 and the data bands DB1 and DB2 are formed along the longitudinal direction LD (that is, an overall length direction) of the magnetic tape MT. Here, the overall length direction of the magnetic tape MT refers to, in other words, the running direction of the magnetic tape MT. The running direction of the magnetic tape MT is defined in two directions of the forward direction which is a direction in which the magnetic tape MT runs from the feeding reel 22 side to the winding reel 38 side (hereinafter, also simply referred to as a “forward direction”), and the backward direction which is a direction in which the magnetic tape MT runs from the winding reel 38 side to the feeding reel 22 side (hereinafter, also simply referred to as a “backward direction”).

The servo bands SB1 to SB3 are arranged at positions spaced in the width direction WD of the magnetic tape MT (hereinafter, also simply referred to as a “width direction WD”). For example, the servo bands SB1 to SB3 are arranged at equal intervals along the width direction WD. In the present embodiment, the term “equal intervals” refers to equal intervals in the sense of including, in addition to a completely equal interval, an error that is generally acceptable in the technical field to which the technology of the present disclosure belongs, and that does not contradict the purpose of the technology of the present disclosure.

The data band DB1 is disposed between the servo band SB1 and the servo band SB2, and the data band DB2 is disposed between the servo band SB2 and the servo band SB3. That is, the servo bands SB and the data bands DB are arranged alternately along the width direction WD.

In the example shown in FIG. 6, for convenience of description, three servo bands SB and two data bands DB are shown, but these are merely examples, and two servo bands SB and one data band DB may be used, and the technology of the present disclosure is established even in a case where four or more servo bands SB and three or more data bands DB are used.

A plurality of servo patterns 52 are formed in the servo band SB along the longitudinal direction LD of the magnetic tape MT. The servo pattern 52 is an example of a “servo pattern” according to the technology of the present disclosure. The servo patterns 52 are classified into a servo pattern 52A and a servo pattern 52B. The plurality of servo patterns 52 are disposed at regular intervals along the longitudinal direction LD of the magnetic tape MT. In the present embodiment, the term “regular” refers to the regularity in the sense of including, in addition to the exact regularity, an error that is generally acceptable in the technical field to which the technology of the present disclosure belongs, and that does not contradict the purpose of the technology of the present disclosure.

The servo band SB is divided by a plurality of frames 50 along the longitudinal direction LD of the magnetic tape MT. The frame 50 is defined by a set of servo patterns 52. In the example shown in FIG. 6, the servo patterns 52A and 52B are shown as an example of the set of servo patterns 52. The servo patterns 52A and 52B are adjacent to each other along the longitudinal direction LD of the magnetic tape MT, and the servo pattern 52A is positioned on an upstream side in the forward direction and the servo pattern 52B is positioned on a downstream side in the forward direction in the frame 50.

The servo pattern 52 consists of linear magnetization region pairs 54. The linear magnetization region pair 54 is classified into a linear magnetization region pair 54A and a linear magnetization region pair 54B.

The servo pattern 52A consists of the linear magnetization region pair 54A. In the example shown in FIG. 6, a pair of linear magnetization regions 54A1 and 54A2 is shown as an example of the linear magnetization region pair 54A. Each of the linear magnetization regions 54A1 and 54A2 is a linearly magnetized region.

The linear magnetization regions 54A1 and 54A2 are inclined in opposite directions with respect to an imaginary straight line C1 which is an imaginary straight line along the width direction WD. In the example shown in FIG. 6, the linear magnetization regions 54A1 and 54A2 are inclined line-symmetrically with respect to the imaginary straight line C1. More specifically, the linear magnetization regions 54A1 and 54A2 are formed in a state of being not parallel to each other and being inclined at a predetermined angle (for example, 5 degrees) in opposite directions on the longitudinal direction LD side of the magnetic tape MT with the imaginary straight line C1 as a symmetry axis.

The linear magnetization region 54A1 is a set of magnetization straight lines 54A1a, which are five magnetized straight lines. The linear magnetization region 54A2 is a set of magnetization straight lines 54A2a, which are five magnetized straight lines. The set of the magnetization straight lines 54A1a and the set of the magnetization straight lines 54A2a are examples of a “set of a plurality of magnetization straight lines” according to the technology of the present disclosure.

The servo pattern 52B consists of the linear magnetization region pair 54B. In the example shown in FIG. 6, a pair of linear magnetization regions 54B1 and 54B2 is shown as an example of the linear magnetization region pair 54B. Each of the linear magnetization regions 54B1 and 54B2 is a linearly magnetized region.

The linear magnetization regions 54B1 and 54B2 are inclined in opposite directions with respect to an imaginary straight line C2 which is an imaginary straight line along the width direction WD. In the example shown in FIG. 6, the linear magnetization regions 54B1 and 54B2 are inclined line-symmetrically with respect to the imaginary straight line C2. More specifically, the linear magnetization regions 54B1 and 54B2 are formed in a state of being not parallel to each other and being inclined at a predetermined angle (for example, 5 degrees) in opposite directions on the longitudinal direction LD side of the magnetic tape MT with the imaginary straight line C2 as a symmetry axis.

The linear magnetization region 54B1 is a set of magnetization straight lines 54B1a, which are four magnetized straight lines. The linear magnetization region 54B2 is a set of magnetization straight lines 54B2a, which are four magnetized straight lines.

The magnetic head 28 is disposed on the front surface 31 side of the magnetic tape MT configured as described above. The holder 44 is formed in a rectangular parallelepiped shape, and is disposed to cross the front surface 31 of the magnetic tape MT along the width direction WD. The plurality of magnetic elements of the magnetic element unit 42 are arranged linearly along the longitudinal direction of the holder 44. The magnetic element unit 42 includes a pair of servo reading elements SR and a plurality of data read/write elements DRW as the plurality of magnetic elements. In the present embodiment, the pair of servo reading elements SR is an example of a “pair of servo reading elements” according to the technology of the present disclosure.

A length of the holder 44 in the longitudinal direction is sufficiently long with respect to the width of the magnetic tape MT. For example, the length of the holder 44 in the longitudinal direction is set to a length exceeding the width of the magnetic tape MT even in a case where the magnetic element unit 42 is disposed at any position on the magnetic tape MT.

The pair of servo reading elements SR is mounted on the magnetic head 28. In the magnetic head 28, a relative positional relationship between the holder 44 and the pair of servo reading elements SR is fixed. The pair of servo reading elements SR consists of servo reading elements SR1 and SR2. The servo reading element SR1 is disposed at one end of the magnetic element unit 42, and the servo reading element SR2 is disposed at the other end of the magnetic element unit 42. In the example shown in FIG. 6, the servo reading element SR1 is provided at a position corresponding to the servo band SB2, and the servo reading element SR2 is provided at a position corresponding to the servo band SB3. In the present embodiment, the servo reading element SR1 is an example of a “first servo reading element” according to the technology of the present disclosure, and the servo reading element SR2 is an example of a “second servo reading element” according to the technology of the present disclosure. In addition, the servo band SB2 is an example of a “first servo band” according to the technology of the present disclosure, and the servo band SB3 is an example of a “second servo band” according to the technology of the present disclosure.

The plurality of data read/write elements DRW are disposed linearly between the servo reading element SR1 and the servo reading element SR2. The plurality of data read/write elements DRW are disposed at intervals along the longitudinal direction of the magnetic head 28 (for example, are disposed at equal intervals along the longitudinal direction of the magnetic head 28). In the example shown in FIG. 6, the plurality of data read/write elements DRW are provided at positions corresponding to the data band DB2.

The control device 30 acquires a servo pattern signal which is a result of reading the servo pattern 52 via the servo reading element SR, and performs tracking control (also referred to as “servo control”) in response to the acquired servo pattern signal. Here, the tracking control refers to control (that is, control of adjusting the position of the magnetic head 28 such that on-track occurs) of positioning the magnetic head 28 to a designated portion by moving the magnetic head 28 in the width direction WD of the magnetic tape MT via the moving mechanism 48 in accordance with the servo pattern 52 read by the servo reading element SR.

By performing the tracking control, the plurality of data read/write elements DRW are positioned on a designated region in the data band DB, and in this state, the magnetic processing is performed on the designated region in the data band DB. In the example shown in FIG. 6, the plurality of data read/write elements DRW perform the magnetic processing on the designated region in the data band DB2.

In addition, in a case where the data band DB of which the data is to be read by the magnetic element unit 42 is changed (in the example shown in FIG. 6, in a case where the data band DB of which the data is to be read by the magnetic element unit 42 is changed from the data band DB2 to the data band DB1), the moving mechanism 48 moves the magnetic head 28 in the width direction WD to change the position of the pair of servo reading elements SR under the control of the control device 30. That is, by moving the magnetic head 28 in the width direction WD, the moving mechanism 48 moves the servo reading element SR1 to a position corresponding to the servo band SB1 and moves the servo reading element SR2 to the position corresponding to the servo band SB2. As a result, the positions of the plurality of data read/write elements DRW are changed from on the data band DB2 to on the data band DB1, and the plurality of data read/write elements DRW perform the magnetic processing on the data band DB1.

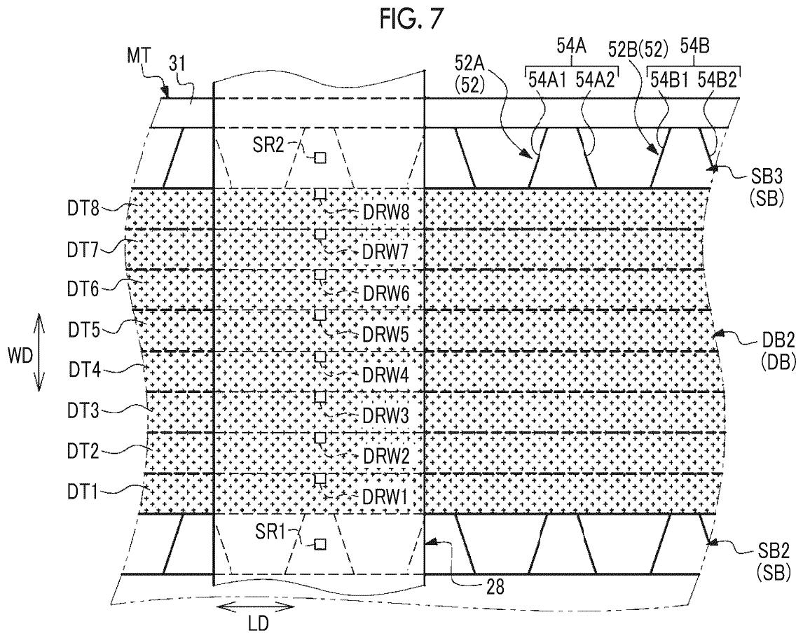

As shown in FIG. 7 as an example, in the data band DB2, as a plurality of division areas obtained by dividing the data band DB2 in the width direction WD, data tracks DT1, DT2, DT3, DT4, DT5, DT6, DT7, and DT8 are formed from the servo band SB2 side to the servo band SB3 side.

The magnetic head 28 includes, as the plurality of data read/write elements DRW, data read/write elements DRW1, DRW2, DRW3, DRW4, DRW5, DRW6, DRW7, and DRW8 between the servo reading element SR1 and the servo reading element SR2 along the width direction WD. The data read/write elements DRW1 to DRW8 have a one-to-one correspondence with the data tracks DT1 to DT8, and can read (that is, reproduce) data from the data tracks DT1 to DT8 and record (that is, write) the data on the data tracks DT1 to DT8.

In addition, although not shown, a plurality of data tracks DT corresponding to the data tracks DT1, DT2, DT3, DT4, DT5, DT6, DT7, and DT8 are also formed in the data band DB1 (see FIG. 6).

Hereinafter, in a case where the distinction is not specifically needed, the data tracks DT1, DT2, DT3, DT4, DT5, DT6, DT7, and DT8 are referred to as a “data track DT”. In addition, in the following, in a case where the distinction is not specifically needed, the data read/write elements DRW1, DRW2, DRW3, DRW4, DRW5, DRW6, DRW7, and DRW8 are referred to as a “data read/write element DRW”.

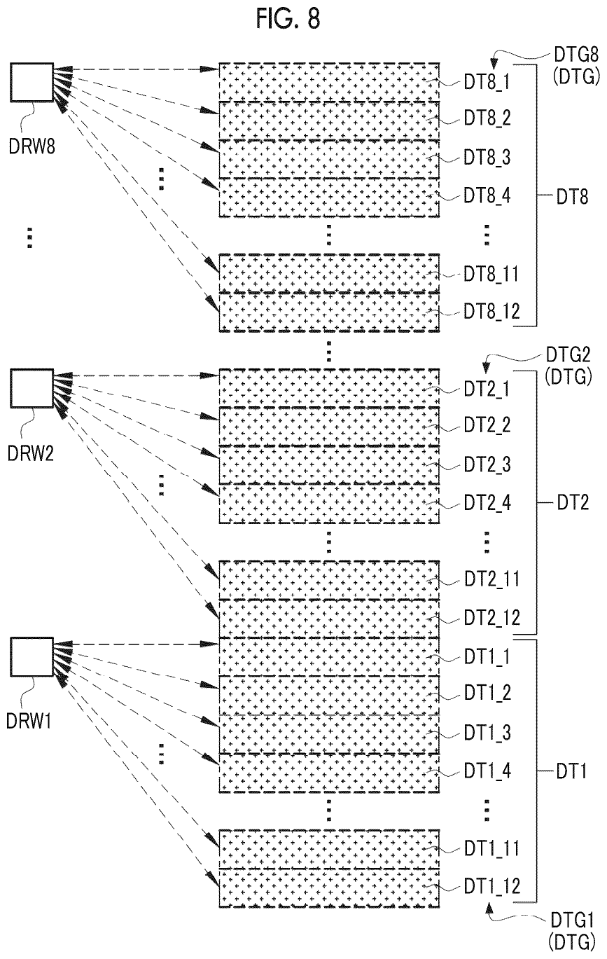

As shown in FIG. 8 as an example, the data track DT includes a division data track group DTG. The data tracks DT1 to DT8 correspond to division data track groups DTG1 to DTG8. In the following, in a case where the distinction is not specifically needed, the division data track groups DTG1 to DTG8 are referred to as a “division data track group DTG”.

The division data track group DTG1 is a set of a plurality of division data tracks obtained by dividing the data track DT in the width direction WD. In the example shown in FIG. 8, as an example of the division data track group DTG1, division data tracks DT1_1, DT1_2, DT1_3, DT1_4, . . . , DT1_11, and DT1_12 obtained by dividing the data track DT into 12 equal parts in the width direction WD are shown. In the present embodiment, the division data track is an example of a “division area” according to the technology of the present disclosure.

The data read/write element DRW1 is responsible for the magnetic processing on the division data track group DTG1. That is, the data read/write element DRW1 is responsible for recording data on the division data tracks DT1_1, DT1_2, DT1_3, DT1_4, . . . , DT1_11, and DT1_12 and for reading data from the division data tracks DT1_1, DT1_2, DT1_3, DT1_4, . . . , DT1_11, and DT1_12.

Each of the data read/write elements DRW2 to DRW8 is also responsible for the magnetic processing on the division data track group DTG of the data track DT corresponding to each data read/write element DRW, similarly to the data read/write element DRW1.

The data read/write element DRW is moved to a position corresponding to designated one data track DT among the plurality of data tracks DT with the movement of the magnetic head 28 in the width direction WD via the moving mechanism 48 (see FIG. 6). The data read/write element DRW is fixed at a position corresponding to the designated one data track DT by the tracking control using the servo pattern 52 (see FIGS. 6 and 7).

Incidentally, in recent years, research on a technology of reducing the influence of transverse dimensional stability (TDS) has been advanced. It has been known that the TDS is affected by a temperature, humidity, a pressure at which the magnetic tape is wound around the reel, temporal deterioration, or the like, the TDS is increased in a case where no measures are taken, and off-track (that is, misregistration of the data read/write element DRW with respect to the track in the data band DB) occurs in a scene in which the magnetic processing is performed on the data band DB.

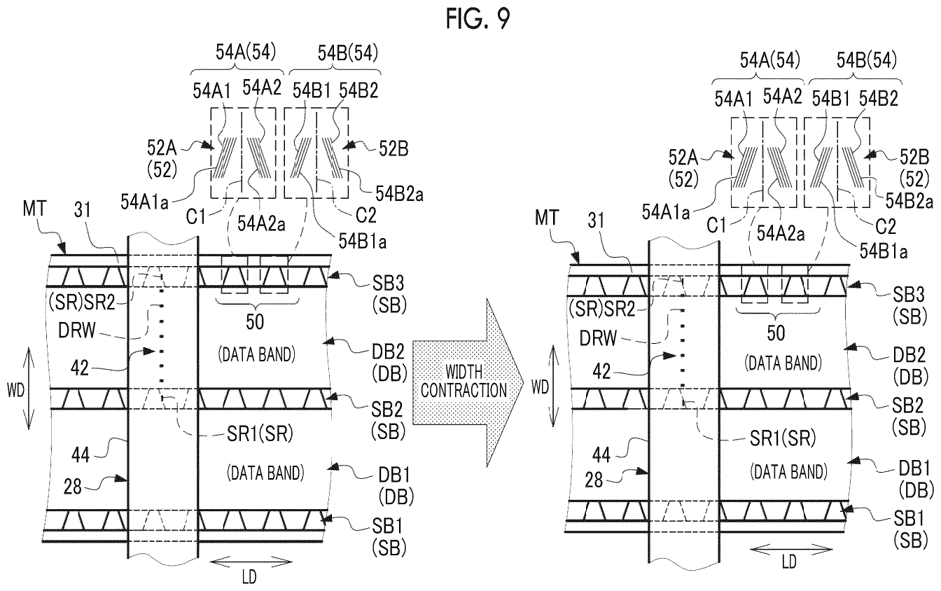

In the example shown in FIG. 9, an aspect is shown in which the width of the magnetic tape MT contracts with the elapse of time. In this case, the off-track occurs. The off-track refers to a state in which the data read/write element DRW is not positioned on the designated division data track among the division data tracks DT1_1, DT1_2, DT1_3, DT1_4, . . . , DT1_11, and DT1_12 included in the division data track group DTG (that is, a state in which the position of the designated division data track and the position of the data read/write element DRW deviate from each other in the width direction WD).

In some cases, the width of the magnetic tape MT expands, and the off-track occurs in this case as well. That is, in a case where the width of the magnetic tape MT contracts or expands with the elapse of time, the position of the servo reading element SR with respect to the servo pattern 52 diverges in the width direction WD from a predetermined position (that is, a predetermined position determined in design with respect to each of the linear magnetization regions 54A1, 54A2, 54B1, and 54B2) determined in design. In a case where the position of the servo reading element SR with respect to the servo pattern 52 diverges in the width direction WD from the predetermined position determined in design, the accuracy of the tracking control is deteriorated, and the position of the track (for example, the designated division data track among the division data tracks DT1_1, DT1_2, DT1_3, DT1_4, . . . , DT1_11, and DT1_12) in the data band DB and the position of the data read/write element DRW deviate from each other. Then, an originally planned track will not be subjected to the magnetic processing.

As a method of reducing the influence of the TDS, a method of adjusting the width of the magnetic tape MT by adjusting the tension applied to the magnetic tape MT is considered. However, in a case where an amount of deformation of the magnetic tape MT in the width direction WD is too large, the off-track may not be eliminated even in a case where the tension applied to the magnetic tape MT is adjusted. In addition, in a case where the tension applied to the magnetic tape MT is increased, the load applied to the magnetic tape MT is also increased, which may lead to shortening the life of the magnetic tape MT. Further, in a case where the tension applied to the magnetic tape MT is too weak, the contact state between the magnetic head 28 and the magnetic tape MT is unstable, and it is difficult for the magnetic head 28 to perform the magnetic processing on the magnetic tape MT. As a method of reducing the influence of the TDS other than the method of adjusting the tension applied to the magnetic tape MT, as shown in FIG. 10 as an example, a method of holding the position of the servo reading element SR with respect to the servo pattern 52 at the predetermined position determined in design by skewing the magnetic head 28 on the magnetic tape MT is known.

The magnetic head 28 comprises a rotation axis RA. The rotation axis RA is provided at a position corresponding to a center portion of the magnetic element unit 42 provided in the magnetic head 28 in a plan view. The magnetic head 28 is rotatably held by the inclination mechanism 49 via the rotation axis RA. In the present embodiment, the operation of inclining the magnetic head 28 with respect to the width direction WD by rotating the magnetic head 28 on the front surface 31 with the rotation axis RA as a central axis along the front surface 31 is referred to as “skew”.

An imaginary straight line C3 which is an imaginary center line is provided in the magnetic head 28. The imaginary straight line C3 is a straight line that passes through the rotation axis RA and that extends in the longitudinal direction of the magnetic head 28 in a plan view (that is, the direction in which the plurality of data read/write elements DRW are arranged). The magnetic head 28 is disposed in an inclined posture with respect to the width direction WD along the front surface 31 (in other words, a posture in which the imaginary straight line C3 is inclined with respect to an imaginary straight line C4 along the front surface 31). In the example shown in FIG. 10, the magnetic head 28 is held by the inclination mechanism 49 to have a posture in which the imaginary straight line C3 is inclined to the longitudinal direction LD side of the magnetic tape MT with respect to the imaginary straight line C4 which is an imaginary straight line along the width direction WD. In the example shown in FIG. 10, the magnetic head 28 is held by the inclination mechanism 49 in a posture in which the imaginary straight line C3 is inclined to the feeding reel 22 side with respect to the imaginary straight line C4 (that is, a posture inclined counterclockwise as viewed from a paper surface side of FIG. 10). An angle formed by the imaginary straight line C3 and the imaginary straight line C4 corresponds to an angle at which the magnetic head 28 is inclined with respect to the width direction WD by rotating the magnetic head 28 on the front surface 31 with the rotation axis RA as a central axis along the front surface 31. In the following, the angle formed by the imaginary straight line C3 and the imaginary straight line C4 is also referred to as a “skew angle” or a “skew angle of the magnetic head 28”. The skew angle is an angle defined such that the counterclockwise direction as viewed from the paper surface side of FIG. 10 is positive, and the clockwise direction as viewed from the paper surface side of FIG. 10 is negative.

The inclination mechanism 49 receives power from the inclination actuator 49A (see FIG. 5) to rotate the magnetic head 28 around the rotation axis RA on the front surface 31 of the magnetic tape MT. Under the control of the control device 30, the inclination mechanism 49 rotates the magnetic head 28 around the rotation axis RA on the front surface 31 of the magnetic tape MT, thereby changing the direction of the inclination (that is, azimuth) and the inclined angle of the imaginary straight line C3 with respect to the imaginary straight line C4. The change the direction of the inclination and the inclined angle of the imaginary straight line C3 with respect to the imaginary straight line C4 is implemented by changing an angle at which the magnetic head 28 is inclined with respect to the width direction WD along the front surface 31, that is, the skew angle of the magnetic head 28. In the present embodiment, the direction of the inclination and the inclined angle of the imaginary straight line C3 with respect to the imaginary straight line C4 are expressed by the skew angle of the magnetic head 28.

By changing the direction of the inclination and the inclined angle of the imaginary straight line C3 with respect to the imaginary straight line C4, that is, the skew angle in accordance with the temperature, the humidity, the pressure at which the magnetic tape MT is wound around the reel, the temporal deterioration, and the like, or expansion and contraction of the magnetic tape MT in the width direction WD due to these, the position of the servo reading element SR with respect to the servo pattern 52 is held at the predetermined position determined in design. In this case, the on-track occurs. The on-track refers to a state in which the data read/write element DRW is positioned on the designated division data track among the division data tracks DT1_1, DT1_2, DT1_3, DT1_4, . . . , DT1_11, and DT1_12 included in the division data track group DTG (that is, a state in which the position of the designated division data track and the position of the data read/write element DRW match each other in the width direction WD).

The servo reading element SR reads the servo pattern 52 and outputs the servo pattern signal indicating a read result. The servo reading element SR is formed linearly along the imaginary straight line C3. Therefore, in a case where the servo pattern 52A is read by the servo reading element SR, an angle formed by the linear magnetization region 54A1 and the servo reading element SR and an angle formed by the linear magnetization region 54A2 and the servo reading element SR are different in the linear magnetization region pair 54A. In a case where the angles are different in this way, a variation due to an azimuth loss (for example, a variation in signal level and waveform distortion) occurs between the servo pattern signal derived from the linear magnetization region 54A1 (that is, the servo pattern signal obtained by reading the linear magnetization region 54A1 via the servo reading element SR) and the servo pattern signal derived from the linear magnetization region 54A2 (that is, the servo pattern signal obtained by reading the linear magnetization region 54A2 via the servo reading element SR).

In the example shown in FIG. 10, since the angle formed by the servo reading element SR and the linear magnetization region 54A1 is larger than the angle formed by the servo reading element SR and the linear magnetization region 54A2, the output of the servo pattern signal is small, and the waveform also spreads, so that a variation occurs in the servo pattern signal obtained by being read by the servo reading element SR across the servo band SB in a state in which the magnetic tape MT runs. In addition, also in a case where the servo pattern 52B is read by the servo reading element SR, the variation due to the azimuth loss occurs between the servo pattern signal derived from the linear magnetization region 54B1 and the servo pattern signal derived from the linear magnetization region 54B2.

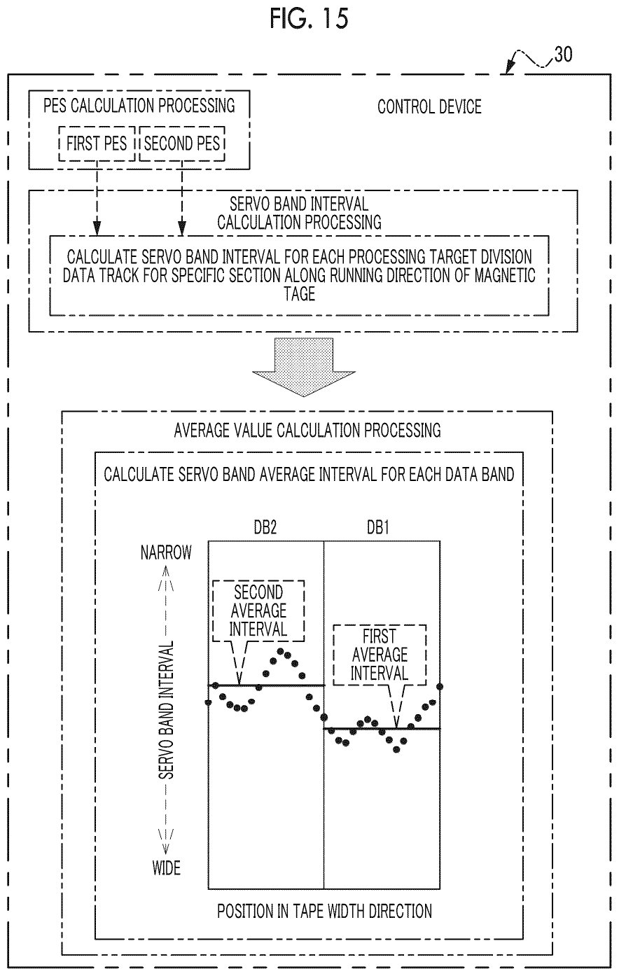

As will be described in detail below, in the present embodiment, as a method of detecting the servo pattern signal in which the variation occurs due to the azimuth loss as described above, a method of detecting the servo pattern signal using an autocorrelation coefficient is used (see FIG. 15).

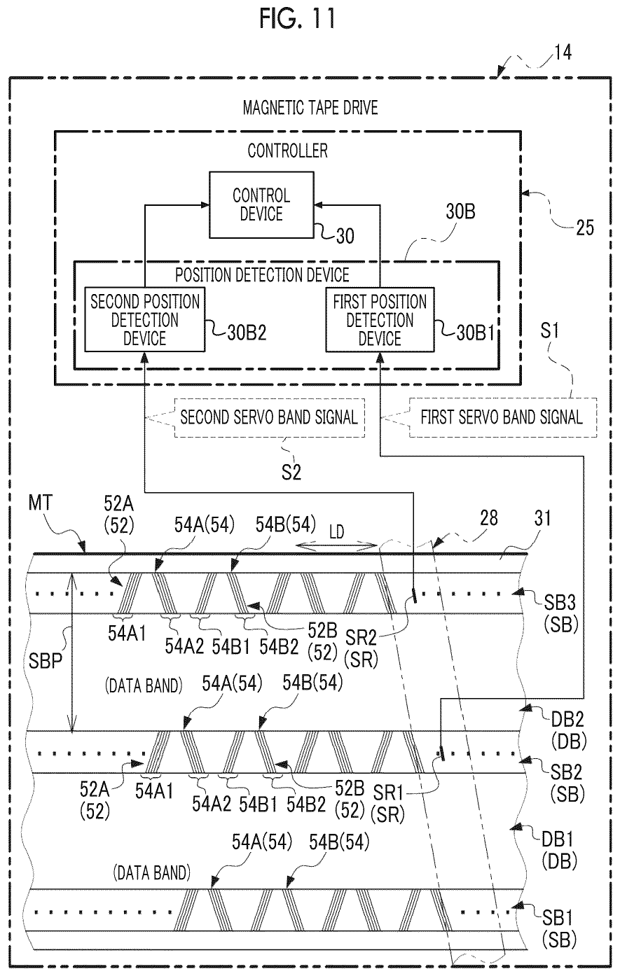

Next, an example of contents of specific processing performed by the control device 30 will be described with reference to FIGS. 11 to 17.

As shown in FIG. 11 as an example, the controller 25 comprises a position detection device 30B in addition to the control device 30. In the example shown in FIG. 11, the position detection device 30B is separate from the control device 30, but this is merely an example, and the position detection device 30B may be integrated with the control device 30 by being incorporated into the control device 30.

The position detection device 30B includes a first position detection device 30B1 and a second position detection device 30B2. The position detection device 30B acquires a servo band signal that is a result of reading the servo band SB via the servo reading element SR, and detects the position of the magnetic head 28 on the magnetic tape MT based on the acquired servo band signal. The servo band signal includes a signal (for example, noise) unnecessary for the tracking control in addition to the servo pattern signal that is the result of reading the servo pattern 52.

The position detection device 30B acquires the servo band signal from the magnetic head 28. The servo band signal is classified into a first servo band signal S1 and a second servo band signal S2. The first servo band signal S1 is a signal indicating the result of reading the servo pattern 52 in the servo band SB via the servo reading element SR1. The second servo band signal S2 is a signal indicating the result of reading the servo pattern 52 in the servo band SB via the servo reading element SR2. The first servo band signal S1 is an example of a “first result of reading the servo pattern via the first servo reading element” according to the technology of the present disclosure, and the second servo band signal S2 is an example of a “second result of reading the servo pattern via the second servo reading element” according to the technology of the present disclosure.

The result of reading the servo pattern 52 in the servo band SB via the servo reading element SR1 refers to, for example, a result of reading the linear magnetization regions 54A1, 54A2, 54B1, and 54B2 included in one servo pattern 52 via the servo reading element SR1. Five magnetization straight lines 54A1a are included in the linear magnetization region 54A1. In addition, five magnetization straight lines 54A2a are included in the linear magnetization region 54A2. In addition, four magnetization straight lines 54B1a are included in the linear magnetization region 54B1. In addition, four magnetization straight lines 54B2a are included in the linear magnetization region 54B2. Therefore, the result of reading the servo pattern 52 via the servo reading element SR1 is obtained as a pulse signal group (hereinafter, also referred to as a “first pulse signal group”) consisting of 18 pulse signals corresponding to the linear magnetization regions 54A1, 54A2, 54B1, and 54B2.

In the example shown in FIG. 11, the first pulse signal group is a set of time-series pulse signals corresponding to the linear magnetization regions 54A1, 54A2, 54B1, and 54B2 in the servo band SB2. In addition, in the present embodiment, the first pulse signal group is the first servo band signal S1.

Here, as the first pulse signal group, a set of time-series pulse signals corresponding to the linear magnetization regions 54A1, 54A2, 54B1 and 54B2 in the servo band SB2 has been described, but this is merely an example. For example, the first pulse signal group may be a set of time-series pulse signals corresponding to the linear magnetization regions 54A1 and 54A2 in the servo band SB2 or a set of time-series pulse signals corresponding to the linear magnetization regions 54B1 and 54B2 in the servo band SB2.

The result of reading the servo pattern 52 in the servo band SB via the servo reading element SR2 refers to, for example, a result of reading the linear magnetization regions 54A1, 54A2, 54B1, and 54B2 included in one servo pattern 52 via the servo reading element SR2. Therefore, the result of reading the servo pattern 52 via the servo reading element SR2 is obtained as a pulse signal group (hereinafter, also referred to as a “second pulse signal group”) consisting of 18 pulse signals corresponding to the linear magnetization regions 54A1, 54A2, 54B1, and 54B2.

In the example shown in FIG. 11, the second pulse signal group is a set of time-series pulse signals corresponding to the linear magnetization regions 54A1, 54A2, 54B1, and 54B2 in the servo band SB3. In addition, in the present embodiment, the second pulse signal group is the second servo band signal S2.

Here, as the second pulse signal group, a set of time-series pulse signals corresponding to the linear magnetization regions 54A1, 54A2, 54B1, and 54B2 in the servo band SB3 has been described, but this is merely an example. For example, the second pulse signal group may be a set of time-series pulse signals corresponding to the linear magnetization regions 54A1 and 54A2 in the servo band SB3 or a set of time-series pulse signals corresponding to the linear magnetization regions 54B1 and 54B2 in the servo band SB3.

The first position detection device 30B1 acquires the first servo band signal S1, and the second position detection device 30B2 acquires the second servo band signal S2. In the example shown in FIG. 11, the signal obtained by reading the servo band SB2 via the servo reading element SR1 is shown as an example of the first servo band signal S1, and the signal obtained by reading the servo band SB3 via the servo reading element SR2 is shown as an example of the second servo band signal S2. In the present embodiment, for convenience of description, in a case where the distinction is not specifically needed, the first servo band signal S1 and the second servo band signal S2 will be referred to as a “servo band signal” without being denoted by reference numerals.

Incidentally, in the magnetic tape drive 14, the tracking control and off-track suppression control (hereinafter, also referred to as “various controls”) are performed. The off-track suppression control is control of suppressing the occurrence of the off-track. Examples of the off-track suppression control include skew control of skewing the magnetic head 28. The skew control is an example of “skew processing” according to the technology of the present disclosure. In addition, as the off-track suppression control, tension control of controlling the tension applied to the magnetic tape MT may be performed in addition to the skew control.

The off-track suppression control is control performed based on a servo band interval SBP. Here, the servo band interval SBP refers to a distance along the width direction WD of the magnetic tape MT between a predetermined position in a certain servo band (for example, an upper end of the servo band as viewed from the paper surface side of FIG. 11) and a predetermined position in an adjacent servo band (for example, an upper end of the servo band as viewed from the paper surface side of FIG. 11). The servo band interval SBP is calculated based on the first servo band signal S1 and the second servo band signal S2. Therefore, in a case where the servo band interval SBP varies for each individual magnetic tape MT, the calculation of the servo band interval SBP is affected by at least the variation in the servo band interval SBP, and the accuracy of various types of control (for example, the skew control) is also reduced accordingly.

The servo pattern 52 is recorded by a servo writer. Various servo writers are used for recording the servo pattern 52, and there is a manufacturing error and/or an attachment error between the servo writers. The manufacturing error and/or the attachment error between the servo writers appear as a difference (for example, a tolerance) in the servo band interval SBP for each adjacent servo band (for example, the servo band SB2 and the servo band SB3). As long as the servo band interval SBP can be determined for each adjacent servo band, it becomes possible to perform various types of control taking into consideration the differences in the servo band interval SBP.

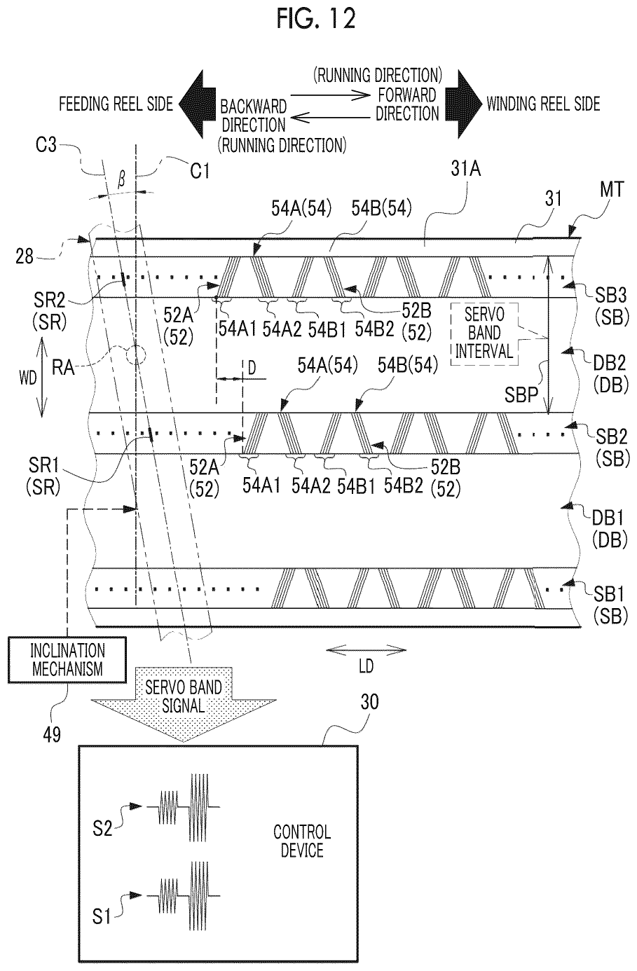

Therefore, in view of such circumstances, in the magnetic tape system 10, as shown in FIG. 12 as an example, the servo band signal is acquired on a BOT region 31A of the magnetic tape MT. The BOT region 31A is an example of a “reference region” according to the technology of the present disclosure. The example shown in FIG. 12 shows a state in which the magnetic head 28 is skewed on the BOT region 31A of the magnetic tape MT around the rotation axis RA such that the imaginary straight line C3 is inclined with respect to the imaginary straight line C1 to the upstream side in the forward direction at an angle β (that is, an angle β counterclockwise as viewed from the paper surface side of FIG. 12). The angle β is an angle corresponding to an interval D (see FIG. 12) and is determined in advance as the skew angle on the BOT region 31A. For example, the angle β is included in the management information 13 (see FIG. 2) and is acquired by the control device 30. The control device 30 operates the inclination mechanism 49 (see FIGS. 5 and 10) to skew the magnetic head 28 on the BOT region 31A such that the skew angle is the angle β. In a state in which the skew angle that is the angle β is maintained, the control device 30 acquires the first servo band signal S1 from the servo reading element SR1 and acquires the second servo band signal S2 from the servo reading element SR2.

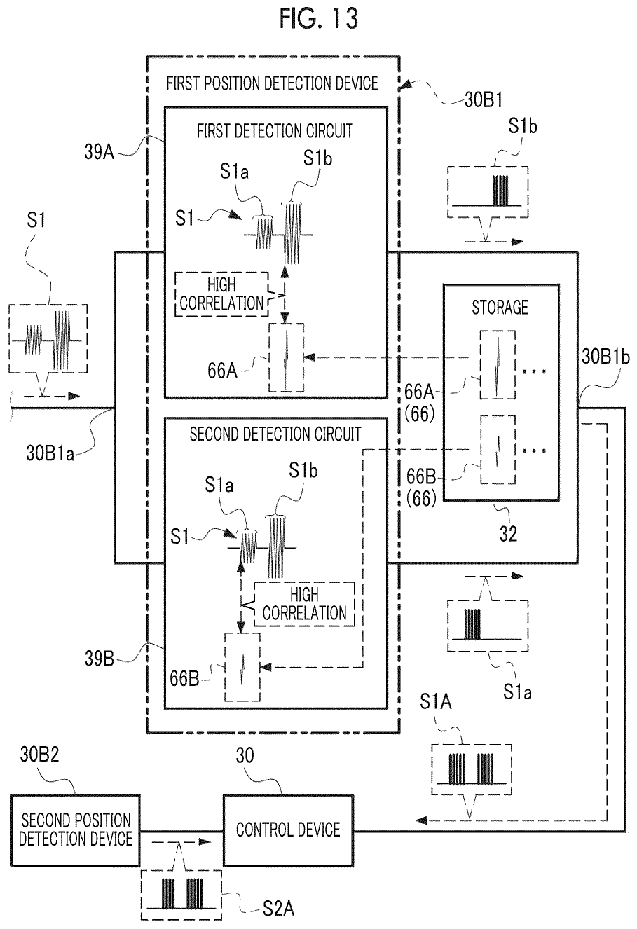

As shown in FIG. 13 as an example, the first position detection device 30B1 includes a first detection circuit 39A and a second detection circuit 39B. The first detection circuit 39A and the second detection circuit 39B are connected in parallel, and comprise an input terminal 30B1a and an output terminal 30B1b that are common to each other. In the example shown in FIG. 13, an aspect example is shown in which the first servo band signal S1 is input to the input terminal 30B1a. The first servo band signal S1 includes a first linear magnetization region signal S1a and a second linear magnetization region signal S1b. The first linear magnetization region signal S1a and the second linear magnetization region signal S1b are servo pattern signals (that is, analog servo pattern signals) indicating the results of the reading via the servo reading element SR1 (see FIG. 11). The same can be said about the second servo band signal S2 (see FIG. 11) as about the first servo band signal S1. That is, the servo pattern signal includes the first linear magnetization region signal S1a and the second linear magnetization region signal S1b.

One ideal waveform signal 66 is stored in advance in the storage 32, for each frame 50. For example, the ideal waveform signal 66 is individually associated with each of all the frames 50 from the beginning to the end of the magnetic tape MT. In a case where the servo pattern 52 included in each frame 50 is read by the servo reading element SR from the beginning to the end of the magnetic tape MT, the first position detection device 30B1 acquires the ideal waveform signal 66 corresponding to each frame 50 from the storage 32 for each time the servo pattern 52 included in each frame 50 is read by the servo reading element SR (for example, in synchronization with a timing at which reading of the servo pattern 52 via the servo reading element SR is started), and uses the acquired ideal waveform signal 66 for comparison with the first servo band signal S1.

The ideal waveform signal 66 is a signal indicating an ideal waveform of a servo pattern signal (that is, an analog servo pattern signal) indicating the result of reading the servo pattern 52 (see FIG. 11) recorded in the servo band SB of the magnetic tape MT via the servo reading element SR. The ideal waveform signal 66 can be said to be a sample signal to be compared with the first servo band signal S1.

The ideal waveform signal 66 is classified into a first ideal waveform signal 66A and a second ideal waveform signal 66B. The first ideal waveform signal 66A corresponds to a signal derived from the linear magnetization region 54A2 or 54B2, that is, the second linear magnetization region signal S1b, and is a signal indicating an ideal waveform of the second linear magnetization region signal S1b. The second ideal waveform signal 66B corresponds to a signal derived from the linear magnetization region 54A1 or 54B1, that is, the first linear magnetization region signal S1a, and is a signal indicating an ideal waveform of the first linear magnetization region signal S1a.

More specifically, for example, the first ideal waveform signal 66A is a signal indicating a single ideal waveform (that is, for one wavelength) included in the second linear magnetization region signal S1b (for example, an ideal signal that is a result of reading one of ideal magnetization straight lines included in the servo pattern 52 via the servo reading element SR). In addition, for example, the second ideal waveform signal 66B is a signal indicating a single ideal waveform (that is, for one wavelength) included in the first linear magnetization region signal S1a (for example, an ideal signal that is a result of reading one of ideal magnetization straight lines included in the servo pattern 52 via the servo reading element SR).

The ideal waveform indicated by the first ideal waveform signal 66A is a waveform determined in accordance with an orientation of the magnetic head 28 on the magnetic tape MT. A relative positional relationship between the holder 44 (see FIG. 10) of the magnetic head 28 and the servo reading element SR is fixed. Therefore, the ideal waveform indicated by the first ideal waveform signal 66A can be said to be a waveform determined in accordance with the orientation of the servo reading element SR on the magnetic tape MT. For example, the ideal waveform indicated by the first ideal waveform signal 66A is a waveform determined in accordance with the geometrical characteristics of the linear magnetization region 54A2 of the servo pattern 52A (for example, the geometrical characteristics of the magnetization straight line 54A2a) and the orientation of the magnetic head 28 on the magnetic tape MT.

As described above, since the relative positional relationship between the holder 44 (see FIG. 10) of the magnetic head 28 and the servo reading element SR is fixed, the ideal waveform indicated by the first ideal waveform signal 66A can be said to be a waveform determined in accordance with the geometrical characteristics of the linear magnetization region 54A2 of the servo pattern 52A (for example, the geometrical characteristics of the magnetization straight line 54A2a) and the orientation of the servo reading element SR on the magnetic tape MT. Here, the orientation of the magnetic head 28 on the magnetic tape MT refers to, for example, an angle formed by the linear magnetization region 54A2 and the magnetic head 28 on the magnetic tape MT. In addition, the orientation of the servo reading element SR on the magnetic tape MT refers to, for example, an angle formed by the linear magnetization region 54A2 and the servo reading element SR on the magnetic tape MT.

The ideal waveform indicated by the first ideal waveform signal 66A may be determined taking into account, in addition to the elements described above, the characteristics of the servo reading element SR itself (material, size, shape, and/or use history), the characteristics of the magnetic tape MT (material and/or use history), and/or the use environment of the magnetic head 28.

Similarly to the ideal waveform indicated by the first ideal waveform signal 66A, the ideal waveform indicated by the second ideal waveform signal 66B is also a waveform determined in accordance with the orientation of the magnetic head 28 on the magnetic tape MT, that is, a waveform determined in accordance with the orientation of the servo reading element SR on the magnetic tape MT. For example, the ideal waveform indicated by the second ideal waveform signal 66B is a waveform determined in accordance with the geometrical characteristics of the linear magnetization region 54A1 of the servo pattern 52A (for example, the geometrical characteristics of the magnetization straight line 54A1a) and the orientation of the magnetic head 28 on the magnetic tape MT, that is, a waveform determined in accordance with the geometrical characteristics of the linear magnetization region 54A1 of the servo pattern 52A (for example, the geometrical characteristics of the magnetization straight line 54A1a) and the orientation of the servo reading element SR on the magnetic tape MT. Here, the orientation of the magnetic head 28 on the magnetic tape MT refers to, for example, an angle formed by the linear magnetization region 54A1 and the magnetic head 28 on the magnetic tape MT. In addition, the orientation of the servo reading element SR on the magnetic tape MT refers to, for example, an angle formed by the linear magnetization region 54A1 and the servo reading element SR on the magnetic tape MT.

Similarly to the ideal waveform indicated by the first ideal waveform signal 66A, the ideal waveform indicated by the second ideal waveform signal 66B may also be determined taking into account, in addition to the elements described above, the characteristics of the servo reading element SR itself (material, size, shape, and/or use history), the characteristics of the magnetic tape MT (material and/or use history), and/or the use environment of the magnetic head 28.

The first position detection device 30B1 acquires the first servo band signal S1, and compares the acquired first servo band signal S1 with the ideal waveform signal 66 to detect a servo pattern signal S1A. In the example shown in FIG. 12, the first position detection device 30B 1 detects the servo pattern signal S1A by using the first detection circuit 39A and the second detection circuit 39B.

The first servo band signal S1 is input to the first detection circuit 39A via the input terminal 30B1a. The first detection circuit 39A detects the second linear magnetization region signal S1b from the input first servo band signal S1 by using an autocorrelation coefficient.

The autocorrelation coefficient used by the first detection circuit 39A is a coefficient indicating a degree of correlation between the first servo band signal S1 and the first ideal waveform signal 66A. The first detection circuit 39A acquires the first ideal waveform signal 66A from the storage 32 and compares the acquired first ideal waveform signal 66A with the first servo band signal S1. Moreover, the first detection circuit 39A calculates the autocorrelation coefficient based on the comparison result. The first detection circuit 39A detects a position at which the correlation between the first servo band signal S1 and the first ideal waveform signal 66A is high (for example, a position at which the first servo band signal S1 and the first ideal waveform signal 66A match each other) on the servo band SB (for example, the servo band SB2 shown in FIG. 9) in accordance with the autocorrelation coefficient.

On the other hand, the first servo band signal S1 is also input to the second detection circuit 39B via the input terminal 30B1a. The second detection circuit 39B detects the first linear magnetization region signal S1a from the input first servo band signal S1 by using the autocorrelation coefficient.

The autocorrelation coefficient used by the second detection circuit 39B is a coefficient indicating a degree of correlation between the first servo band signal S1 and the second ideal waveform signal 66B. The second detection circuit 39B acquires the second ideal waveform signal 66B from the storage 32 and compares the acquired second ideal waveform signal 66B with the first servo band signal S1. Moreover, the second detection circuit 39B calculates the autocorrelation coefficient based on the comparison result. The second detection circuit 39B detects a position at which the correlation between the first servo band signal S1 and the second ideal waveform signal 66B is high (for example, a position at which the first servo band signal S1 and the second ideal waveform signal 66B match each other) on the servo band SB (for example, the servo band SB2 shown in FIG. 9) in accordance with the autocorrelation coefficient.

The first position detection device 30B1 detects the servo pattern signal S1A based on the detection result by the first detection circuit 39A and the detection result by the second detection circuit 39B. The first position detection device 30B1 outputs the servo pattern signal S1A from the output terminal 30B1b to the control device 30. The servo pattern signal S1A is a signal (for example, a digital signal) indicating a logical sum of the second linear magnetization region signal S1b detected by the first detection circuit 39A and the first linear magnetization region signal S1a detected by the second detection circuit 39B.

In the example shown in FIG. 13, the form example has been described in which the first position detection device 30B1 detects the servo pattern signal S1A by comparing the first servo band signal S1 with the ideal waveform signal 66, similarly, the second position detection device 30B2 also detects the servo pattern signal S2A by comparing the second servo band signal S2 with the ideal waveform signal 66, and outputs the detected servo pattern signal S2A to the control device 30.

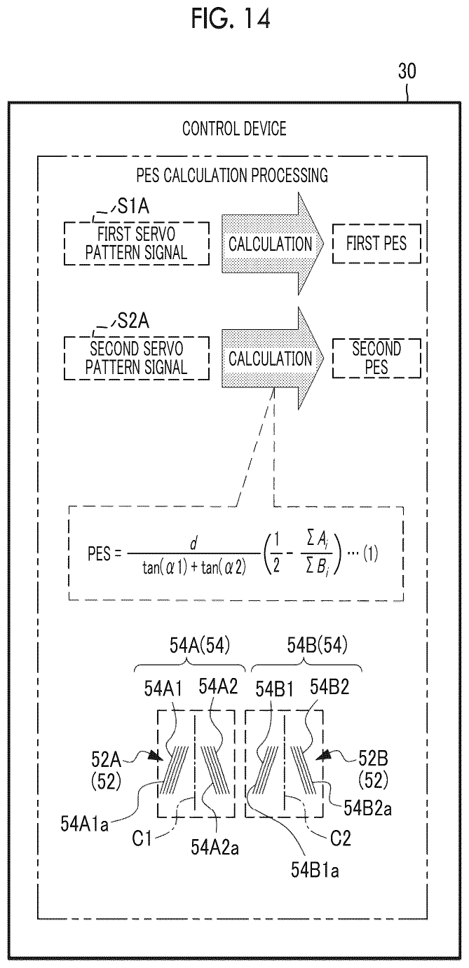

As shown in FIG. 14 as an example, the control device 30 executes PES calculation processing. In the PES calculation processing, the control device 30 calculates a PES based on the servo pattern signals S1A and S2A acquired from the position detection device 30B. For example, the control device 30 calculates a first PES based on the first servo pattern signal S1A input from the first position detection device 30B1. In addition, the control device 30 calculates a second PES based on the second servo pattern signal S2A input from the second position detection device 30B2.

In the example shown in FIG. 14, the first PES refers to a PES that is a signal indicating a position in the width direction WD in the servo pattern 52 on the servo band SB2 where the servo reading element SR1 is positioned. The second PES refers to a PES that is a signal indicating a position in the width direction WD in the servo pattern 52 on the servo band SB3 where the servo reading element SR2 is positioned. Hereinafter, in cases where the distinction is not specifically needed, the first PES and the second PES are referred to as a “PES”. The first PES is an example of a “first signal” according to the technology of the present disclosure, and the second PES is an example of a “second signal” according to the technology of the present disclosure.

The PES is calculated using Expression (1).

$$PES = \frac{d}{tan ( α1 ) + tan ( α2 )} ( \frac{1}{2} - \frac{\sum {A}_{i}}{\sum {B}_{i}} ) \qquad ( 1 )$$

Here,
α1 is an angle determined in advance as an angle formed by the imaginary straight line C1 and the linear magnetization region 54A1,
α2 is an angle determined in advance as an angle formed by the imaginary straight line C1 and the linear magnetization region 54A2,
d is a distance determined in advance as a distance in the longitudinal direction LD between the linear magnetization region 54A1 and the linear magnetization region 54B1,
Aᵢ is a second distance, and
Bᵢ is a first distance.

In Expression (1), “α1” is an angle determined in advance as an angle formed by the imaginary straight line C1 and the linear magnetization region 54A1. In Expression (1), “α2” is an angle determined in advance as an angle formed by the imaginary straight line C1 and the linear magnetization region 54A2. In the present embodiment, since the linear magnetization regions 54A1 and 54A2 are inclined line-symmetrically with respect to the imaginary straight line C1, “α1” and “α2” are equivalent.

In Expression (1), “i” is a natural number from 1 to 4. The maximum value of “i” (here, 4) is the number of the magnetization straight lines 54A1a used for the measurement of the PES. In Expression (1), the second distance “Aᵢ” refers to a distance between the magnetization straight line 54A1a and the magnetization straight line 54A2a at positions that correspond to each other in a case where the servo reading element SR crosses the servo pattern 52A along the longitudinal direction LD. Here, the phrase “the magnetization straight line 54A1a and the magnetization straight line 54A2a at positions that correspond to each other” refers to first to fourth magnetization straight line pairs. The first magnetization straight line pair refers to the magnetization straight line 54A1a and the magnetization straight line 54A2a that are positioned on the most upstream side in the running direction of the magnetic tape MT in the linear magnetization regions 54A1 and 54A2. The second magnetization straight line pair refers to the magnetization straight line 54A1a and the magnetization straight line 54A2a that are positioned second from the most upstream side to the downstream side in the running direction of the magnetic tape MT in the linear magnetization regions 54A1 and 54A2. The third magnetization straight line pair refers to the magnetization straight line 54A1a and the magnetization straight line 54A2a that are positioned third from the most upstream side to the downstream side in the running direction of the magnetic tape MT in the linear magnetization regions 54A1 and 54A2. The fourth magnetization straight line pair refers to the magnetization straight line 54A1a and the magnetization straight line 54A2a that are positioned fourth from the most upstream side to the downstream side in the running direction of the magnetic tape MT in the linear magnetization regions 54A1 and 54A2.

In Expression (1), the first distance “Bᵢ” refers to a distance between the magnetization straight line 54A1a and the magnetization straight line 54B1a at positions that correspond to each other in a case where the servo reading element SR crosses the servo pattern 52A and the servo pattern 52B that is adjacent to the servo pattern 52A on the forward direction side along the longitudinal direction LD. Here, the phrase “the magnetization straight line 54A1a and the magnetization straight line 54B1a at positions that correspond to each other” refers to fifth to eighth magnetization straight line pairs. The fifth magnetization straight line pair refers to the magnetization straight line 54A1a and the magnetization straight line 54B1a that are positioned on the most upstream side in the running direction of the magnetic tape MT in the linear magnetization region 54A1 in the servo pattern 52A and the linear magnetization region 54B 1 in the servo pattern 52B that is adjacent to the servo pattern 52A on the forward direction side. The sixth magnetization straight line pair refers to the magnetization straight line 54A1a and the magnetization straight line 54B1a that are positioned second from the most upstream side to the downstream side in the running direction of the magnetic tape MT in the linear magnetization region 54A1 in the servo pattern 52A and the linear magnetization region 54B1 in the servo pattern 52B that is adjacent to the servo pattern 52A on the forward direction side. The seventh magnetization straight line pair refers to the magnetization straight line 54A1a and the magnetization straight line 54B1a that are positioned third from the most upstream side to the downstream side in the running direction of the magnetic tape MT in the linear magnetization region 54A1 in the servo pattern 52A and the linear magnetization region 54B1 in the servo pattern 52B that is adjacent to the servo pattern 52A on the forward direction side. The eighth magnetization straight line pair refers to the magnetization straight line 54A1a and the magnetization straight line 54B1a that are positioned fourth from the most upstream side to the downstream side in the running direction of the magnetic tape MT in the linear magnetization region 54A1 in the servo pattern 52A and the linear magnetization region 54B1 in the servo pattern 52B that is adjacent to the servo pattern 52A on the forward direction side.

In Expression (1), “d” is a distance determined in advance as a distance in the longitudinal direction LD between the linear magnetization region 54A1 and the linear magnetization region 54B1. An example of “d” is a distance determined in advance as a distance between the magnetization straight line 54A1a and the magnetization straight line 54B1a at positions that correspond to each other in a case where the servo reading element SR crosses the servo patterns 52A and 52B along the longitudinal direction LD.

The control device 30 detects the position of the servo reading element SR1 with respect to the servo band SB2 based on the first PES. In addition, the control device 30 detects the position of the servo reading element SR2 with respect to the servo band SB3 based on the second PES. As a result, the control device 30 calculates the servo band interval SBP.

Incidentally, as described above, the servo band interval SBP is calculated in order to accurately position the data read/write element DRW with respect to the division data track. In other words, the servo band interval SBP is required for positioning for each division data track. For example, a method of storing a servo band interval used in the skew control in a case where the magnetic processing is performed on each division data track in a memory (for example, the storage 32 (see FIG. 3) or the cartridge memory 24 (see FIG. 2)) in advance for each division data track is considered. However, in a case where the servo band interval for each division data track is stored in the memory, the storage capacity of the memory is strained as the number of the division data tracks in each data band DB increases.

Therefore, as shown in FIG. 15 as an example, the control device 30 performs servo band interval calculation processing. In the servo band interval calculation processing, the control device 30 calculates the servo band interval by using the first PES and the second PES calculated in the PES calculation processing as described above. Here, the servo band interval is calculated for a specific section along the running direction of the magnetic tape MT in the BOT region 31A (hereinafter, also simply referred to as a “specific section”) in units of the data band DB. The calculated servo band interval is used in the skew control in a case where the magnetic processing is performed on each of the processing target division data tracks.

Here, the specific section refers to, for example, a partial section of the BOT region 31A of the magnetic tape MT (that is, a partial section of the magnetic tape MT along the running direction). Examples of the partial section of the magnetic tape MT include a section included in the first half of the BOT region 31A of the magnetic tape MT, a section included in the second half of the BOT region 31A of the magnetic tape MT, a section included in the middle of the BOT region 31A of the magnetic tape MT, and an intermittent section along the entire length direction of the BOT region 31A of the magnetic tape MT. The intermittent section refers to, for example, equally spaced sections or non-equally spaced sections. In addition, a time interval in which the servo band interval is calculated is, for example, a certain time interval (for example, a sampling period determined in accordance with a clock frequency).

In average value calculation processing, the control device 30 calculates a value obtained by statistically processing the calculation results obtained in the servo band interval calculation processing. Here, the value obtained by statistically processing the calculation results in the servo band interval calculation processing refers to, for example, an average value. Here, the calculation results in the servo band interval calculation processing are an example of “results of measuring an interval between the first servo pattern and the second servo pattern for each of the division areas in a case where the magnetic tape is run” according to the technology of the present disclosure and “results of measuring an interval between the first servo pattern and the second servo pattern in a partial section of the division areas along a running direction of the magnetic tape for each of the division areas in a case where the magnetic tape is run” according to the technology of the present disclosure.

In the average value calculation processing, the control device 30 calculates a servo band average interval for each data band DB based on the calculation result from the servo band interval calculation processing. The servo band average interval is an average value of the servo band intervals SBP calculated in the servo band interval calculation processing for each processing target division data track for the specific section. In addition, here, the servo band average interval is an example of an “average value of results of measuring an interval between the first servo pattern and the second servo pattern for each of the division areas” according to the technology of the present disclosure.

The servo band average interval is an example of a representative interval between the first servo pattern, which is the servo pattern 52 in the first servo band (that is, one servo band SB) of the pair of servo bands SB adjacent to each other via the data band DB, and the second servo pattern, which is the servo pattern 52 in the second servo band (that is, the other servo band SB) of the pair of servo bands SB adjacent to each other via the data band DB.

In the example shown in FIG. 15, a first average interval and a second average interval are shown as an example of the servo band average interval calculated for each data band DB. The first average interval is an example of a representative interval between the servo pattern 52 in the servo band SB1 (see FIG. 7) and the servo pattern 52 in the servo band SB2 (see FIG. 7). The second average interval is an example of a representative interval between the servo pattern 52 in the servo band SB2 (see FIG. 7) and the servo pattern 52 in the servo band SB3 (see FIG. 7).

In the average value calculation processing, the control device 30 calculates the average value of the servo band intervals used in the tracking control in a case where the magnetic processing is performed on each processing target division data track in the data band DB1 for the specific section, as the first average interval. The first average interval is commonly used for each division data track included in the data band DB1 as a servo band interval used for the skew control in a case where the magnetic processing is performed on each division data track included in the data band DB1 designated as the processing target data band.

In the average value calculation processing, the control device 30 calculates the average value of the servo band intervals used in the tracking control in a case where the magnetic processing is performed on each processing target division data track in the data band DB2 for the specific section, as the second average interval. The second average interval is commonly used for each division data track included in the data band DB2 as a servo band interval used for the skew control in a case where the magnetic processing is performed on each division data track included in the data band DB2 designated as the processing target data band.

In the example shown in FIG. 15, the average value is shown as the representative interval of the servo band interval SBP for each data band DB, but this is merely an example. The representative interval of the servo band interval SBP for each data band DB may be a statistical value such as a median, a mode, a maximum value, or a minimum value.

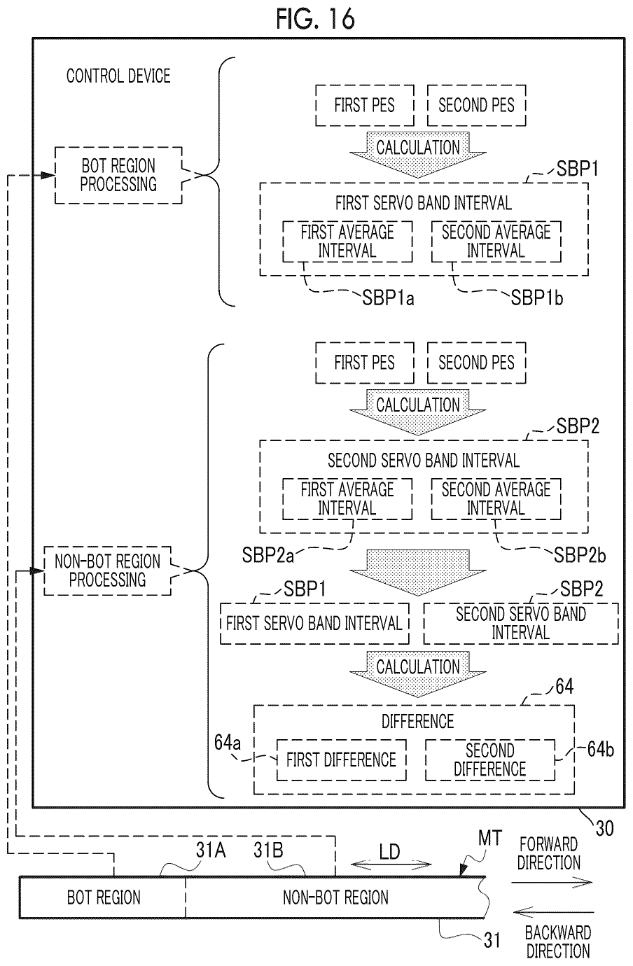

As shown in FIG. 16 as an example, the front surface 31 of the magnetic tape MT is roughly divided into the BOT region 31A and a non-BOT region 31B. The non-BOT region 31B refers to a region other than the BOT region 31A in the front surface 31. In the present embodiment, the BOT region 31A is an example of a “storage medium”, a “BOT region”, and a “partial region of the magnetic tape” according to the technology of the present disclosure. The control device 30 performs BOT region processing and non-BOT region processing in a state in which the magnetic tape MT is running in one direction (for example, in the forward direction) at a constant speed. The BOT region processing is performed on the BOT region 31A in a state in which the magnetic head 28 is skewed at the angle β as described above. The non-BOT region processing is performed on the non-BOT region 31B in a state in which the magnetic head 28 is skewed at the angle β.

In the BOT region processing, the control device 30 calculates the first PES and the second PES in the BOT region 31A. The control device 30 calculates a first servo band interval SBP1 from the calculated first PES and second PES. The first servo band interval SBP1 is the servo band interval SBP in the BOT region 31A. For example, the first servo band interval SBP1 is a first average interval SBP1a and a second average interval SBP1b for each data band DB in the BOT region 31A, as the servo band interval in the BOT region 31A.

In the non-BOT region processing, the control device 30 calculates the first PES and the second PES in the non-BOT region 31B. The control device 30 calculates a second servo band interval SBP2 from the calculated first PES and second PES. The second servo band interval SBP2 is the servo band interval SBP in the non-BOT region 31B. For example, the second servo band interval SBP2 is a first average interval SBP2a and a second average interval SBP2b for each data band DB in the non-BOT region 31B, as the servo band interval in the non-BOT region 31B.

The control device 30 calculates a difference 64 between the first servo band interval SBP1 and the second servo band interval SBP2. The difference 64 is a difference between the servo band interval SBP for each data band DB included in the first servo band interval SBP1 and the servo band interval SBP for each data band DB included in the second servo band interval SBP2. For example, the control device 30 calculates a first difference 64a that is a difference between the first average interval SBP1a and the first average interval SBP2a (that is, a difference between an average value of the servo band interval SBP of the data band DB1 in the BOT region 31A and an average value of the servo band interval SBP of the data band DB1 in the non-BOT region 31B). In addition, the control device 30 calculates a second difference 64b that is a difference between the second average interval SBP1b and the second average interval SBP2b (that is, a difference between an average value of the servo band interval SBP of the data band DB2 in the BOT region 31A and an average value of the servo band interval SBP of the data band DB2 in the non-BOT region 31B).

An example of the first difference 64a is a value obtained by subtracting the first average interval SBP2a from the first average interval SBP1a. Note that this is merely an example, and the first difference 64a may be a value obtained by subtracting the first average interval SBP1a from the first average interval SBP2a. In addition, the first difference 64a may be a proportion of the first average interval SBP1a to the first average interval SBP2a, or a proportion of the first average interval SBP2a to the first average interval SBP1a. As described above, a difference degree between the first average interval SBP1a and the first average interval SBP2a may be any value as long as the difference degree can be specified. In addition, similarly to the first difference 64a, the second difference 64b may be any value as long as a difference degree between the second average interval SBP1b and the second average interval SBP2b can be specified.

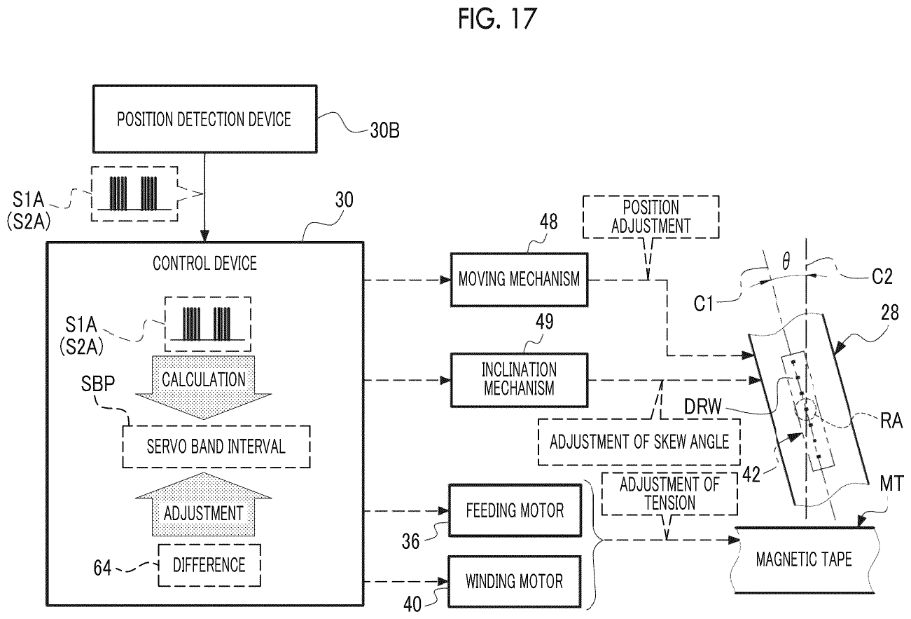

As shown in FIG. 17 as an example, the control device 30 performs the skew control based on the first servo band interval SBP1 and the second servo band interval SBP2. For example, the control device 30 performs the skew control by using the difference 64 obtained from the first servo band interval SBP1 and the second servo band interval SBP2. The skew control is implemented by operating the inclination mechanism 49 such that an angle formed by the imaginary straight line C1 and the imaginary straight line C2 is an angle θ determined from the difference 64.

In addition, the control device 30 may perform the tension control based on the first servo band interval SBP1 and the second servo band interval SBP2. The tension control is implemented by operating the feeding motor 36 and the winding motor 40 such that the rotation speed, the rotation torque, and the like of each of the feeding motor 36 and the winding motor 40 are the rotation speed, the rotation torque, and the like uniquely determined from the servo band interval SBP adjusted by using the difference 64.

In addition, the control device 30 performs various types of control based on the result (that is, the servo pattern signals S1A and S2A) of the position detection by the position detection device 30B. For example, the control device 30 performs the tracking control based on the result of the position detection by the position detection device 30B. That is, the control device 30 adjusts the position of the magnetic head 28 by operating the moving mechanism 48 based on the result of the position detection by the position detection device 30B.

In the present embodiment, the form example has been described in which the first linear magnetization region signal S1a and the second linear magnetization region signal S1b are detected by using the autocorrelation coefficient, but the technology of the present disclosure is not limited to this, and the first linear magnetization region signal S1a and the second linear magnetization region signal S1b may be detected by using a plurality of threshold values. Examples of the plurality of threshold values include a first threshold value and a second threshold value. A magnitude relationship between the first threshold value and the second threshold value is “first threshold value>second threshold value”. The first threshold value is a value derived in advance based on an amplitude expected as the amplitude of the waveform of the second linear magnetization region signal S1b, and is used to detect the second linear magnetization region signal S1b. The second threshold value is a value derived in advance based on an amplitude expected as the amplitude of the waveform of the first linear magnetization region signal S1a and the amplitude expected as the amplitude of the waveform of the second linear magnetization region signal S1b. The first threshold value and the second threshold value are used to detect the first linear magnetization region signal S1a.

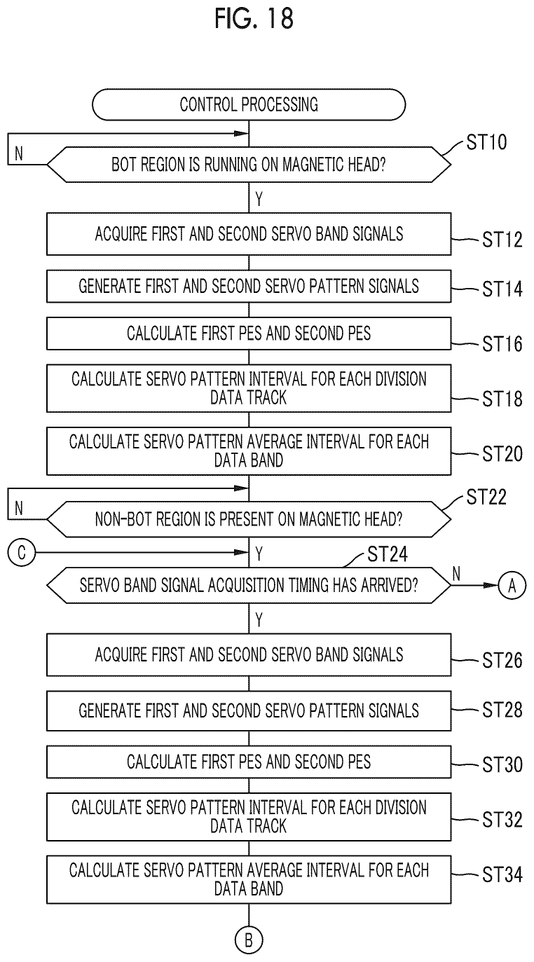

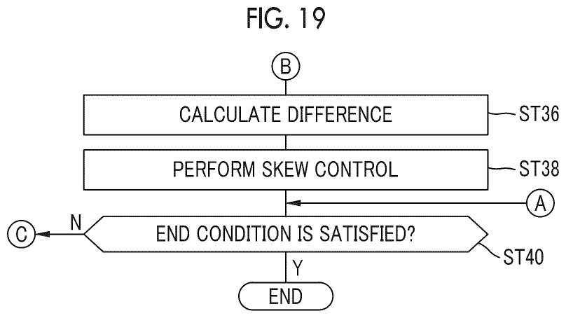

Next, the action of the magnetic tape system 10 will be described with reference to FIGS. 18 and 19.

FIGS. 18 and 19 show an example of a flow of control processing executed by the control device 30 in a case where the magnetic tape MT runs in the forward direction from the BOT region 31A to an EOT region (not shown). The control processing is an example of “signal processing” according to the technology of the present disclosure. The control processing includes the BOT region processing and the non-BOT region processing. The flow of the flowchart shown in FIGS. 18 and 19 is an example of a “signal processing method” according to the technology of the present disclosure.

In step ST10 shown in FIG. 18, the control device 30 determines whether or not the BOT region 31A is running on the magnetic head 28. In step ST10, in a case where the BOT region 31A is not running on the magnetic head 28, a negative determination is made, and the determination in step ST10 is made again. In step ST10, in a case where the BOT region 31A is running on the magnetic head 28, a positive determination is made, and the control processing proceeds to step ST12.

In step ST12, the control device 30 acquires the first servo band signal S1 from the servo reading element SR1, and acquires the second servo band signal S2 from the servo reading element SR2. After executing the processing of step ST12, the control processing proceeds to step ST14.

In step ST14, the control device 30 generates the first servo pattern signal S1A from the first servo band signal S1 acquired in step ST12, and generates the second servo pattern signal S2A from the second servo band signal S2. After executing the processing of step ST14, the control processing proceeds to step ST16.

In step ST16, the control device 30 calculates the first PES from the first servo pattern signal S1A generated in step ST14, and calculates the second PES from the second servo pattern signal S2A generated in step ST14. After executing the processing of step ST16, the control processing proceeds to step ST18.

In step ST18, the control device 30 calculates the servo band interval SBP for each processing target division data track for the specific section along the running direction of the magnetic tape MT, from the first PES and the second PES calculated in step ST16. After executing the processing of step ST18, the control processing proceeds to step ST20.

In step ST20, the control device 30 calculates the average interval between adjacent servo bands for each data band DB (for example, the first average interval SBP1a and the second average interval SBP1b) from the servo band interval SBP calculated in step ST18. After executing the processing of step ST20, the control processing proceeds to step ST22.

In step ST22, the control device 30 determines whether or not the non-BOT region 31B is present on the magnetic head 28. In step ST22, in a case where the non-BOT region 31B is not present on the magnetic head 28, a negative determination is made, and the determination in step ST22 is made again. In step ST22, in a case where the non-BOT region 31B is present on the magnetic head 28, a positive determination is made, and the control processing proceeds to step ST24.

In step ST24, the control device 30 determines whether or not a timing for acquiring the servo band signal (hereinafter, referred to as a “servo band signal acquisition timing”) has arrived. A first example of the servo band signal acquisition timing is a timing at which the beginning of the frame 50 reaches over the magnetic element unit 42. As a second example of the servo band signal acquisition timing is a timing at which the beginning of the frame 50 reaches on the magnetic element unit 42 after a predetermined number of frames 50 (for example, a predetermined number within a range of tens to tens of millions) pass over the magnetic element unit 42. A third example of the servo band signal acquisition timing is a timing at which a certain time (for example, a time determined within a range of several milliseconds to several minutes) has elapsed since the processing of step ST24 is started.

In step ST24, in a case where the servo band signal acquisition timing has not arrived, a negative determination is made, and the control processing proceeds to step ST40. In step ST24, in a case where the servo band signal acquisition timing has arrived, a positive determination is made, and the control processing proceeds to step ST26.

In step ST26, the control device 30 acquires the first servo band signal S1 from the servo reading element SR1, and acquires the second servo band signal S2 from the servo reading element SR2. After executing the processing of step ST26, the control processing proceeds to step ST28.

In step ST28, the control device 30 generates the first servo pattern signal S1A from the first servo band signal S1 acquired in step ST26, and generates the second servo pattern signal S2A from the second servo band signal S2. After executing the processing of step ST28, the control processing proceeds to step ST30.

In step ST30, the control device 30 calculates the first PES from the first servo pattern signal S1A generated in step ST28, and calculates the second PES from the second servo pattern signal S2A generated in step ST28. After executing the processing of step ST28, the control processing proceeds to step ST32.

In step ST32, the control device 30 calculates the servo band interval SBP for each processing target division data track for the specific section along the running direction of the magnetic tape MT, from the first PES and the second PES calculated in step ST30. After executing the processing of step ST32, the control processing proceeds to step ST34.

In step ST34 shown in FIG. 19, the control device 30 calculates the average interval between adjacent servo bands for each data band DB (for example, the first average interval SBP2a and the second average interval SBP2b) from the servo band interval SBP calculated in step ST32. After executing the processing of step ST34, the control processing proceeds to step ST36.

In step ST36, the control device 30 calculates the difference 64 between the first servo band interval SBP1 calculated in step ST20 and the second servo band interval SBP2 calculated in step ST34. After executing the processing of step ST36, the control processing proceeds to step ST38.

In step ST38, the control device 30 performs the skew control by using the difference 64 calculated in step ST38. The skew control is implemented by operating the inclination mechanism 49 such that an angle formed by the imaginary straight line C1 and the imaginary straight line C2 is an angle θ determined from the difference 64. After executing the processing of step ST38, the control processing proceeds to step ST40.

In step ST40, the control device 30 determines whether or not a condition for ending the control processing (hereinafter, referred to as an “end condition”) is satisfied. A first example of the end condition is a condition that an instruction to end the control processing is received by the UI system device 34. A second example of the end condition is a condition that the number of the frames 50 passing over the magnetic element unit 42 has reached a predetermined number (for example, a number determined within a range of several to tens of thousands). A third example of the end condition is a condition that a predetermined time (for example, a time designated in advance) has elapsed since the execution of the control processing is started. In step ST40, in a case where the end condition is not satisfied, a negative determination is made, and the control processing proceeds to step ST24. In step ST40, in a case where the end condition is satisfied, a positive determination is made, and the control processing ends.

Here, the form example has been described in which the first servo band interval SBP1 is calculated on the BOT region 31A (see steps ST12 to ST20), but this is merely an example. For example, in a case where the first servo band interval SBP1 is already stored in the storage medium such as the cartridge memory 24 and/or the BOT region 31A, the processing of steps ST12 to ST20 may be replaced with the processing of “reading out the first servo band interval SBP1 from the storage medium”.

As described above, in the magnetic tape system 10, the magnetic head 28 of the magnetic tape drive 14 is provided with the servo reading elements SR1 and SR2. The servo reading element SR1 corresponds to the servo band SB2, and the servo reading element SR2 corresponds to the servo band SB3. The servo reading element SR1 outputs the first servo band signal S1 by reading the servo pattern 52 from the servo band SB2, and the servo reading element SR2 outputs the second servo band signal S2 by reading the servo pattern 52 from the servo band SB3.

The skew control performed by control device 30 is based on the first servo band signal S1 and the second servo band signal S2. Therefore, in a case where there is a variation in the servo band interval SBP for each data band because of design tolerances of the servo band interval SBP, the accuracy of the skew control is reduced by at least the variation in the servo band interval SBP.

In the present configuration, the servo reading element SR1 on the reference region outputs the first servo band signal S1 by reading the servo pattern 52 from the servo band SB2, and the servo reading element SR2 on the reference region outputs the second servo band signal S2 by reading the servo pattern 52 from the servo band SB3. The servo band interval SBP is calculated based on the first PES and the second PES. Then, the skew control is performed based on the servo band interval SBP. Therefore, with the present configuration, the skew control taking into consideration the servo band interval SBP for each of the servo bands SB adjacent to each other in the width direction WD of the magnetic tape MT is implemented.

For example, in the magnetic tape, highly accurate skew control is implemented by taking into consideration the servo band interval SBP for each of the servo bands SB adjacent to each other in the width direction WD of the magnetic tape MT, as compared with a case where the skew control is performed by always applying a constant servo band interval SBP to all pairs of servo bands SB.

In addition, in the magnetic tape system 10, a method of storing the servo band interval SBP used in the skew control in a case of performing the magnetic processing on each division data track in advance in a memory (for example, the storage 32 (see FIG. 3) or the cartridge memory 24 (see FIG. 2)) for each division data track is considered. However, in a case where the servo band interval SBP for each division data track is stored in the memory, the storage capacity of the memory is strained as the number of the division data tracks in each data band increases.

Therefore, in the present embodiment, as the servo band interval SBP used for the skew control, a representative interval between the servo pattern 52 in one servo band SB of the pair of servo bands SB adjacent to each other via the data band DB and the servo pattern 52 in the other servo band SB is used. The representative interval is commonly used for all the division data tracks in the data band DB.

Therefore, with the present configuration, a degree of pressure with respect to the storage capacity of the memory caused by the servo band interval SBP used in a case where the skew control is performed can be reduced. For example, the degree of pressure on the storage capacity of the memory can be reduced as compared with a method in which the servo band interval SBP is stored in the memory (for example, the storage 32) for each division data track and each time the magnetic processing is performed on the division data track, the servo band interval SBP corresponding to the division data track to be subjected to the magnetic processing is acquired from the memory.

In addition, in the magnetic tape system 10, in a case where the magnetic tape MT is caused to run in a stage before the magnetic processing is performed on the data band DB, a value (for example, an average value) obtained by statistically processing the results of measuring the servo band interval SBP for each of the division data tracks included in the data band DB is used as the servo band interval SBP in a case where the skew control is performed. Therefore, with the present configuration, it is possible to reduce the amount of data used for the skew control for each data band DB as compared with a case where the actual measured value of the servo band interval SBP for each division data track is used.

In addition, in the magnetic tape system 10, in a case where the magnetic tape MT is caused to run in a stage before the magnetic processing is performed on the data band DB, a value obtained by statistically processing the results of measuring the servo band interval SBP in a partial section along the running direction of the magnetic tape MT for each division data track included in the data band DB is used as the servo band interval SBP used in a case where the skew control is performed. Therefore, with the present configuration, it is possible to reduce the amount of data used for the skew control for each data band DB as compared with a case where the servo band interval SBP is measured in the entire section of the magnetic tape MT along the running direction.

In addition, in the magnetic tape system 10, the representative interval is an average value of results of measuring the interval between the first servo pattern and the second servo pattern for each of the division data tracks in a case where the magnetic tape MT is run. Therefore, with the present configuration, it is possible to reduce the amount of data used for the skew control for each data band DB as compared with a case where the actual measured value of the servo band interval SBP for each division data track is used as the servo band interval SBP.

In addition, in the magnetic tape system 10, the servo reading element SR1 on the BOT region 31A outputs the first servo band signal S1 by reading the servo pattern 52 from the servo band SB2. In addition, the servo reading element SR2 on the BOT region 31A outputs the second servo band signal S2 by reading the servo pattern 52 from the servo band SB3. The servo band interval SBP is calculated based on the first PES and the second PES. Then, the skew control is performed based on the servo band interval SBP. Therefore, with the present configuration, the skew control taking into consideration the variation in the servo band interval SBP inherent to the magnetic tape MT (for example, the variation in the servo band interval SBP due to the tolerance) is implemented.

The servo band interval SBP in the BOT region 31A reflects the servo band interval SBP in the magnetic tape MT. That is, the variation in the servo band interval SBP in the BOT region 31A reflects the variation in the servo band interval SBP inherent to the magnetic tape MT. Therefore, the servo band interval SBP inherent to the magnetic tape MT can be obtained by obtaining the servo band interval SBP based on the servo band signal derived from the reading result of the servo band SB in the BOT region 31A. Further, by performing the skew control based on the servo band interval SBP, the skew control taking into consideration the variation in the servo band interval SBP is implemented. As a result, the highly accurate skew control taking into consideration the servo band interval SBP for each of the servo bands SB adjacent to each other in the width direction WD of the magnetic tape MT is implemented.

In the above-described embodiment, the form example has been described in which the specific section along the running direction of the magnetic tape MT in the BOT region 31A is a partial section of the magnetic tape MT in the BOT region 31A, but the technology of the present disclosure is not limited to this. For example, the specific section may be the entire section in the BOT region 31A of the magnetic tape MT.

As described above, in the magnetic tape system 10, in a case where the magnetic tape MT is caused to run in a stage before the magnetic processing is performed on the data band DB, a value obtained by statistically processing the results of measuring the servo band interval SBP in the entire section along the running direction of the magnetic tape MT for each division data track included in the data band DB is used as the servo band interval SBP used in a case where the skew control is performed. Therefore, with the present configuration, it is possible to improve the accuracy of data used for the skew control for each data band DB as compared with a case where the servo band interval SBP is measured only in a partial section of the magnetic tape MT along the running direction.

### First Modification Example

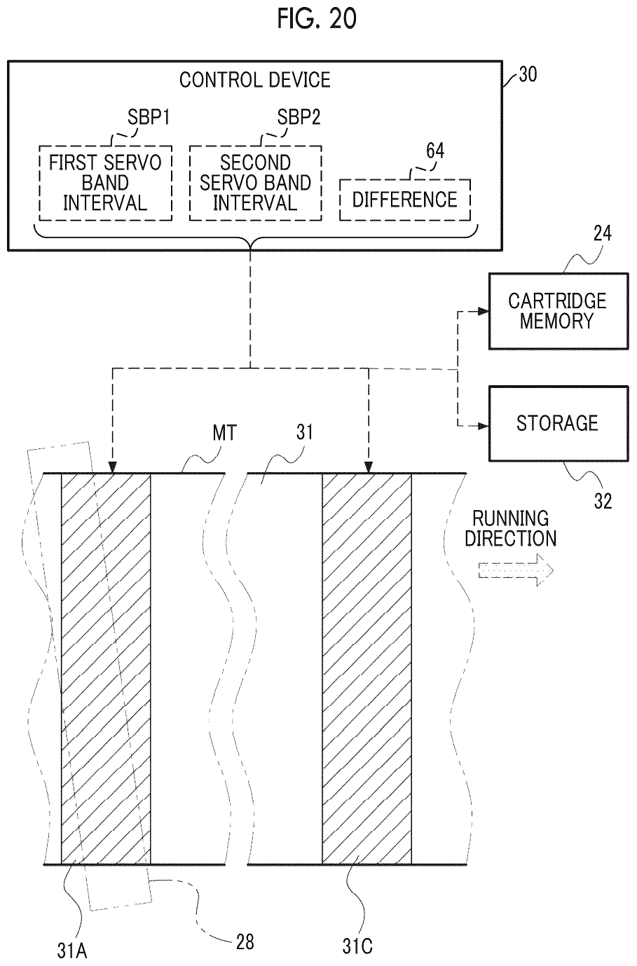

In the above-described embodiment, the form example has been described in which the control device 30 performs the skew control based on the first servo band interval SBP1 and the second servo band interval SBP2, but the technology of the present disclosure is not limited to this. In this first modification example, as shown in FIG. 20 as an example, at least the first servo band interval SBP1 among the first servo band interval SBP1, the second servo band interval SBP2, and the difference 64 is stored in the storage medium, such as the storage 32, the cartridge memory 24, the BOT region 31A, and/or an EOT region 31C, as a signal by the control device 30. In this case, the skew control is implemented by referring to the signal stored in the storage medium. Examples of the values of the first servo band interval SBP1, the second servo band interval SBP2, and the difference 64 stored in the storage medium include values calculated in a case of the initial use of the magnetic tape cartridge 12.

As described above, in the magnetic tape system 10, a signal indicating the first servo band interval SBP1 is stored in the storage medium, such as the storage 32, the cartridge memory 24, the BOT region 31A, and/or the EOT region 31C. The control device 30 reads out the stored first servo band interval SBP1. Further, the control device 30 performs the skew control by using the read-out first servo band interval SBP1. Therefore, with the present configuration, the skew control taking into consideration the servo band interval for each of the servo bands adjacent to each other in the width direction WD of the magnetic tape MT is implemented.

In addition, in the magnetic tape system 10, a signal indicating the first servo band interval SBP1 is stored in the cartridge memory 24 as the storage medium. Therefore, with the present configuration, it is easier to store a signal indicating the first servo band interval SBP1 as compared with a case where a separate recording medium is provided.

In addition, in the magnetic tape system 10, a signal indicating the first servo band interval SBP1 is stored in the BOT region 31A and/or the EOT region 31C as the storage medium. Therefore, with the present configuration, it is easier to store a signal indicating the first servo band interval SBP1 as compared with a case where a separate recording medium is provided.

In addition, at least the first servo band interval SBP1 among the first servo band interval SBP1, the second servo band interval SBP2, and the difference 64 may be output to a display and/or a speaker. In this case, the servo band interval SBP between the servo bands SB adjacent to each other in the width direction WD of the magnetic tape MT can be perceived by the user or the like.

### Second Modification Example

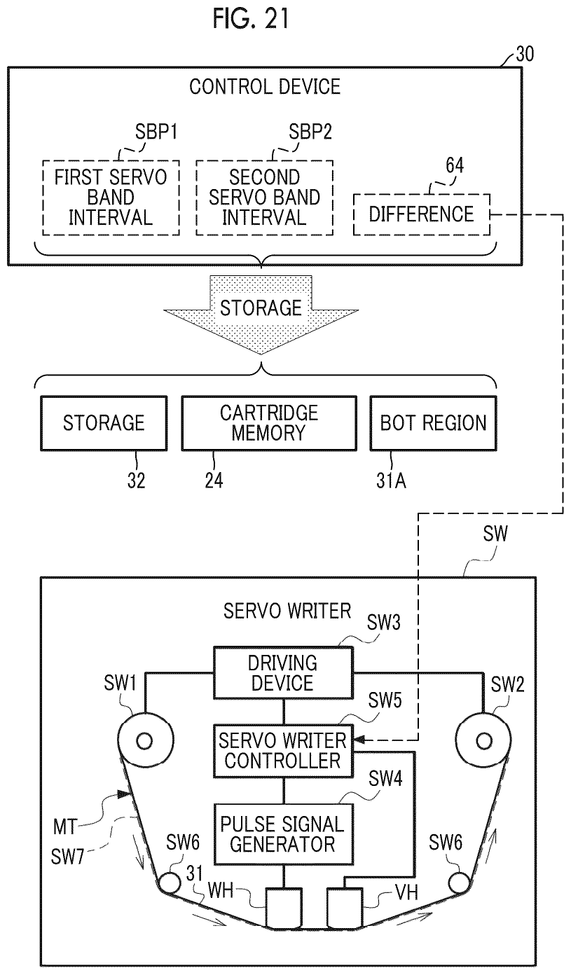

In the above-described embodiment, the form example has been described in which the off-track suppression control is performed based on the difference 64 obtained from the first servo band interval SBP1 and the second servo band interval SBP2, but the technology of the present disclosure is not limited to this. For example, the technology of the present disclosure can also be applied in a case where the servo writer SW records the servo pattern 52 in the servo band SB of the magnetic tape MT. In the example shown in FIG. 21, the servo writer SW comprises a feeding reel SW1, a winding reel SW2, a driving device SW3, a pulse signal generator SW4, a servo writer controller SW5, a plurality of guides SW6, a transport passage SW7, a servo pattern recording head WH, and a verification head VH. The servo writer controller SW5 incorporates a device corresponding to the controller 25 described above.

In a servo pattern recording step, the servo writer SW is used. The servo writer SW comprises a feeding reel SW1, a winding reel SW2, a driving device SW3, a pulse signal generator SW4, a servo writer controller SW5, a plurality of guides SW6, a transport passage SW7, a servo pattern recording head WH, and a verification head VH. The servo writer controller SW5 incorporates a device corresponding to the controller 25 (see FIG. 3) described above.

The servo writer controller SW5 controls the entirety of the servo writer SW. In the present embodiment, the servo writer controller SW5 is implemented by an ASIC, but the technology of the present disclosure is not limited to this. For example, the servo writer controller SW5 may be implemented by an FPGA and/or a PLC. In addition, the servo writer controller SW5 may be implemented by the computer including a CPU, a flash memory (for example, an EEPROM and/or an SSD), and a RAM. In addition, the servo writer controller SW5 may be implemented by combining two or more of an ASIC, an FPGA, a PLC, and a computer. That is, the servo writer controller SW5 may be implemented by a combination of a hardware configuration and a software configuration.

A pancake is set in the feeding reel SW1. The pancake refers to a large-diameter roll in which the magnetic tape MT cut into a product width from a wide web raw material before writing the servo pattern 52 is wound around a hub.

The driving device SW3 has a motor (not shown) and a gear (not shown), and is mechanically connected to the feeding reel SW1 and the winding reel SW2. In a case where the magnetic tape MT is wound by the winding reel SW2, the driving device SW3 generates power in accordance with instructions from the servo writer controller SW5, and transmits the generated power to the feeding reel SW1 and the winding reel SW2 to rotate the feeding reel SW1 and the winding reel SW2. That is, the feeding reel SW1 receives the power from the driving device SW3 and rotates to feed the magnetic tape MT to the predetermined transport passage SW7. The winding reel SW2 receives the power from the driving device SW3 and rotates to wind the magnetic tape MT fed from the feeding reel SW1. The rotation speed, the rotation torque, and the like of the feeding reel SW1 and the winding reel SW2 are adjusted in accordance with a speed at which the magnetic tape MT is wound around the winding reel SW2. The rotation speed, rotation torque, and the like of the feeding reel SW1 and the winding reel SW2 may be adjusted in the same manner as in the tension control in the above-described embodiment.

The plurality of guides SW6 and the servo pattern recording head WH are disposed on the transport passage SW7. The servo pattern recording head WH is disposed on the front surface 31 side of the magnetic tape MT between the plurality of guides SW6. The magnetic tape MT fed from the feeding reel SW1 to the transport passage SW7 is guided by the plurality of guides SW6 and is wound by the winding reel SW2 via the servo pattern recording head WH.

In the servo pattern recording step, the pulse signal generator SW4 generates a pulse signal under the control of the servo writer controller SW5, and supplies the generated pulse signal to the servo pattern recording head WH. In a state in which the magnetic tape MT runs on the transport passage SW7 at a constant speed, the servo pattern recording head WH records the servo pattern 52 on the servo band SB in response to the pulse signal supplied from the pulse signal generator SW4. As a result, for example, the plurality of servo patterns 52 are recorded on the servo band SB of the magnetic tape MT over the total length of the magnetic tape MT (see FIGS. 6 to 9).

In a case where the servo band SB is recorded by the servo pattern recording head WH, the servo band interval may be adjusted by using the first servo band interval SBP1 and the second servo band interval SBP2. For example, during a period in which the servo pattern 52 is recorded in the BOT region 31A, the servo band SB is recorded using the first servo band interval SBP1. In addition, for example, during a period in which the servo pattern 52 is recorded in the non-BOT region 31B, the servo band SB is recorded using the second servo band interval SBP2. As a result, it is possible to suppress the variation in the servo band interval SBP, which is determined by recording the servo pattern 52 on the servo band SB, between the servo writers SW as compared with a case where the servo band interval SBP is not adjusted.

A manufacturing process of the magnetic tape MT includes a plurality of steps in addition to the servo pattern recording step. The plurality of steps include an inspection step and a winding step.

For example, the inspection step is a step of inspecting the servo band SB formed on the front surface 31 of the magnetic tape MT by the servo pattern recording head WH. The inspection of the servo band SB refers to, for example, processing of determining whether the servo pattern 52 recorded on the servo band SB is correct or not. The determination of the correctness of the servo pattern 52 refers to, for example, a determination (that is, verification of the servo pattern 52) whether or not the servo patterns 52A and 52B are recorded in a predetermined portion of the front surface 31 without excess or deficiency of the magnetization straight lines 54A1a, 54A2a, 54B1a, and 54B2a and within an allowable error.

The inspection step is performed by using the servo writer controller SW5 and the verification head VH. The verification head VH is disposed on the downstream side of the servo pattern recording head WH in a transport direction of the magnetic tape MT. In addition, similarly to the magnetic head 28, the verification head VH includes a plurality of servo reading elements (not shown), and the plurality of servo bands SB are read by the plurality of servo reading elements. In this case, the skew control, the tracking control, and the tension control may be performed in the same manner as described in the embodiment.

The verification head VH is connected to the servo writer controller SW5. The verification head VH is disposed at a position facing the servo band SB as viewed from the front surface 31 side of the magnetic tape MT (that is, a rear surface side of the verification head VH), and reads the servo pattern 52 recorded on the servo band SB and outputs the reading result (hereinafter, referred to as “servo pattern reading result”) to the servo writer controller SW5. The servo writer controller SW5 inspects the servo band SB (for example, determines whether the servo pattern 52 is correct or not) based on the servo pattern reading result (for example, the servo pattern signal) input from the verification head VH. For example, since the servo writer controller SW5 incorporates the device corresponding to the controller 25 (see FIG. 3) described above, the servo writer controller SW5 acquires a position detection result from the servo pattern reading result, and inspects the servo band SB by determining whether the servo pattern 52 is correct or not by using the position detection result.

Here, the servo writer controller SW5 performs, for example, servo pattern detection processing to acquire the position detection result from the servo pattern reading result. The ideal waveform signal 66 used in the servo pattern detection processing by the servo writer controller SW5 is the ideal waveform signal 66 stored in the storage (not shown) in the servo writer controller SW5.

The servo writer controller SW5 outputs information indicating the result obtained by inspecting the servo band SB (for example, the result obtained by determining whether the servo pattern 52 is correct or not) to a predetermined output destination (for example, a storage, a display, a tablet terminal, a personal computer, and/or a server).

For example, in a case where the inspection step is ended, the winding step is then performed. The winding step is a step of winding the magnetic tape MT around the feeding reel 22 (that is, the feeding reel 22 (see FIGS. 2 to 4) accommodated in the magnetic tape cartridge 12 (see FIGS. 1 to 4)) used for each of a plurality of the magnetic tape cartridges 12 (see FIGS. 1 to 4). In the winding step, the winding motor (not shown) is used. The winding motor is mechanically connected to the feeding reel 22 via a gear and the like. The winding motor rotates the feeding reel 22 by applying a rotation force to the feeding reel 22 under the control of a processing device (not shown). The magnetic tape MT wound around the winding reel SW2 is wound around the feeding reel 22 by the rotation of the feeding reel 22. In the winding step, a cutting device (not shown) is used. In a case where a required amount of the magnetic tape MT is wound around the feeding reel 22 for each of the plurality of feeding reels 22, the magnetic tape MT fed from the winding reel SW2 to the feeding reel 22 is cut by the cutting device.

In addition, for example, as shown in FIG. 21, in a manufacturing stage of the magnetic tape cartridge 12, at least the first servo band interval SBP1 among the first servo band interval SBP1, the second servo band interval SBP2, and the difference 64 may be stored in the storage medium, such as the storage 32, the cartridge memory 24, and/or the BOT region 31A, as a signal by the control device 30.

In the above description, the servo pattern 52 has been described as an example, but the servo pattern 52 is merely an example, and the technology of the present disclosure is established even in a case where other types of servo patterns (that is, servo patterns having the geometrical characteristics different from the geometrical characteristics of the servo pattern 52) are used. In the following third modification example to tenth modification example, an aspect example of the magnetic tape MT on which a servo pattern of a type different from that of the servo pattern 52 is recorded will be described.

### Third Modification Example

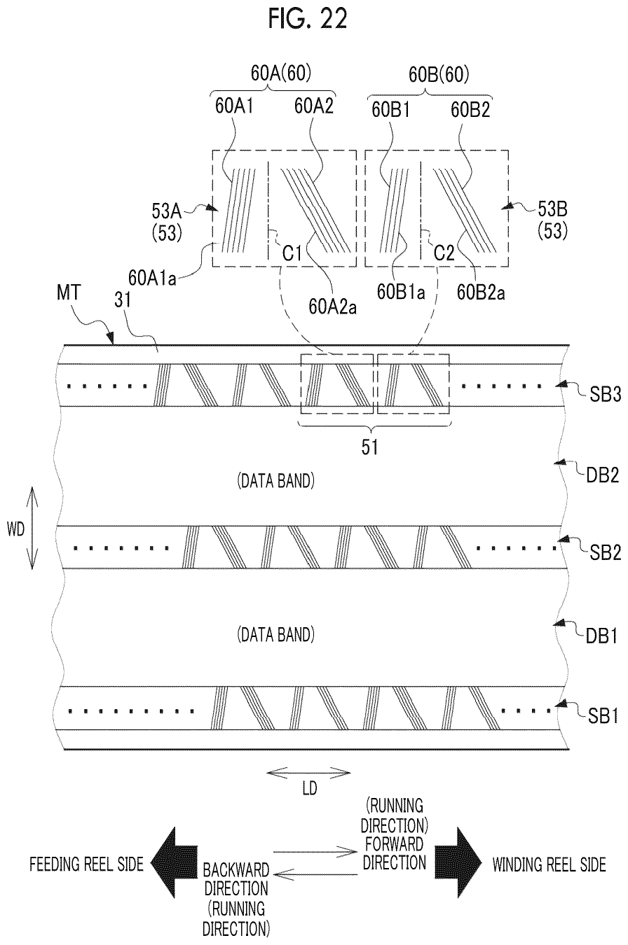

As shown in FIG. 22 as an example, the magnetic tape MT according to this third modification example is different from the magnetic tape MT shown in FIG. 6 in that a frame 51 is provided instead of the frame 50. The frame 51 is defined by a set of servo patterns 53. A plurality of servo patterns 53 are recorded on the servo band SB along the longitudinal direction LD of the magnetic tape MT. The plurality of servo patterns 53 are disposed at regular intervals along the longitudinal direction LD of the magnetic tape MT, similarly to the plurality of servo patterns 52 recorded on the magnetic tape MT shown in FIG. 6.

In the example shown in FIG. 22, servo patterns 53A and 53B are shown as an example of the set of servo patterns 53 included in the frame 51. The servo patterns 53A and 53B are adjacent to each other along the longitudinal direction LD of the magnetic tape MT, and the servo pattern 53A is positioned on the upstream side in the forward direction and the servo pattern 53B is positioned on the downstream side in the forward direction in the frame 51.

The servo pattern 53 consists of a linear magnetization region pair 60. The linear magnetization region pair 60 is classified into a linear magnetization region pair 60A and a linear magnetization region pair 60B.

The servo pattern 53A consists of the linear magnetization region pair 60A. In the example shown in FIG. 22, a pair of linear magnetization regions 60A1 and 60A2 is shown as an example of the linear magnetization region pair 60A. Each of the linear magnetization regions 60A1 and 60A2 is a linearly magnetized region.

The linear magnetization regions 60A1 and 60A2 are inclined in opposite directions with respect to the imaginary straight line C1. The linear magnetization regions 60A1 and 60A2 are not parallel to each other and are inclined at different angles with respect to the imaginary straight line C1. The linear magnetization region 60A1 has a steeper inclined angle with respect to the imaginary straight line C1 than the linear magnetization region 60A2. Here, the term “steep” refers to that, for example, an angle of the linear magnetization region 60A1 with respect to the imaginary straight line C1 is smaller than an angle of the linear magnetization region 60A2 with respect to the imaginary straight line C1. In addition, a total length of the linear magnetization region 60A1 is shorter than a total length of the linear magnetization region 60A2.

In the servo pattern 53A, a plurality of magnetization straight lines 60A1a are included in the linear magnetization region 60A1, and a plurality of magnetization straight lines 60A2a are included in the linear magnetization region 60A2. The number of the magnetization straight lines 60A1a included in the linear magnetization region 60A1 is the same as the number of the magnetization straight lines 60A2a included in the linear magnetization region 60A2.

The linear magnetization region 60A1 is a set of magnetization straight lines 60A1a, which are five magnetized straight lines, and the linear magnetization region 60A2 is a set of magnetization straight lines 60A2a, which are five magnetized straight lines. In the servo band SB, positions of both ends of the linear magnetization region 60A1 (that is, positions of both ends of each of the five magnetization straight lines 60A1a) and positions of both ends of the linear magnetization region 60A2 (that is, positions of both ends of each of the five magnetization straight lines 60A2a) are aligned in the width direction WD. Here, the example has been described in which the positions of both ends of each of the five magnetization straight lines 60A1a and the positions of both ends of each of the five magnetization straight lines 60A2a are aligned, but this is merely an example, and the positions of both ends of one or more magnetization straight lines 60A1a among the five magnetization straight lines 60A1a and the positions of both ends of one or more magnetization straight lines 60A2a among of the five magnetization straight lines 60A2a need only be aligned. In addition, in the present embodiment, the concept of “aligned” also includes meaning of “aligned” including an error generally allowed in the technical field to which the technology of the present disclosure belongs, which is the error to the extent that it does not contradict the purpose of the technology of the present disclosure, in addition to the meaning of being exactly aligned.

The servo pattern 53B consists of the linear magnetization region pair 60B. In the example shown in FIG. 22, a pair of linear magnetization regions 60B1 and 60B2 is shown as an example of the linear magnetization region pair 60B. Each of the linear magnetization regions 60B1 and 60B2 is a linearly magnetized region.

The linear magnetization regions 60B1 and 60B2 are inclined in opposite directions with respect to the imaginary straight line C2. The linear magnetization regions 60B1 and 60B2 are not parallel to each other and are inclined at different angles with respect to the imaginary straight line C2. The linear magnetization region 60B1 has a steeper inclined angle with respect to the imaginary straight line C2 than the linear magnetization region 60B2. Here, the term “steep” refers to that, for example, an angle of the linear magnetization region 60B1 with respect to the imaginary straight line C2 is smaller than an angle of the linear magnetization region 60B2 with respect to the imaginary straight line C2. In addition, a total length of the linear magnetization region 60B1 is shorter than a total length of the linear magnetization region 60B2.

In the servo pattern 53B, a plurality of magnetization straight lines 60B1a are included in the linear magnetization region 60B1, and a plurality of magnetization straight lines 60B2a are included in the linear magnetization region 60B2. The number of the magnetization straight lines 60B1a included in the linear magnetization region 60B1 is the same as the number of the magnetization straight lines 60B2a included in the linear magnetization region 60B2.

The total number of the magnetization straight lines 60B1a and 60B2a included in the servo pattern 53B is different from the total number of the magnetization straight lines 60A1a and 60A2a included in the servo pattern 53A. In the example shown in FIG. 22, the total number of the magnetization straight lines 60A1a and 60A2a included in the servo pattern 53A is ten, whereas the total number of the magnetization straight lines 60B1a and 60B2a included in the servo pattern 53B is eight.

The linear magnetization region 60B1 is a set of magnetization straight lines 60B1a, which are four magnetized straight lines, and the linear magnetization region 60B2 is a set of magnetization straight lines 60B2a, which are four magnetized straight lines. In the servo band SB, positions of both ends of the linear magnetization region 60B1 (that is, positions of both ends of each of the four magnetization straight lines 60B1a) and positions of both ends of the linear magnetization region 60B2 (that is, positions of both ends of each of the four magnetization straight lines 60B2a) are aligned in the width direction WD.

Here, the example has been described in which the positions of both ends of each of the four magnetization straight lines 60B1a and the positions of both ends of each of the four magnetization straight lines 60B2a are aligned, but this is merely an example, and the positions of both ends of one or more magnetization straight lines 60B1a among the four magnetization straight lines 60B1a and the positions of both ends of one or more magnetization straight lines 60B2a among of the four magnetization straight lines 60B2a need only be aligned.

In addition, here, the set of magnetization straight lines 60A1a, which are five magnetized straight lines, is described as an example of the linear magnetization region 60A1, the set of magnetization straight lines 60A2a, which are five magnetized straight lines, is described as an example of the linear magnetization region 60A2, the set of magnetization straight lines 60B1a, which are four magnetized straight lines, is described as an example of the linear magnetization region 60B1, and the set of magnetization straight lines 60B2a, which are four magnetized straight lines, is described as an example of the linear magnetization region 60B2, but the technology of the present disclosure is not limited to this. For example, the linear magnetization region 60A1 need only have the number of the magnetization straight lines 60A1a that contribute to specifying the position of the magnetic head 28 on the magnetic tape MT, the linear magnetization region 60A2 need only have the number of the magnetization straight lines 60A2a that contribute to specifying the position of the magnetic head 28 on the magnetic tape MT, the linear magnetization region 60B1 need only have the number of the magnetization straight lines 60B1a that contribute to specifying the position of the magnetic head 28 on the magnetic tape MT, and the linear magnetization region 60B2 need only have the number of the magnetization straight lines 60B2a that contribute to specifying the position of the magnetic head 28 on the magnetic tape MT.

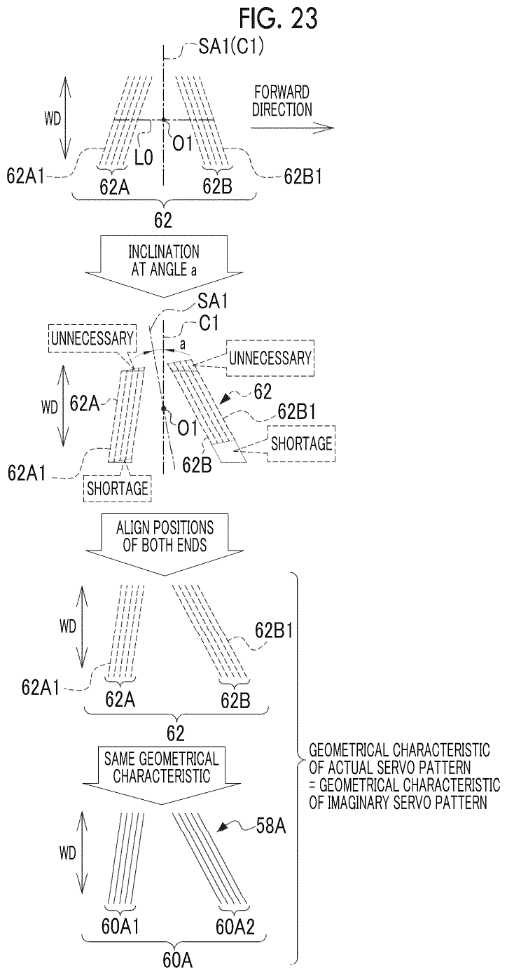

Here, the geometrical characteristics of the linear magnetization region pair 60A on the magnetic tape MT will be described with reference to FIG. 23.

As shown in FIG. 23 as an example, the geometrical characteristics of the linear magnetization region pair 60A on the magnetic tape MT can be expressed by using an imaginary linear region pair 62. The imaginary linear region pair 62 consists of an imaginary linear region 62A and an imaginary linear region 62B. The geometrical characteristics of the linear magnetization region pair 60A on the magnetic tape MT correspond to the geometrical characteristics based on the imaginary linear region pair 62 in a case where an entirety of the imaginary linear region pair 62 is inclined with respect to the imaginary straight line C1 by inclining, with respect to the imaginary straight line C1, a symmetry axis SAI of the imaginary linear region 62A and the imaginary linear region 62B inclined line-symmetrically with respect to the imaginary straight line C1.

The imaginary linear region pair 62 is an imaginary linear magnetization region pair having the same geometrical characteristics as the linear magnetization region pair 54A shown in FIG. 6. The imaginary linear region pair 62 is an imaginary magnetization region used for convenience for describing the geometrical characteristics of the linear magnetization region pair 60A on the magnetic tape MT, and is not an actually present magnetization region.

The imaginary linear region 62A has the same geometrical characteristics as the linear magnetization region 54A1 shown in FIG. 6, and consists of five imaginary straight lines 62A1 corresponding to the five magnetization straight lines 54A1a shown in FIG. 6. The imaginary linear region 62B has the same geometrical characteristics as the linear magnetization region 54B1 shown in FIG. 6, and consists of five imaginary straight lines 62B1 corresponding to the five magnetization straight lines 54A2a shown in FIG. 6.

A center O1 is provided in the imaginary linear region pair 62. For example, the center O1 is a center of a line segment LO connecting a center of the straight line 62A1 positioned on the most upstream side in the forward direction among the five straight lines 62A1 and a center of the straight line 62B1 positioned on the most downstream side in the forward direction among the five straight lines 62B1.

Since the imaginary linear region pair 62 has the same geometrical characteristics as the linear magnetization region pair 54A shown in FIG. 6, the imaginary linear region 62A and the imaginary linear region 62B are inclined line-symmetrically with respect to the imaginary straight line C1. Here, a case will be considered in which reading by the servo reading element SR is performed tentatively with respect to the imaginary linear region pair 62 in a case where the entirety of the imaginary linear region pair 62 is inclined with respect to the imaginary straight line C1 by inclining the symmetry axis SAI of the imaginary linear regions 62A and 62B at an angle a (for example, 10 degrees) with respect to the imaginary straight line C1 with the center O1 as the rotation axis. In this case, in the imaginary linear region pair 62, in the width direction WD, a portion is generated in which the imaginary linear region 62A is read but the imaginary linear region 62B is not read, or the imaginary linear region 62A is not read but the imaginary linear region 62B is read. That is, in each of the imaginary linear regions 62A and 62B, in a case where reading by the servo reading element SR is performed, a shortage part and an unnecessary part are generated.

Therefore, by compensating for the shortage part and removing the unnecessary part, the positions of both ends of the imaginary linear region 62A (that is, the positions of both ends of each of the five straight lines 62A1) and the positions of both ends of the imaginary linear region 62B (that is, the positions of both ends of each of the five straight lines 62B1) are aligned in the width direction WD.

The geometrical characteristics of the imaginary linear region pair 62 (that is, the geometrical characteristics of the imaginary servo pattern) obtained as described above correspond to the geometrical characteristics of the actual servo pattern 53A. That is, the linear magnetization region pair 60A having the geometrical characteristics corresponding to the geometrical characteristics of the imaginary linear region pair 62 obtained by aligning the positions of both ends of the imaginary linear region 62A and the positions of both ends of the imaginary linear region 62B in the width direction WD is recorded on the servo band SB.

The linear magnetization region pair 60B is different from the linear magnetization region pair 60A only in that the four magnetization straight lines 60B1a are provided instead of the five magnetization straight lines 60A1a and the four magnetization straight lines 60B2a are provided instead of the five magnetization straight lines 60A2a. Therefore, the linear magnetization region pair 60B having the geometrical characteristics corresponding to the geometrical characteristics of the imaginary linear region pair (not shown) obtained by aligning the positions of both ends of each of the four straight lines 62A1 and the positions of both ends of each of the four straight lines 62B1 in the width direction WD is recorded on the servo band SB.

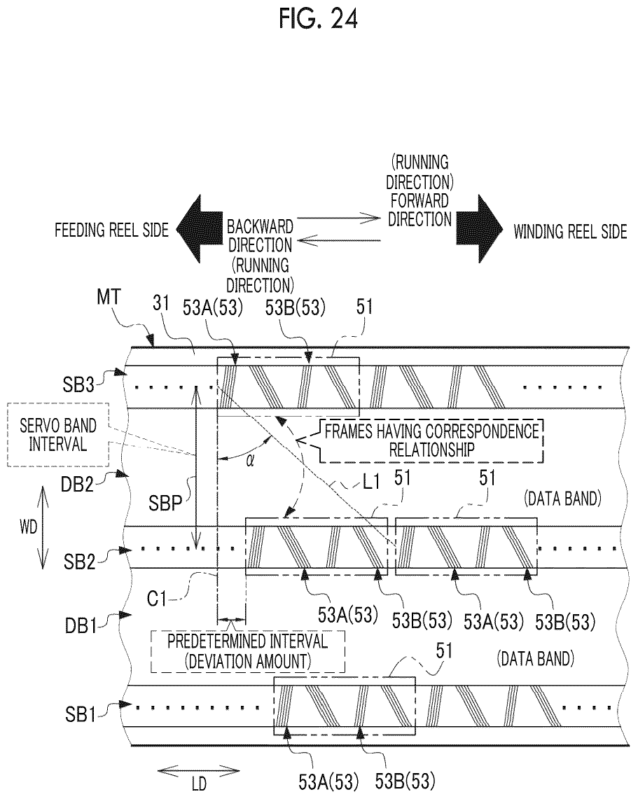

As shown in FIG. 24 as an example, the plurality of servo bands SB are formed on the magnetic tape MT in the width direction WD, and the frames 51 having a correspondence relationship between the servo bands SB deviate from each other at a predetermined interval in the longitudinal direction LD of the magnetic tape MT between the servo bands SB adjacent to each other in the width direction WD. The above description means that the servo patterns 53 having a correspondence relationship between the servo bands SB deviate from each other at the predetermined interval in the longitudinal direction LD of the magnetic tape MT between the servo bands SB adjacent to each other in the width direction WD. The predetermined interval is defined by Expression (1). That is, the positional relationship between the frames 51 between the servo bands SB and the positional relationship between the servo patterns 53 between the servo bands SB are the same as those in the example shown in FIG. 12.

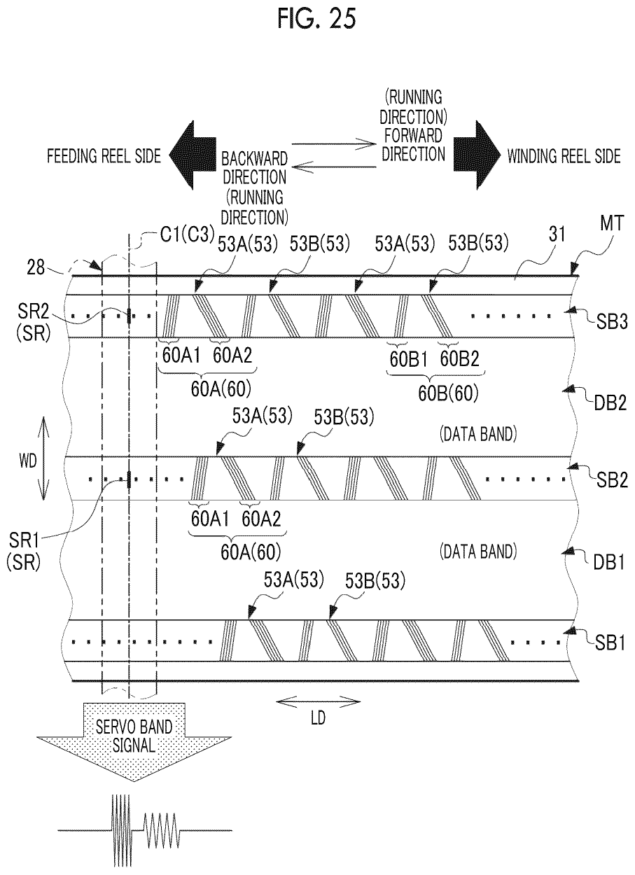

As shown in FIG. 25 as an example, in a case where the servo pattern 53A (that is, the linear magnetization region pair 60A) is read by the servo reading element SR in a state in which the direction of the imaginary straight line C1 and the direction of the imaginary straight line C3 match (that is, a state in which the longitudinal direction of the magnetic head 28 and the width direction WD match), the variation due to the azimuth loss occurs between the servo pattern signal derived from the linear magnetization region 60A1 and the servo pattern signal derived from the linear magnetization region 60A2. In addition, also in a case where the servo pattern 53B (that is, the linear magnetization region pair 60B) is read by the servo reading element SR in a state in which the direction of the imaginary straight line C1 and the direction of the imaginary straight line C3 match (that is, a state in which the longitudinal direction of the magnetic head 28 and the width direction WD match), a similar phenomenon occurs.

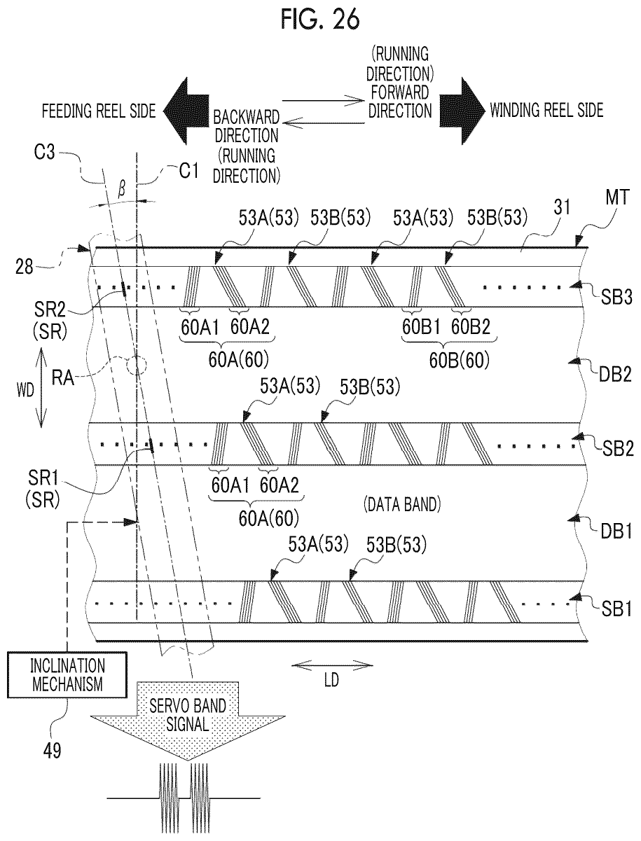

Therefore, as shown in FIG. 26 as an example, the inclination mechanism 49 skews the magnetic head 28 on the magnetic tape MT around the rotation axis RA such that the imaginary straight line C3 is inclined with respect to the imaginary straight line C1 to the upstream side in the forward direction at an angle β (that is, the angle β counterclockwise as viewed from the paper surface side of FIG. 26). As described above, since the magnetic head 28 is inclined to the upstream side in the forward direction at the angle β on the magnetic tape MT, the variation due to the azimuth loss between the servo pattern signal derived from the linear magnetization region 60A1 and the servo pattern signal derived from the linear magnetization region 60A2 is smaller than that in the example shown in FIG. 25. In addition, also in a case where the servo pattern 53B (that is, the linear magnetization region pair 60B) is read by the servo reading element SR, similarly, the variation due to the azimuth loss between the servo pattern signal derived from the linear magnetization region 60B1 and the servo pattern signal derived from the linear magnetization region 60B2 is small.

### Fourth Modification Example

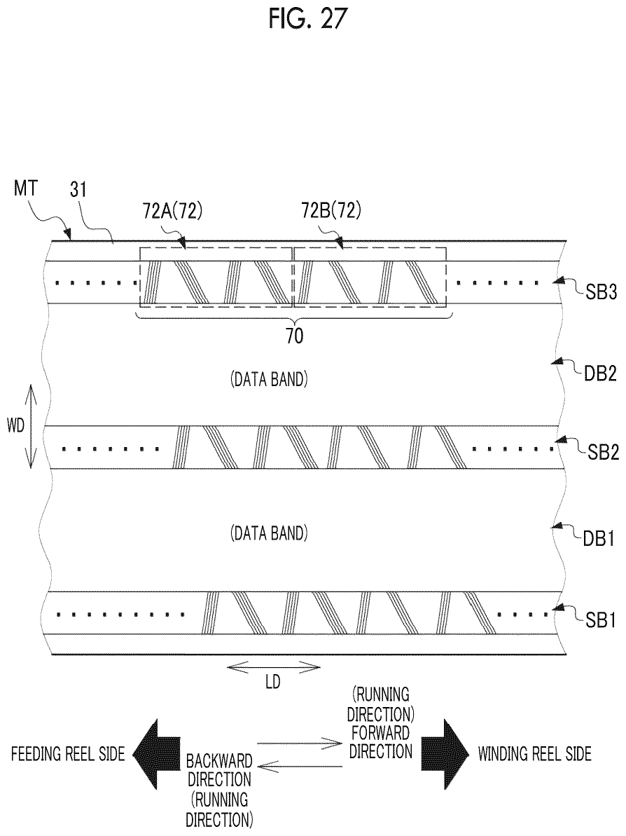

In the third modification example described above, the form example has been described in which the servo band SB is divided by a plurality of frames 51 along the longitudinal direction LD of the magnetic tape MT, but the technology of the present disclosure is not limited to this. For example, as shown in FIG. 27, the servo band SB may be divided by a frame 70 along the longitudinal direction LD of the magnetic tape MT. The frame 70 is defined by a set of servo patterns 72. A plurality of servo patterns 72 are recorded on the servo band SB along the longitudinal direction LD of the magnetic tape MT. The plurality of servo patterns 72 are disposed at regular intervals along the longitudinal direction LD of the magnetic tape MT, similarly to the plurality of servo patterns 52.

In the example shown in FIG. 27, a pair of servo patterns 72A and 72B is shown as an example of the set of servo patterns 72. Each of the servo patterns 72A and 72B is an M-shaped magnetized servo pattern. The servo patterns 72A and 72B are adjacent to each other along the longitudinal direction LD of the magnetic tape MT, and the servo pattern 72A is positioned on the upstream side in the forward direction and the servo pattern 72B is positioned on the downstream side in the forward direction in the frame 70.

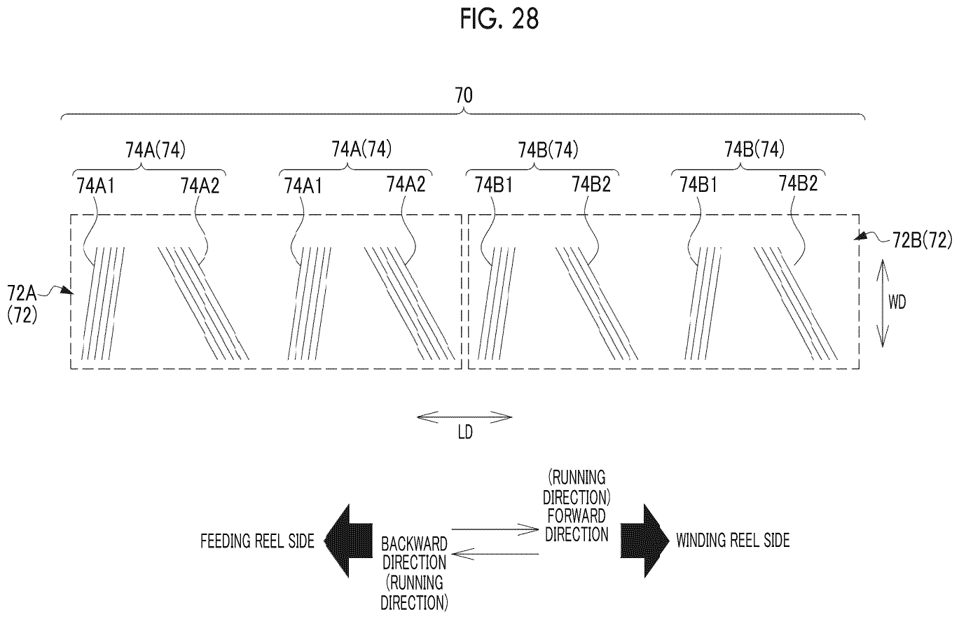

As shown in FIG. 28 as an example, the servo pattern 72 consists of a linear magnetization region pair 74. The linear magnetization region pair 74 is classified into a linear magnetization region pair 74A and a linear magnetization region pair 74B.

The servo pattern 72A consists of a set of linear magnetization region pairs 74A. The set of linear magnetization region pairs 74A is disposed in a state in which the linear magnetization region pairs are adjacent to each other along the longitudinal direction LD of the magnetic tape MT.

In the example shown in FIG. 28, a pair of linear magnetization regions 74A1 and 74A2 is shown as an example of the linear magnetization region pair 74A. The linear magnetization region pair 74A is configured in the same manner as the linear magnetization region pair 60A described in the third modification example, and has the same geometrical characteristics as the linear magnetization region pair 60A. That is, the linear magnetization region 74A1 is configured in the same manner as the linear magnetization region 60A1 described in the third modification example, and has the same geometrical characteristics as the linear magnetization region 60A1, and the linear magnetization region 74A2 is configured in the same manner as the linear magnetization region 60A2 described in the third modification example, and has the same geometrical characteristics as the linear magnetization region 60A2.

The servo pattern 72B consists of a set of linear magnetization region pairs 74B. The set of linear magnetization region pairs 74B is disposed in a state in which the linear magnetization region pairs are adjacent to each other along the longitudinal direction LD of the magnetic tape MT.

In the example shown in FIG. 28, a pair of linear magnetization regions 74B1 and 74B2 is shown as an example of the linear magnetization region pair 74B. The linear magnetization region pair 74B is configured in the same manner as the linear magnetization region pair 60B described in the third modification example, and has the same geometrical characteristics as the linear magnetization region pair 60B. That is, the linear magnetization region 74B1 is configured in the same manner as the linear magnetization region 60B1 described in the third modification example, and has the same geometrical characteristics as the linear magnetization region 60B1, and the linear magnetization region 74B2 is configured in the same manner as the linear magnetization region 60B2 described in the third modification example, and has the same geometrical characteristics as the linear magnetization region 60B2.

### Fifth Modification Example

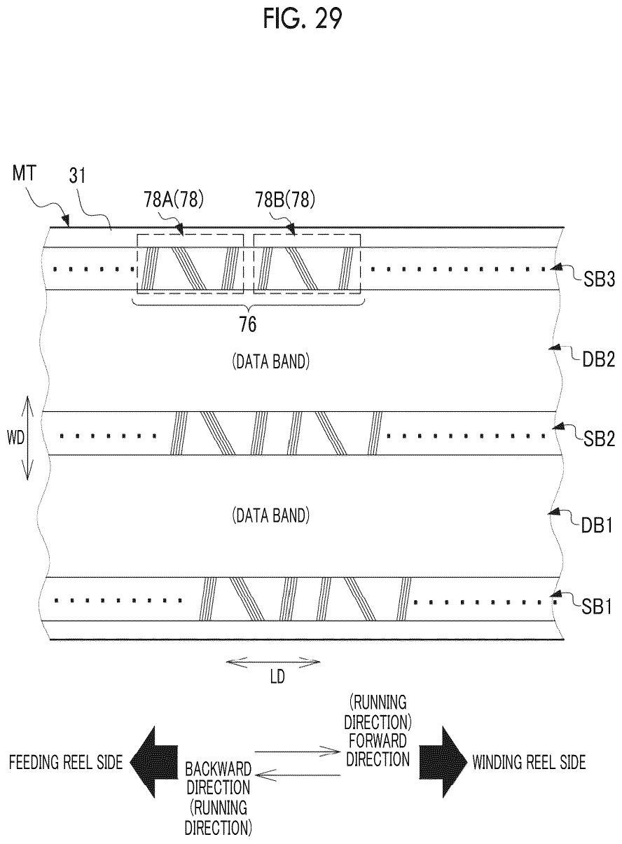

In the example shown in FIG. 27, the form example has been described in which the servo band SB is divided by a plurality of frames 70 along the longitudinal direction LD of the magnetic tape MT, but the technology of the present disclosure is not limited to this. For example, as shown in FIG. 29, the servo band SB may be divided by a frame 76 along the longitudinal direction LD of the magnetic tape MT. The frame 76 is defined by a set of servo patterns 78. A plurality of servo patterns 78 are recorded on the servo band SB along the longitudinal direction LD of the magnetic tape MT. Similarly to the plurality of servo patterns 72 (see FIG. 27), the plurality of servo patterns 78 are disposed at regular intervals along the longitudinal direction LD of the magnetic tape MT.

In the example shown in FIG. 29, servo patterns 78A and 78B are shown as an example of the set of servo patterns 78. Each of the servo patterns 78A and 78B is an N-shaped magnetized servo pattern. The servo patterns 78A and 78B are adjacent to each other along the longitudinal direction LD of the magnetic tape MT, and the servo pattern 78A is positioned on the upstream side in the forward direction and the servo pattern 78B is positioned on the downstream side in the forward direction in the frame 76.

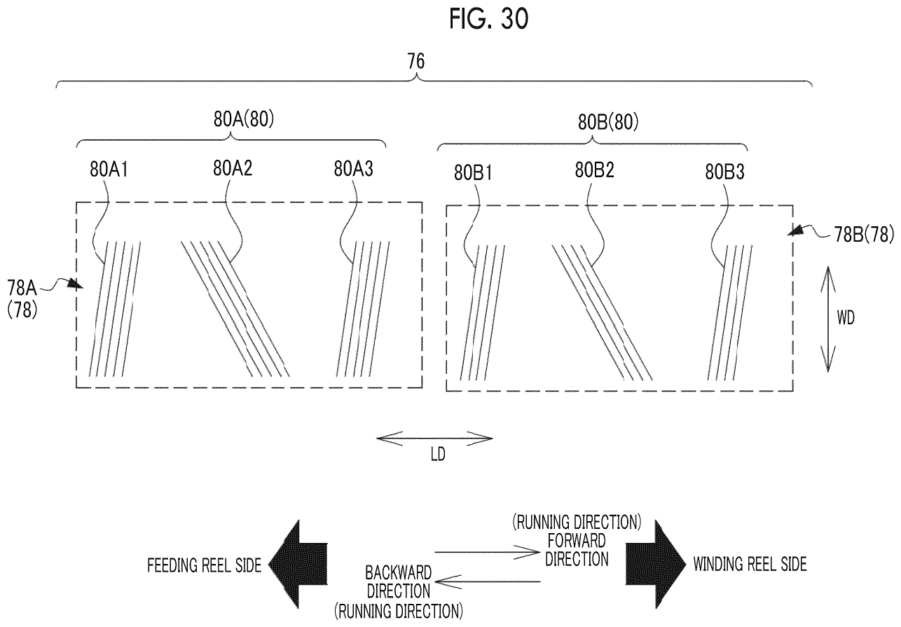

As shown in FIG. 30 as an example, the servo pattern 78 consists of a linear magnetization region group 80. The linear magnetization region group 80 is classified into a linear magnetization region group 80A and a linear magnetization region group 80B.

The servo pattern 78A consists of the linear magnetization region group 80A. The linear magnetization region group 80A consists of linear magnetization regions 80A1, 80A2, and 80A3. The linear magnetization regions 80A1, 80A2, and 80A3 are disposed in a state of being adjacent to each other along the longitudinal direction LD of the magnetic tape MT. The linear magnetization regions 80A1, 80A2, and 80A3 are disposed in the order of the linear magnetization regions 80A1, 80A2, and 80A3 from the upstream side in the forward direction.

The linear magnetization regions 80A1 and 80A2 are configured in the same manner as the linear magnetization region pair 74A shown in FIG. 30, and have the same geometrical characteristics as the linear magnetization region pair 74A. That is, the linear magnetization region 80A1 is configured in the same manner as the linear magnetization region 74A1 shown in FIG. 30, and has the same geometrical characteristics as the linear magnetization region 74A1, and the linear magnetization region 80A2 is configured in the same manner as the linear magnetization region 74A2 shown in FIG. 30, and has the same geometrical characteristics as the linear magnetization region 74A2. In addition, the linear magnetization region 80A3 is configured in the same manner as the linear magnetization region 80A1, and has the same geometrical characteristics as the linear magnetization region 80A1.

The servo pattern 78B consists of the linear magnetization region group 80B. The linear magnetization region group 80B consists of linear magnetization regions 80B1, 80B2, and 80B3. The linear magnetization regions 80B1, 80B2, and 80B3 are disposed in a state of being adjacent to each other along the longitudinal direction LD of the magnetic tape MT. The linear magnetization regions 80B1, 80B2, and 80B3 are disposed in the order of the linear magnetization regions 80B1, 80B2, and 80B3 from the upstream side in the forward direction.

The linear magnetization regions 80B1 and 80B2 are configured in the same manner as the linear magnetization region pair 74B shown in FIG. 30, and have the same geometrical characteristics as the linear magnetization region pair 74B. That is, the linear magnetization region 80B1 is configured in the same manner as the linear magnetization region 74B1 shown in FIG. 30, and has the same geometrical characteristics as the linear magnetization region 74B1, and the linear magnetization region 80B2 is configured in the same manner as the linear magnetization region 74B2 shown in FIG. 30, and has the same geometrical characteristics as the linear magnetization region 74B2. In addition, the linear magnetization region 80B3 is configured in the same manner as the linear magnetization region 80B1, and has the same geometrical characteristics as the linear magnetization region 80B1.

### Sixth Modification Example

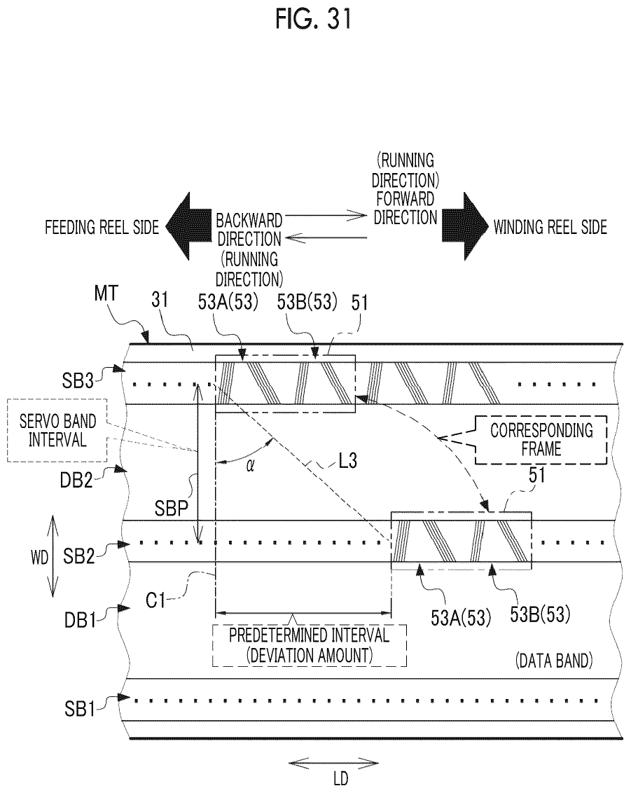

In the third modification example described above, the form example has been described in which the predetermined interval is defined based on the angle α, the servo band interval, and the frame length, but the technology of the present disclosure is not limited to this, and the predetermined interval may be defined without using the frame length. For example, as shown in FIG. 31, the predetermined interval is defined based on the angle α formed by the interval between the frames 51 having the correspondence relationship between the servo bands SB adjacent to each other in the width direction WD (in the example shown in FIG. 31, a line segment L3) and the imaginary straight line C1, and the pitch between the servo bands SB adjacent to each other in the width direction WD (that is, the servo band interval). In this case, for example, the predetermined interval is calculated from Expression (2).

(Predetermined interval)=(Servo band interval)×tan α (2)

As described above, Expression (2) does not include the frame length. This means that the predetermined interval is calculated even in a case where the frame length is not considered. Therefore, with the present configuration, the predetermined interval can be calculated more easily than in a case of calculating the predetermined interval from Expression (1).

### Seventh Modification Example

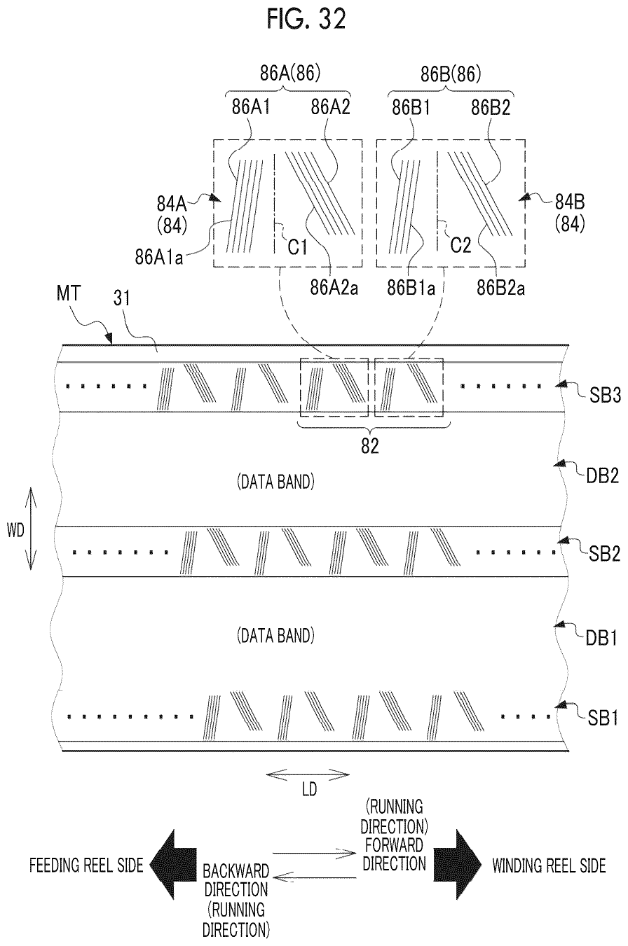

In the third modification example described above, the form example has been described in which the servo band SB is divided by a plurality of frames 51 along the longitudinal direction LD of the magnetic tape MT, but the technology of the present disclosure is not limited to this. For example, as shown in FIG. 32, the servo band SB may be divided by a frame 82 along the longitudinal direction LD of the magnetic tape MT.

The frame 82 is defined by a set of servo patterns 84. A plurality of servo patterns 84 are recorded on the servo band SB along the longitudinal direction LD of the magnetic tape MT. The plurality of servo patterns 84 are disposed at regular intervals along the longitudinal direction LD of the magnetic tape MT, similarly to the plurality of servo patterns 52 (see FIG. 6) recorded on the magnetic tape MT.

In the example shown in FIG. 32, servo patterns 84A and 84B are shown as an example of the set of servo patterns 84 included in the frame 82. The servo patterns 84A and 84B are adjacent to each other along the longitudinal direction LD of the magnetic tape MT, and the servo pattern 84A is positioned on the upstream side in the forward direction and the servo pattern 84B is positioned on the downstream side in the forward direction in the frame 82.

The servo pattern 84A consists of the linear magnetization region pair 86A. In the example shown in FIG. 32, a pair of linear magnetization regions 86A1 and 86A2 is shown as an example of the linear magnetization region pair 86A. Each of the linear magnetization regions 86A1 and 86A2 is a linearly magnetized region.

The linear magnetization regions 86A1 and 86A2 are inclined in opposite directions with respect to the imaginary straight line C1. The linear magnetization regions 86A1 and 86A2 are not parallel to each other and are inclined at different angles with respect to the imaginary straight line C1. The linear magnetization region 86A1 has a steeper inclined angle with respect to the imaginary straight line C1 than the linear magnetization region 86A2. Here, the term “steep” refers to that, for example, an angle of the linear magnetization region 86A1 with respect to the imaginary straight line C1 is smaller than an angle of the linear magnetization region 86A2 with respect to the imaginary straight line C1.

In addition, the overall position of the linear magnetization region 86A1 and the overall position of the linear magnetization region 86A2 deviate from each other in the width direction WD. That is, a position of one end of the linear magnetization region 86A1 and a position of one end of the linear magnetization region 86A2 are not aligned in the width direction WD, and a position of the other end of the linear magnetization region 86A1 and a position of the other end of the linear magnetization region 86A2 are not aligned in the width direction WD.

In the servo pattern 84A, a plurality of magnetization straight lines 86A1a are included in the linear magnetization region 86A1, and a plurality of magnetization straight lines 86A2a are included in the linear magnetization region 86A2. The number of the magnetization straight lines 86A1a included in the linear magnetization region 86A1 is the same as the number of the magnetization straight lines 86A2a included in the linear magnetization region 86A2.

The linear magnetization region 86A1 is a set of magnetization straight lines 86A1a, which are five magnetized straight lines, and the linear magnetization region 86A2 is a set of magnetization straight lines 86A2a, which are five magnetized straight lines.

In the servo band SB, a position of one end of each of all the magnetization straight lines 86A1a included in the linear magnetization region 86A1 in the width direction WD is aligned, and a position of the other end of each of all the magnetization straight lines 86A1a included in the linear magnetization region 86A1 in the width direction WD is also aligned. In addition, in the servo band SB, a position of one end of each of all the magnetization straight lines 86A2a included in the linear magnetization region 86A2 in the width direction WD is aligned, and a position of the other end of each of all the magnetization straight lines 86A2a included in the linear magnetization region 86A2 in the width direction WD is also aligned.

The servo pattern 84B consists of the linear magnetization region pair 86B. In the example shown in FIG. 32, a pair of linear magnetization regions 86B1 and 86B2 is shown as an example of the linear magnetization region pair 86B. Each of the linear magnetization regions 86B1 and 86B2 is a linearly magnetized region.

The linear magnetization regions 86B1 and 86B2 are inclined in opposite directions with respect to the imaginary straight line C2. The linear magnetization regions 86B1 and 86B2 are not parallel to each other and are inclined at different angles with respect to the imaginary straight line C2. The linear magnetization region 86B1 has a steeper inclined angle with respect to the imaginary straight line C2 than the linear magnetization region 86B2. Here, the term “steep” refers to that, for example, an angle of the linear magnetization region 86B1 with respect to the imaginary straight line C2 is smaller than an angle of the linear magnetization region 86B2 with respect to the imaginary straight line C2.

In addition, the overall position of the linear magnetization region 86B1 and the overall position of the linear magnetization region 86B2 deviate from each other in the width direction WD. That is, a position of one end of the linear magnetization region 86B1 and a position of one end of the linear magnetization region 86B2 are not aligned in the width direction WD, and a position of the other end of the linear magnetization region 86B1 and a position of the other end of the linear magnetization region 86B2 are not aligned in the width direction WD.

In the servo pattern 84B, a plurality of magnetization straight lines 86B1a are included in the linear magnetization region 86B1, and a plurality of magnetization straight lines 86B2a are included in the linear magnetization region 86B2. The number of the magnetization straight lines 86B1a included in the linear magnetization region 86B1 is the same as the number of the magnetization straight lines 86B2a included in the linear magnetization region 86B2.

The total number of the magnetization straight lines 86B1a and 86B2a included in the servo pattern 84B is different from the total number of the magnetization straight lines 86A1a and 86A2a included in the servo pattern 84A. In the example shown in FIG. 32, the total number of the magnetization straight lines 86A1a and 86A2a included in the servo pattern 84A is ten, whereas the total number of the magnetization straight lines 86B1a and 86B2a included in the servo pattern 84B is eight.

The linear magnetization region 86B1 is a set of magnetization straight lines 86B1a, which are four magnetized straight lines, and the linear magnetization region 86B2 is a set of magnetization straight lines 86B2a, which are four magnetized straight lines.

In the servo band SB, a position of one end of each of all the magnetization straight lines 86B1a included in the linear magnetization region 86B1 in the width direction WD is aligned, and a position of the other end of each of all the magnetization straight lines 86B1a included in the linear magnetization region 86B1 in the width direction WD is also aligned. In addition, in the servo band SB, a position of one end of each of all the magnetization straight lines 86B2a included in the linear magnetization region 86B2 in the width direction WD is aligned, and a position of the other end of each of all the magnetization straight lines 86B2a included in the linear magnetization region 86B2 in the width direction WD is also aligned.

Here, the set of magnetization straight lines 86A1a, which are five magnetized straight lines, is described as an example of the linear magnetization region 86A1, the set of magnetization straight lines 86A2a, which are five magnetized straight lines, is described as an example of the linear magnetization region 86A2, the set of magnetization straight lines 86B1a, which are four magnetized straight lines, is described as an example of the linear magnetization region 86B1, and the set of magnetization straight lines 86B2a, which are four magnetized straight lines, is described as an example of the linear magnetization region 86B2, but the technology of the present disclosure is not limited to this. For example, the linear magnetization region 86A1 need only have the number of the magnetization straight lines 86A1a that contribute to specifying the position of the magnetic head 28 on the magnetic tape MT, the linear magnetization region 86A2 need only have the number of the magnetization straight lines 86A2a that contribute to specifying the position of the magnetic head 28 on the magnetic tape MT, the linear magnetization region 86B1 need only have the number of the magnetization straight lines 86B1a that contribute to specifying the position of the magnetic head 28 on the magnetic tape MT, and the linear magnetization region 86B2 need only have the number of the magnetization straight lines 86B2a that contribute to specifying the position of the magnetic head 28 on the magnetic tape MT.

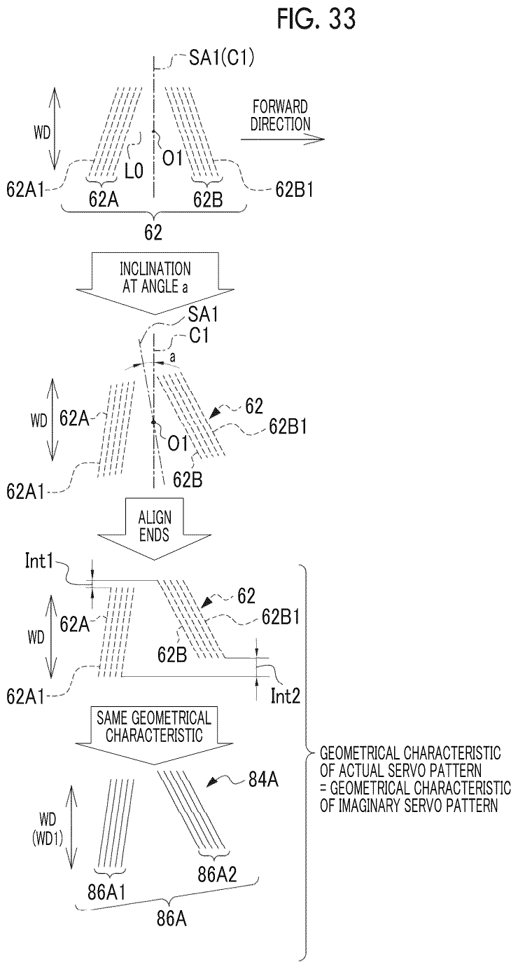

Here, the geometrical characteristics of the linear magnetization region pair 86A on the magnetic tape MT will be described with reference to FIG. 33.

As shown in FIG. 33 as an example, the geometrical characteristics of the linear magnetization region pair 86A on the magnetic tape MT can be expressed by using an imaginary linear region pair 62. Here, the entirety of the imaginary linear region pair 62 is inclined with respect to the imaginary straight line C1 by inclining the symmetry axis SAI of the imaginary linear regions 62A and 62B at an angle a (for example, 10 degrees) with respect to the imaginary straight line C1 with the center O1 as the rotation axis. Moreover, a position of one end of each of all the straight lines 62A1 included in the imaginary linear region 62A of the imaginary linear region pair 62 in this state in the width direction WD is aligned, and a position of the other end of each of all the straight lines 62A1 included in the imaginary linear region 62A in the width direction WD is also aligned. In addition, similarly, a position of one end of each of all the straight lines 62B1 included in the imaginary linear region 62B of the imaginary linear region pair 62 in the width direction WD is aligned, and a position of the other end of each of all the straight lines 62B1 included in the imaginary linear region 62B in the width direction WD is also aligned. As a result, the imaginary linear region 62A and the imaginary linear region 62B deviate from each other in the width direction WD.

That is, one end of the imaginary linear region 62A and one end of the imaginary linear region 62B deviate from each other in the width direction WD at a regular interval Int1, and the other end of the imaginary linear region 62A and the other end of the imaginary linear region 62B deviate from each other in the width direction WD at a regular interval Int2.

The geometrical characteristics of the imaginary linear region pair 62 (that is, the geometrical characteristics of the imaginary servo pattern) obtained as described above correspond to the geometrical characteristics of the actual servo pattern 84A. That is, the geometrical characteristics of the linear magnetization region pair 86A on the magnetic tape MT correspond to the geometrical characteristics based on the imaginary linear region pair 62 in a case where an entirety of the imaginary linear region pair 62 is inclined with respect to the imaginary straight line C1 by inclining, with respect to the imaginary straight line C1, a symmetry axis SAI of the imaginary linear region 62A and the imaginary linear region 62B inclined line-symmetrically with respect to the imaginary straight line C1.

The imaginary linear region 62A corresponds to the linear magnetization region 86A1 of the servo pattern 84A, and the imaginary linear region 62B corresponds to the linear magnetization region 86A2 of the servo pattern 84A. Therefore, on the servo band SB, the servo pattern 84A consisting of the linear magnetization region pair 86A in which one end of the linear magnetization region 86A1 and one end of the linear magnetization region 86A2 deviate from each other in the width direction WD at the regular interval Int1, and the other end of the linear magnetization region 86A1 and the other end of the linear magnetization region 86A2 deviate from each other in the width direction WD at the regular interval Int2 is recorded (see FIG. 32).

The linear magnetization region pair 86B is different from the linear magnetization region pair 86A only in that the four magnetization straight lines 86B1a are provided instead of the five magnetization straight lines 86A1a and the four magnetization straight lines 86B2a are provided instead of the five magnetization straight lines 86A2a (see FIG. 32). Therefore, on the servo band SB, the servo pattern 84B consisting of the linear magnetization region pair 86B in which one end of the linear magnetization region 86B1 and one end of the linear magnetization region 86B2 deviate from each other in the width direction WD at the regular interval Int1, and the other end of the linear magnetization region 86B1 and the other end of the linear magnetization region 86B2 deviate from each other in the width direction WD at the regular interval Int2 is recorded (see FIG. 32).

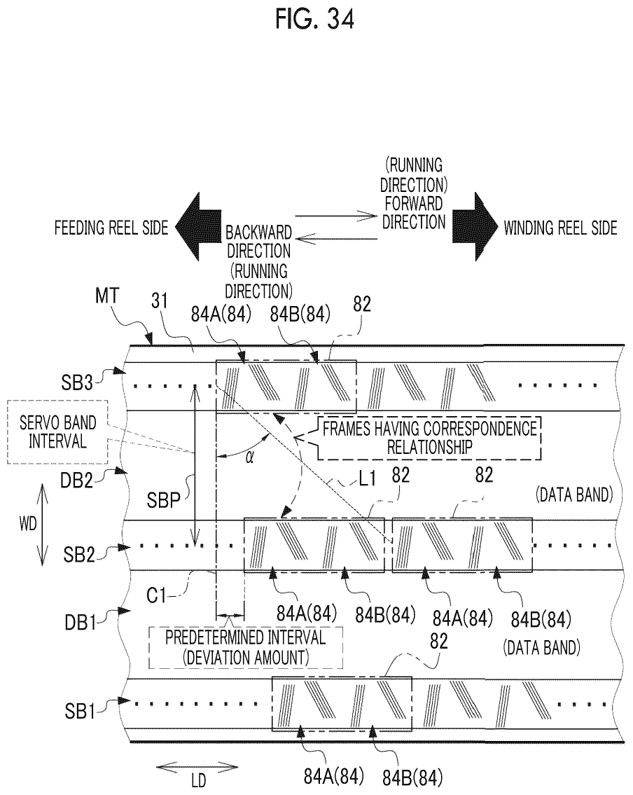

As shown in FIG. 34 as an example, the plurality of servo bands SB are formed on the magnetic tape MT in the width direction WD, and the frames 82 having a correspondence relationship between the servo bands SB deviate from each other at a predetermined interval in the longitudinal direction LD of the magnetic tape MT between the servo bands SB adjacent to each other in the width direction WD. This means that the servo patterns 84 having a correspondence relationship between the servo bands SB deviate from each other at the predetermined interval described in the third modification example in the longitudinal direction LD of the magnetic tape MT between the servo bands SB adjacent to each other in the width direction WD. The predetermined interval is defined by Expression (1).

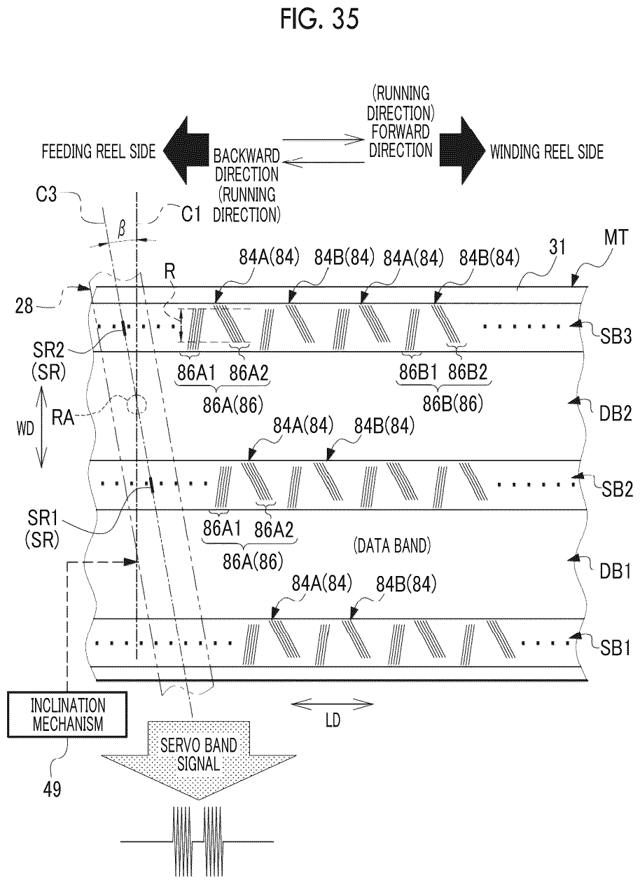

Similarly to the third modification example described above, in the seventh modification example, as shown in FIG. 35 as an example, the inclination mechanism 49 skews the magnetic head 28 on the magnetic tape MT around the rotation axis RA such that the imaginary straight line C3 is inclined with respect to the imaginary straight line C1 to the upstream side in the forward direction at an angle β (that is, the angle β counterclockwise as viewed from the paper surface side of FIG. 35). That is, the magnetic head 28 is inclined at the angle β to the upstream side in the forward direction on the magnetic tape MT. In this state, in a case where the servo pattern 84A is read by the servo reading element SR along the longitudinal direction LD within a range R in which the linear magnetization regions 86A1 and 86A2 overlap with each other in the width direction WD, the variation due to the azimuth loss between the servo pattern signal derived from the linear magnetization region 86A1 and the servo pattern signal derived from the linear magnetization region 86A2 is smaller than in the example shown in FIG. 34. In addition, also in a case where the servo pattern 84B (that is, the linear magnetization region pair 86B) is read by the servo reading element SR, similarly, the variation due to the azimuth loss between the servo pattern signal derived from the linear magnetization region 86B1 and the servo pattern signal derived from the linear magnetization region 86B2 is small.

### Eighth Modification Example

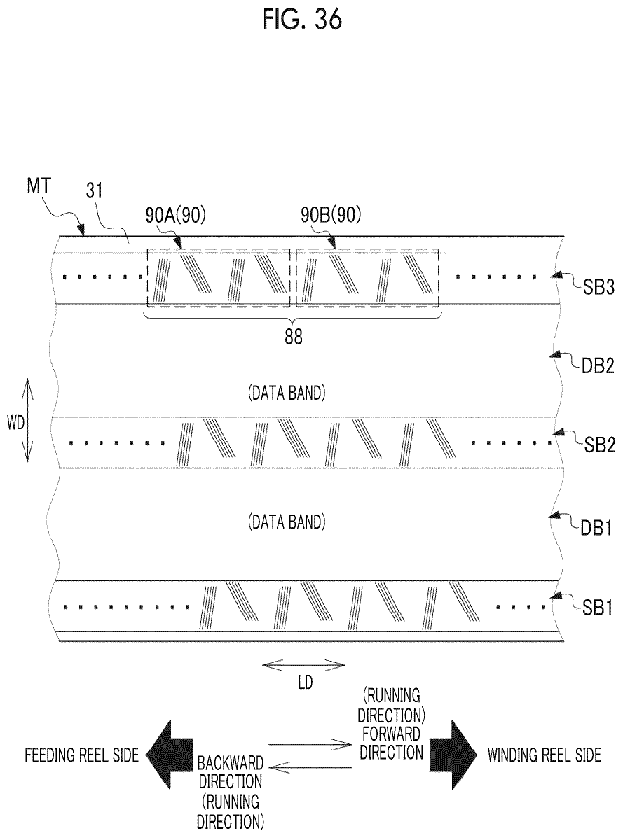

In the seventh modification example described above, the form example has been described in which the servo band SB is divided by a plurality of frames 82 along the longitudinal direction LD of the magnetic tape MT, but the technology of the present disclosure is not limited to this. For example, as shown in FIG. 36, the servo band SB may be divided by a frame 88 along the longitudinal direction LD of the magnetic tape MT. The frame 88 is defined by a set of servo patterns 90. A plurality of servo patterns 90 are recorded on the servo band SB along the longitudinal direction LD of the magnetic tape MT. Similarly to the plurality of servo patterns 84 (see FIG. 32), the plurality of servo patterns 90 are disposed at regular intervals along the longitudinal direction LD of the magnetic tape MT.

In the example shown in FIG. 36, a pair of servo patterns 90A and 90B is shown as an example of the set of servo patterns 90. Each of the servo patterns 90A and 90B is an M-shaped magnetized servo pattern. The servo patterns 90A and 90B are adjacent to each other along the longitudinal direction LD of the magnetic tape MT, and the servo pattern 90A is positioned on the upstream side in the forward direction and the servo pattern 90B is positioned on the downstream side in the forward direction in the frame 88.

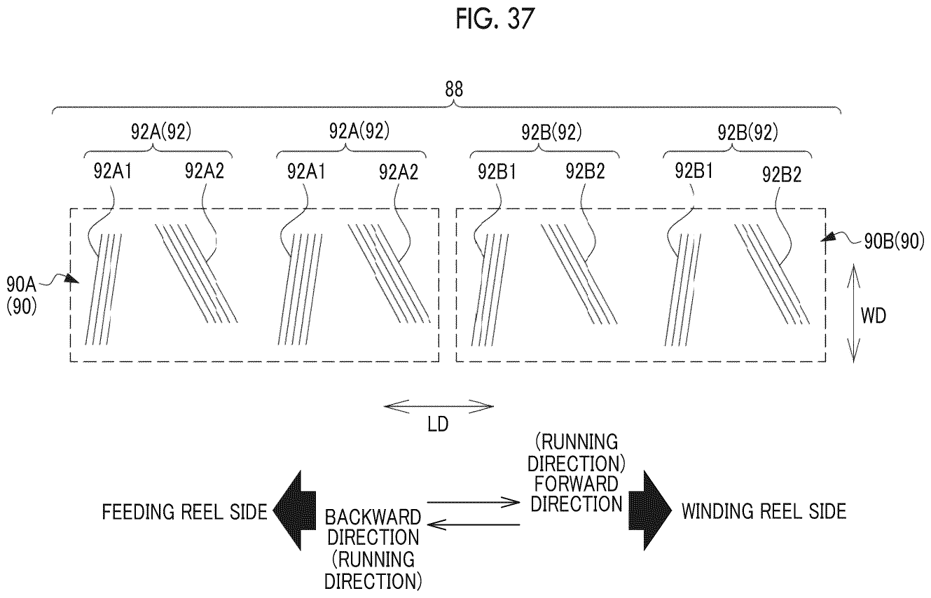

As shown in FIG. 37 as an example, the servo pattern 90 consists of a linear magnetization region pair 92. The linear magnetization region pair 92 is classified into a linear magnetization region pair 92A and a linear magnetization region pair 92B.

The servo pattern 90A consists of a set of linear magnetization region pairs 92A. The set of linear magnetization region pairs 92A is disposed in a state in which the linear magnetization region pairs are adjacent to each other along the longitudinal direction LD of the magnetic tape MT.

In the example shown in FIG. 37, a pair of linear magnetization regions 92A1 and 92A2 is shown as an example of the linear magnetization region pair 92A. The linear magnetization region pair 92A is configured in the same manner as the linear magnetization region pair 86A (see FIG. 32) described in the seventh modification example, and has the same geometrical characteristics as the linear magnetization region pair 86A. That is, the linear magnetization region 92A1 is configured in the same manner as the linear magnetization region 86A1 (see FIG. 32) described in the seventh modification example and has the same geometrical characteristics as the linear magnetization region 86A1, and the linear magnetization region 92A2 is configured in the same manner as the linear magnetization region 86A2 (see FIG. 32) described in the seventh modification example and has the same geometrical characteristics as the linear magnetization region 86A2.

The servo pattern 90B consists of a set of linear magnetization region pairs 92B. The set of linear magnetization region pairs 92B is disposed in a state in which the linear magnetization region pairs are adjacent to each other along the longitudinal direction LD of the magnetic tape MT.

In the example shown in FIG. 37, a pair of linear magnetization regions 92B1 and 92B2 is shown as an example of the linear magnetization region pair 92B. The linear magnetization region pair 92B is configured in the same manner as the linear magnetization region pair 86B (see FIG. 32) described in the seventh modification example, and has the same geometrical characteristics as the linear magnetization region pair 86B. That is, the linear magnetization region 92B 1 is configured in the same manner as the linear magnetization region 86B1 (see FIG. 32) described in the seventh modification example and has the same geometrical characteristics as the linear magnetization region 86B1, and the linear magnetization region 92B2 is configured in the same manner as the linear magnetization region 86B2 (see FIG. 32) described in the seventh modification example and has the same geometrical characteristics as the linear magnetization region 86B2.

### Ninth Modification Example

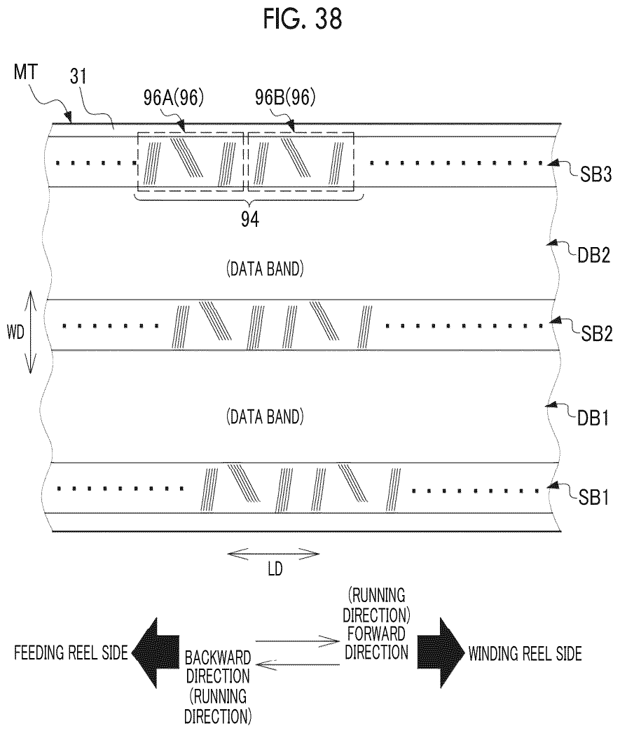

In the example shown in FIG. 36, the form example has been described in which the servo band SB is divided by a plurality of frames 88 along the longitudinal direction LD of the magnetic tape MT, but the technology of the present disclosure is not limited to this. For example, as shown in FIG. 38, the servo band SB may be divided by a frame 94 along the longitudinal direction LD of the magnetic tape MT. The frame 94 is defined by a set of servo patterns 96. A plurality of servo patterns 96 are recorded on the servo band SB along the longitudinal direction LD of the magnetic tape MT. Similarly to the plurality of servo patterns 90 (see FIG. 36), the plurality of servo patterns 96 are disposed at regular intervals along the longitudinal direction LD of the magnetic tape MT.

In the example shown in FIG. 38, servo patterns 96A and 96B are shown as an example of the set of servo patterns 96. Each of the servo patterns 96A and 96B is an N-shaped magnetized servo pattern. The servo patterns 96A and 96B are adjacent to each other along the longitudinal direction LD of the magnetic tape MT, and the servo pattern 96A is positioned on the upstream side in the forward direction and the servo pattern 96B is positioned on the downstream side in the forward direction in the frame 94.

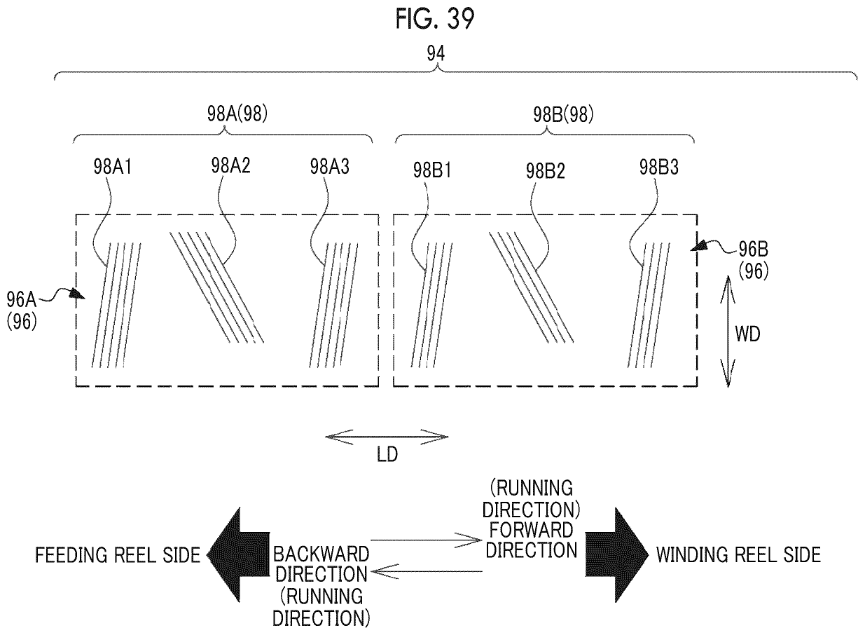

As shown in FIG. 39 as an example, the servo pattern 96 consists of a linear magnetization region group 98. The linear magnetization region group 98 is classified into a linear magnetization region group 98A and a linear magnetization region group 98B.

The servo pattern 96A consists of the linear magnetization region group 98A. The linear magnetization region group 98A consists of linear magnetization regions 98A1, 98A2, and 98A3. The linear magnetization regions 98A1, 98A2, and 98A3 are disposed in a state of being adjacent to each other along the longitudinal direction LD of the magnetic tape MT. The linear magnetization regions 98A1, 98A2, and 98A3 are disposed in the order of the linear magnetization regions 98A1, 98A2, and 98A3 from the upstream side in the forward direction.

The linear magnetization regions 98A1 and 98A2 are configured in the same manner as the linear magnetization region pair 92A shown in FIG. 37, and have the same geometrical characteristics as the linear magnetization region pair 92A. That is, the linear magnetization region 98A1 is configured in the same manner as the linear magnetization region 92A1 shown in FIG. 37, and has the same geometrical characteristics as the linear magnetization region 92A1, and the linear magnetization region 98A2 is configured in the same manner as the linear magnetization region 92A2 shown in FIG. 37, and has the same geometrical characteristics as the linear magnetization region 92A2. In addition, the linear magnetization region 98A3 is configured in the same manner as the linear magnetization region 92A1, and has the same geometrical characteristics as the linear magnetization region 92A1.

The servo pattern 96B consists of the linear magnetization region group 98B. The linear magnetization region group 98B consists of linear magnetization regions 98B1, 98B2, and 98B3. The linear magnetization regions 98B1, 98B2, and 98B3 are disposed in a state of being adjacent to each other along the longitudinal direction LD of the magnetic tape MT. The linear magnetization regions 98B1, 98B2, and 98B3 are disposed in the order of the linear magnetization regions 98B1, 98B2, and 98B3 from the upstream side in the forward direction.

The linear magnetization regions 98B1 and 98B2 are configured in the same manner as the linear magnetization region pair 92B shown in FIG. 37, and have the same geometrical characteristics as the linear magnetization region pair 92B. That is, the linear magnetization region 98B1 is configured in the same manner as the linear magnetization region 92B1 shown in FIG. 37, and has the same geometrical characteristics as the linear magnetization region 92B1, and the linear magnetization region 98B2 is configured in the same manner as the linear magnetization region 92B2 shown in FIG. 37, and has the same geometrical characteristics as the linear magnetization region 92B2. In addition, the linear magnetization region 98B3 is configured in the same manner as the linear magnetization region 92B1, and has the same geometrical characteristics as the linear magnetization region 92B1.

### Tenth Modification Example

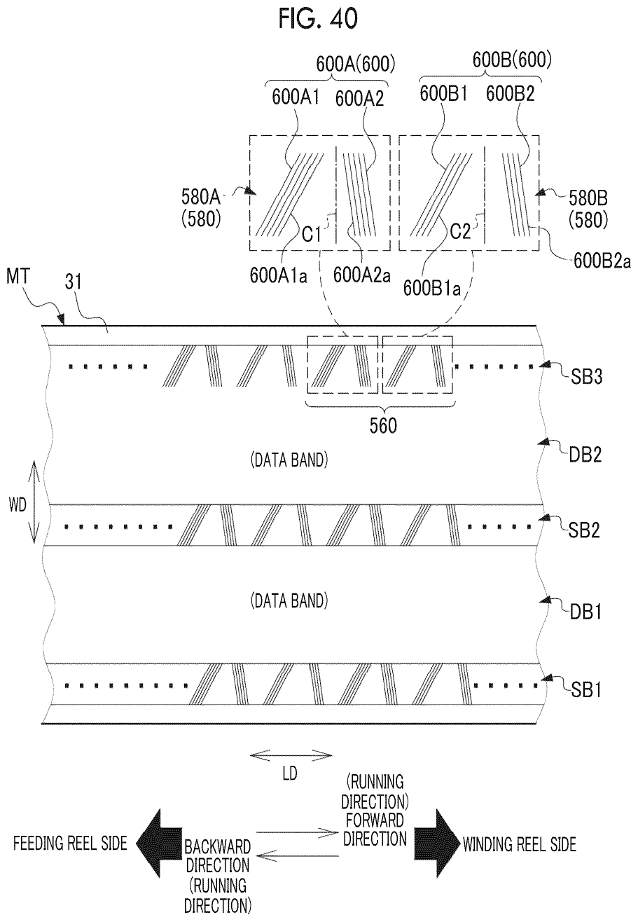

In the third modification example described above (for example, example shown in FIG. 22), the form example has been described in which the servo band SB is divided by the plurality of frames 51 along the longitudinal direction LD of the magnetic tape MT, but the technology of the present disclosure is not limited to this. For example, as shown in FIG. 40, the servo band SB may be divided by a frame 560 along the longitudinal direction LD of the magnetic tape MT. The frame 560 is defined by a set of servo patterns 580. A plurality of servo patterns 580 are recorded on the servo band SB along the longitudinal direction LD of the magnetic tape MT. The plurality of servo patterns 580 are disposed at regular intervals along the longitudinal direction LD of the magnetic tape MT, similarly to the plurality of frames 51.

The servo pattern 580 consists of a linear magnetization region pair 600. The linear magnetization region pair 600 is classified into a linear magnetization region pair 600A and a linear magnetization region pair 600B. That is, the linear magnetization region pair 600 is different from the linear magnetization region pair 60 (see FIG. 22) in that the linear magnetization region pair 600A is provided instead of the linear magnetization region pair 60A, and the linear magnetization region pair 600B is provided instead of the linear magnetization region pair 60B.

The servo pattern 580A consists of the linear magnetization region pair 600A. The linear magnetization region pair 600A is different from the linear magnetization region pair 60A in that the linear magnetization region 600A1 is provided instead of the linear magnetization region 60A1, and the linear magnetization region 600A2 is provided instead of the linear magnetization region 60A2. Each of the linear magnetization regions 600A1 and 600A2 is a linearly magnetized region.

The linear magnetization regions 600A1 and 600A2 are inclined in opposite directions with respect to the imaginary straight line C1. The linear magnetization regions 600A1 and 600A2 are not parallel to each other and are inclined at different angles with respect to the imaginary straight line C1. The linear magnetization region 600A2 has a steeper inclined angle with respect to the imaginary straight line C1 than the linear magnetization region 600A1. Here, the term “steep” refers to that, for example, an angle of the linear magnetization region 600A2 with respect to the imaginary straight line C1 is smaller than an angle of the linear magnetization region 600A1 with respect to the imaginary straight line C1. In addition, a total length of the linear magnetization region 600A2 is shorter than a total length of the linear magnetization region 600A1.

The linear magnetization region 600A1 is different from the linear magnetization region 60A1 in that a plurality of magnetization straight lines 600A1a are provided instead of the plurality of magnetization straight lines 60A1a. The linear magnetization region 600A2 is different from the linear magnetization region 60A2 in that a plurality of magnetization straight lines 600A2a are provided instead of the plurality of magnetization straight lines 60A2a.

The plurality of magnetization straight lines 600A1a are included in the linear magnetization region 600A1, and the plurality of magnetization straight lines 600A2a are included in the linear magnetization region 600A2. The number of the magnetization straight lines 600A1a included in the linear magnetization region 600A1 is the same as the number of the magnetization straight lines 600A2a included in the linear magnetization region 600A2.

The linear magnetization region 600A1 is a linear magnetization region corresponding to a first line symmetry region. The first line symmetry region refers to a region in which the linear magnetization region 60A2 (see FIG. 22) described in the third modification example is formed line-symmetrically with respect to the imaginary straight line C1. That is, the linear magnetization region 600A1 can be said to be a linear magnetization region formed by geometrical characteristics of a mirror image of the linear magnetization region 60A2 (see FIG. 22) (that is, geometrical characteristics obtained by performing the mirror image with respect to the linear magnetization region 60A2 (see FIG. 22) with the imaginary straight line C1 as a line symmetry axis).

The linear magnetization region 600A2 is a linear magnetization region corresponding to a second line symmetry region. The second line symmetry region refers to a region in which the linear magnetization region 60A1 (see FIG. 22) described in the third modification example is formed line-symmetrically with respect to the imaginary straight line C1. That is, the linear magnetization region 600A2 can be said to be a linear magnetization region formed by geometrical characteristics of a mirror image of the linear magnetization region 60A1 (see FIG. 22) (that is, geometrical characteristics obtained by performing the mirror image with respect to the linear magnetization region 60A1 (see FIG. 22) with the imaginary straight line C1 as a line symmetry axis).

That is, in the example shown in FIG. 23, the geometrical characteristics of the imaginary linear region pair 62 obtained by aligning the positions of both ends of the imaginary linear region 62A and the positions of both ends of the imaginary linear region 62B in a case where the entirety of the imaginary linear region pair 62 is inclined with respect to the imaginary straight line C1 by inclining the symmetry axis SAI of the imaginary linear regions 62A and 62B with respect to the imaginary straight line C1 at the angle α clockwise as viewed from the paper surface side of FIG. 23 with the center O1 as the rotation axis correspond to the geometrical characteristics of the servo pattern 580A.

The servo pattern 580B consists of the linear magnetization region pair 600B. The linear magnetization region pair 600B is different from the linear magnetization region pair 60B in that the linear magnetization region 600B1 is provided instead of the linear magnetization region 60B1, and the linear magnetization region 600B2 is provided instead of the linear magnetization region 60B2. Each of the linear magnetization regions 600B1 and 600B2 is a linearly magnetized region.

The linear magnetization regions 600B1 and 600B2 are inclined in opposite directions with respect to the imaginary straight line C2. The linear magnetization regions 600B1 and 600B2 are not parallel to each other and are inclined at different angles with respect to the imaginary straight line C2. The linear magnetization region 600B2 has a steeper inclined angle with respect to the imaginary straight line C2 than the linear magnetization region 600B1. Here, the term “steep” refers to that, for example, an angle of the linear magnetization region 600B2 with respect to the imaginary straight line C2 is smaller than an angle of the linear magnetization region 600B1 with respect to the imaginary straight line C2.

The plurality of magnetization straight lines 600B1a are included in the linear magnetization region 600B1, and the plurality of magnetization straight lines 600B2a are included in the linear magnetization region 600B2. The number of the magnetization straight lines 600B1a included in the linear magnetization region 600B1 is the same as the number of the magnetization straight lines 600B2a included in the linear magnetization region 600B2.

The total number of the magnetization straight lines 600B1a and 600B2a included in the servo pattern 580B is different from the total number of the magnetization straight lines 600A1a and 600A2a included in the servo pattern 580A. In the example shown in FIG. 40, the total number of the magnetization straight lines 600A1a and 600A2a included in the servo pattern 580A is ten, whereas the total number of the magnetization straight lines 600B1a and 600B2a included in the servo pattern 580B is eight.

The linear magnetization region 600B1 is a set of magnetization straight lines 600B1a, which are four magnetized straight lines, and the linear magnetization region 600B2 is a set of magnetization straight lines 600B2a, which are four magnetized straight lines. In the servo band SB, the positions of both ends of the linear magnetization region 600B1 (that is, the positions of both ends of each of the four magnetization straight lines 600B1a) and the positions of both ends of the linear magnetization region 600B2 (that is, the positions of both ends of each of the four magnetization straight lines 600B2a) are aligned in the width direction WD.

As described above, the geometrical characteristics of the servo pattern 580A correspond to the geometrical characteristics of the mirror image of the linear magnetization region 60A2 (see FIG. 22) and the geometrical characteristics of the mirror image of the linear magnetization region 60A2 (see FIG. 22) (that is, geometrical characteristics of the mirror image of the servo pattern 53A shown in FIG. 22), and the geometrical characteristics of the servo pattern 580B correspond to the geometrical characteristics of the mirror image of the linear magnetization region 60B2 (see FIG. 22) and the geometrical characteristics of the mirror image of the linear magnetization region 60B2 (see FIG. 22) (that is, geometrical characteristics of the mirror image of the servo pattern 53B shown in FIG. 22). However, this is merely an example, and instead of the servo pattern 580, the servo pattern formed by the geometrical characteristics of the mirror image of the servo pattern 72 shown in FIG. 27, the geometrical characteristics of the mirror image of the servo pattern 78 shown in FIG. 29, the geometrical characteristics of the mirror image of the servo pattern 84 shown in FIG. 32, the geometrical characteristics of the mirror image of the servo pattern 90 shown in FIG. 36, or the geometrical characteristics of the mirror image of the servo pattern 96 shown in FIG. 38 may be applied.

Even in a case where the geometrical characteristics of the servo pattern are changed in this way, the inclination mechanism 49 changes the direction of the inclination (that is, azimuth) of the imaginary straight line C3 with respect to the imaginary straight line C4 and the inclined angle (for example, angle β shown in FIG. 26) in accordance with the geometrical characteristics of the servo pattern. That is, even in a case where the geometrical characteristics of the servo pattern are changed, in the same manner as in the example shown in FIG. 26, the inclination mechanism 49 rotates, under the control of the control device 30, the magnetic head 28 around the rotation axis RA on the front surface 31 of the magnetic tape MT to change the direction of the inclination of the imaginary straight line C3 with respect to the imaginary straight line C4 (that is, azimuth) and the inclined angle (for example, angle β shown in FIG. 26) such that the variation in the servo pattern signal is reduced.

### Other Modification Examples

In the embodiment described above, the form example has been described in which the front surface 31 of the magnetic tape MT is subjected to the magnetic processing by the magnetic head 28, but the technology of the present disclosure is not limited to this. For example, the back surface 33 of the magnetic tape MT may be formed of the surface of the magnetic layer, and the back surface 33 may be subjected to the magnetic processing by the magnetic head 28.

In the embodiment described above, the magnetic tape system 10 has been described in which the magnetic tape cartridge 12 can be inserted and removed with respect to the magnetic tape drive 14, but the technology of the present disclosure is not limited to this. For example, even in a case of the magnetic tape system in which at least one magnetic tape cartridge 12 is loaded in advance into the magnetic tape drive 14 (that is, the magnetic tape system in which at least one magnetic tape cartridge 12 and the magnetic tape drive 14 or the magnetic tape MT are integrated in advance (for example, before the data is recorded in the data band DB)), the technology of the present disclosure is established.

In the embodiment described above, the single magnetic head 28 has been described, but the technology of the present disclosure is not limited to this. For example, a plurality of magnetic heads 28 may be disposed on the magnetic tape MT. For example, the magnetic head 28 for reading and at least one magnetic head 28 for writing may be disposed on the magnetic tape MT. The magnetic head 28 for reading may be used for verifying the data recorded on the data band DB by the magnetic head 28 for writing. In addition, one magnetic head on which the magnetic element unit 42 for reading and at least one magnetic element unit 42 for writing are mounted may be disposed on the magnetic tape MT.

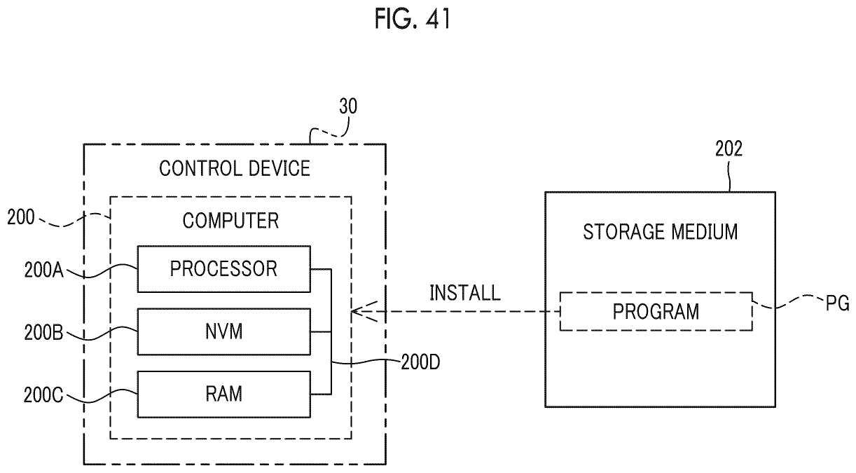

In the embodiment described above, the form example has been described in which the control device 30 (see FIG. 3) is implemented by the ASIC, but the technology of the present disclosure is not limited to this, and the control device 30 may be implemented by the software configuration. In addition, only the control device 30 and the position detection device 30 may be implemented by the software configuration. In a case where the control device 30 and the position detection device 30B are implemented by the software configuration, for example, as shown in FIG. 41, the control device 30 comprises a computer 200. The computer 200 includes a processor 200A (for example, a single CPU or a plurality of CPUs), an NVM 200B, and a RAM 200C. The processor 200A, the NVM 200B, and the RAM 200C are connected to a bus 200D. A program PG is stored in a portable storage medium 202 (for example, an SSD or a USB memory) which is a computer-readable non-transitory storage medium.

The program PG stored in the storage medium 202 is installed in the computer 200. The processor 200A executes the control processing (see FIG. 17) in accordance with the program PG.

In addition, the program PG may be stored in a storage device of another computer or server device connected to the computer 200 via a communication network (not shown), and the program PG may be downloaded in response to a request from the control device 30 and installed in the computer 200. The program PG is an example of a “program” according to the technology of the present disclosure, and the computer 200 is an example of a “computer” according to the technology of the present disclosure.

In the example shown in FIG. 41, although the computer 200 has been described as an example, the technology of the present disclosure is not limited to this, and a device including an ASIC, an FPGA, and/or a PLC may be applied instead of the computer 200. In addition, instead of the computer 200, a hardware configuration and a software configuration may be used in combination.

As the hardware resource for executing the processing of the control device 30 (see FIG. 3), various processors shown below can be used. Examples of the processor include the CPU which is a general-purpose processor functioning as the hardware resource for executing the processing by executing software, that is, a program. In addition, examples of the processor include a dedicated electronic circuit which is a processor having a circuit configuration designed to be dedicated to executing specific processing, such as an FPGA, a PLC, or an ASIC described as an example. A memory is incorporated or connected to any processor, and any processor executes the processing using the memory.

The hardware resource for executing the processing of the control device 30 and/or the servo writer controller SW5 may be composed of one of those various processors or may be composed of a combination of two or more processors of the same type or different types (for example, a combination of a plurality of FPGAs or a combination of a CPU and an FPGA). In addition, the hardware resource for executing the processing of the control device 30 and/or the servo writer controller SW5 may be one processor.

A first example in which the hardware resource is composed of one processor is an aspect in which one or more CPUs and software are combined to constitute one processor and the processor functions as the hardware resource that executes the processing. Secondly, as typified by SoC, there is a form in which a processor that realizes the functions of the entire system including a plurality of hardware resources for executing the processing with one IC chip is used. As described above, the processing of the control device 30 and/or the servo writer controller SW5 is implemented by using one or more of the various processors described above as the hardware resource.

Further, as the hardware structure of these various processors, more specifically, it is possible to use an electronic circuit in which circuit elements, such as semiconductor elements, are combined. In addition, the processing of the control device 30 and/or the servo writer controller SW5 is merely an example. Accordingly, it is possible to delete an unnecessary step, add a new step, or change a processing order without departing from the gist of the present disclosure.

The content of the above description and the content of the drawings are detailed explanations of the parts relating to the technology of the present disclosure, and are merely examples of the technology of the present disclosure. For example, description related to the above configurations, functions, actions, and effects is description related to an example of configurations, functions, actions, and effects of the parts relating to the technology of the present disclosure. Thus, it is needless to say that unnecessary portions may be deleted, new elements may be added, or replacement may be made to the content of the above description and the content of the drawings without departing from the gist of the technology of the present disclosure. In order to avoid complication and easily understand the parts relating to the technology of the present disclosure, in the content of the above description and the content of the drawings, the description regarding common general technical knowledge which is not necessarily particularly described in terms of embodying the technology of the present disclosure is omitted.

In the present specification, “A and/or B” is synonymous with “at least one of A or B”. That is, “A and/or B” may refer to A alone, B alone, or a combination of A and B. In addition, in the present specification, in a case where three or more matters are expressed with the connection of “and/or”, the same concept as “A and/or B” is applied.

All documents, patent applications, and technical standards mentioned in the present specification are incorporated herein by reference to the same extent as in a case in which each document, each patent application, and each technical standard are specifically and individually described by being incorporated by reference.

The disclosure of JP2022-073647 filed on Apr. 27, 2022 is incorporated herein by reference in its entirety.

The following appendices are further disclosed with respect to the above embodiment.

### Appendix 1

A signal processing device comprising:
a processor that acquires and processes data read by a magnetic head from a magnetic tape on which a plurality of servo bands are formed,
in which the plurality of servo bands are disposed at intervals in a width direction of the magnetic tape,
a plurality of servo patterns are formed in each of the plurality of servo bands along a longitudinal direction of the magnetic tape,
the magnetic head has a pair of servo reading elements corresponding to a pair of servo bands adjacent to each other in the width direction among the plurality of servo bands,
a first servo reading element included in the pair of servo reading elements reads the servo pattern included in a first servo band included in the pair of servo bands,
a second servo reading element included in the pair of servo reading elements reads the servo pattern included in a second servo band included in the pair of servo bands, and
the processor
   acquires a first signal based on a first result of reading the servo pattern in the first servo band via the first servo reading element while the first servo reading element is positioned on a reference region of the magnetic tape,
   acquires a second signal based on a second result of reading the servo pattern in the second servo band being via the second servo reading element while the second servo reading element is positioned on the reference region, and
   executes skew processing for a skew mechanism that skews the magnetic head based on a servo band interval signal corresponding to a servo band interval according to the first signal and the second signal, the skew processing being processing of skewing the magnetic head according to the servo band interval.

### Appendix 2

The signal processing device according to Appendix 1,
in which the servo band interval is used in common for a plurality of division areas obtained by dividing a data band in the width direction of the magnetic tape, and is a representative interval between a first servo pattern, which is the servo pattern in the first servo band of the pair of servo bands adjacent to each other via the data band, and a second servo pattern, which is the servo pattern in the second servo band of the pair of servo bands.

### Appendix 3

The signal processing device according to Appendix 2,
in which the representative interval is obtained by statistically processing results of measuring an interval between the firsta servo pattern and the second servo pattern for each of the division areas in a case where the magnetic tape is run.

### Appendix 4

The signal processing device according to Appendix 2 or 3,
in which the representative interval is obtained by statistically processing results of measuring an interval between the first servo pattern and the second servo pattern in a partial section of the division areas along a running direction of the magnetic tape for each of the division areas in a case where the magnetic tape is run.

### Appendix 5

The signal processing device according to Appendix 2 or 3,
in which the representative interval is obtained by statistically processing results of measuring an interval between the first servo pattern and the second servo pattern in an entire section of the division areas along a running direction of the magnetic tape for each of the division areas in a case where the magnetic tape is run.

### Appendix 6

The signal processing device according to any one of Appendices 2 to 5,
in which the representative interval is an average value of results of measuring an interval between the first servo pattern and the second servo pattern for each of the division areas in a case where the magnetic tape is run.

### Appendix 7

The signal processing device according to any one of Appendices 1 to 6,
in which the reference region is a BOT region.

### Appendix 8

The signal processing device according to any one of Appendices 1 to 7,
in which the processor stores the servo band interval signal in a storage medium.

### Appendix 9

The signal processing device according to Appendix 8,
in which the magnetic tape is accommodated in a magnetic tape cartridge,
the magnetic tape cartridge is provided with a noncontact storage medium that is able to perform communication in a noncontact manner, and
the storage medium includes the noncontact storage medium.

### Appendix 10

The signal processing device according to Appendix 8 or 9,
in which the storage medium includes a partial region of the magnetic tape.

What is claimed is:

1. A signal processing device comprising:
a processor that acquires and processes data read by a magnetic head from a magnetic tape on which a plurality of servo bands are formed,
wherein the plurality of servo bands are disposed at intervals in a width direction of the magnetic tape,
a plurality of servo patterns are formed in each of the plurality of servo bands along a longitudinal direction of the magnetic tape,
the magnetic head has a pair of servo reading elements corresponding to a pair of servo bands adjacent to each other in the width direction among the plurality of servo bands,
a first servo reading element included in the pair of servo reading elements reads the servo pattern included in a first servo band included in the pair of servo bands,
a second servo reading element included in the pair of servo reading elements reads the servo pattern included in a second servo band included in the pair of servo bands, and
the processor
acquires a first signal based on a first result of reading the servo pattern in the first servo band via the first servo reading element while the first servo reading element is positioned on a reference region of the magnetic tape,
acquires a second signal based on a second result of reading the servo pattern in the second servo band being via the second servo reading element while the second servo reading element is positioned on the reference region, and
executes skew processing for a skew mechanism that skews the magnetic head based on a servo band interval signal corresponding to a servo band interval according to the first signal and the second signal, the skew processing being processing of skewing the magnetic head according to the servo band interval.

2. The signal processing device according to claim 1,
wherein the servo band interval is used in common for a plurality of division areas obtained by dividing a data band in the width direction of the magnetic tape, and is a representative interval between a first servo pattern, which is the servo pattern in the first servo band of the pair of servo bands adjacent to each other via the data band, and a second servo pattern, which is the servo pattern in the second servo band of the pair of servo bands.

3. The signal processing device according to claim 2,
wherein the representative interval is obtained by statistically processing results of measuring an interval between the first servo pattern and the second servo pattern for each of the division areas in a case where the magnetic tape is run.

4. The signal processing device according to claim 2,
wherein the representative interval is obtained by statistically processing results of measuring an interval between the first servo pattern and the second servo pattern in a partial section of the division areas along a running direction of the magnetic tape for each of the division areas in a case where the magnetic tape is run.

5. The signal processing device according to claim 2,
wherein the representative interval is obtained by statistically processing results of measuring an interval between the first servo pattern and the second servo pattern in an entire section of the division areas along a running direction of the magnetic tape for each of the division areas in a case where the magnetic tape is run.

6. The signal processing device according to claim 2,
wherein the representative interval is an average value of results of measuring an interval between the first servo pattern and the second servo pattern for each of the division areas in a case where the magnetic tape is run.

7. The signal processing device according to claim 1,
wherein the reference region is a BOT region.

8. The signal processing device according to claim 1,
wherein the processor stores the servo band interval signal in a storage medium.

9. The signal processing device according to claim 8,
wherein the magnetic tape is accommodated in a magnetic tape cartridge,
the magnetic tape cartridge is provided with a noncontact storage medium that is able to perform communication in a noncontact manner, and
the storage medium includes the noncontact storage medium.

10. The signal processing device according to claim 8,
wherein the storage medium includes a partial region of the magnetic tape.

11. A magnetic tape drive in which skew processing is performed by the signal processing device according to claim 1.

12. A magnetic tape comprising:
a plurality of servo bands formed thereon,
wherein the plurality of servo bands are disposed at intervals in a width direction of the magnetic tape,
a plurality of servo patterns are formed in each of the plurality of servo bands along a longitudinal direction of the magnetic tape, and
servo band interval between a pair of servo bands adjacent to each other in the width direction among the plurality of servo bands corresponds to the servo band interval signal obtained from the signal processing device according to claim 1.

13. The magnetic tape according to claim 12,
wherein the servo band interval signal is stored in a partial region of the magnetic tape.

14. The magnetic tape according to claim 13,
wherein the partial region is a BOT region and/or an EOT region.

15. A magnetic tape cartridge comprising:
the magnetic tape according to claim 12 accommodated therein.

16. A magnetic tape cartridge comprising:
a noncontact storage medium that is able to perform communication in a noncontact manner,
wherein the servo band interval signal obtained from the signal processing device according to claim 1 is stored in the noncontact storage medium.

17. A signal processing method comprising:
acquiring and processing data read by a magnetic head from a magnetic tape on which a plurality of servo bands are formed,
wherein the plurality of servo bands are disposed at intervals in a width direction of the magnetic tape,
a plurality of servo patterns are formed in each of the plurality of servo bands along a longitudinal direction of the magnetic tape,
the magnetic head has a pair of servo reading elements corresponding to a pair of servo bands adjacent to each other in the width direction among the plurality of servo bands,
a first servo reading element included in the pair of servo reading elements reads the servo pattern included in a first servo band included in the pair of servo bands,
a second servo reading element included in the pair of servo reading elements reads the servo pattern included in a second servo band included in the pair of servo bands, and
the signal processing method includes
acquiring a first signal based on a first result of reading the servo pattern in the first servo band via the first servo reading element while the first servo reading element is positioned on a reference region of the magnetic tape,
acquiring a second signal based on a second result of reading the servo pattern in the second servo band via the second servo reading element while the second servo reading element is positioned on the reference region, and
executing skew processing for a skew mechanism that skews the magnetic head based on a servo band interval signal corresponding to a servo band interval according to the first signal and the second signal, the skew processing being processing of skewing the magnetic head according to the servo band interval.

18. A magnetic tape manufacturing method comprising:
recording the servo pattern in accordance with the servo band interval signal obtained from the signal processing device according to claim 1.

19. A magnetic tape on which the servo pattern is recorded in accordance with the servo band interval signal obtained by using the signal processing method according to claim 17.

20. A magnetic tape manufacturing method comprising:
recording the servo pattern on a magnetic tape in accordance with the servo band interval signal obtained by using the signal processing method according to claim 17.

21. A non-transitory computer-readable storage medium storing a program executable by a computer to execute signal processing comprising:
acquiring and processing data read by a magnetic head from a magnetic tape on which a plurality of servo bands are formed,
wherein the plurality of servo bands are disposed at intervals in a width direction of the magnetic tape,
a plurality of servo patterns are formed in each of the plurality of servo bands along a longitudinal direction of the magnetic tape,
the magnetic head has a pair of servo reading elements corresponding to a pair of servo bands adjacent to each other in the width direction among the plurality of servo bands,
a first servo reading element included in the pair of servo reading elements reads the servo pattern included in a first servo band included in the pair of servo bands,
a second servo reading element included in the pair of servo reading elements reads the servo pattern included in a second servo band included in the pair of servo bands, and
the signal processing includes
acquiring a first signal based on a first result of reading the servo pattern in the first servo band via the first servo reading element while the first servo reading element is positioned on a reference region of the magnetic tape,
acquiring a second signal based on a second result of reading the servo pattern in the second servo band via the second servo reading element while the second servo reading element is positioned on the reference region, and
executing skew processing for a skew mechanism that skews the magnetic head based on a servo band interval signal corresponding to a servo band interval according to the first signal and the second signal, the skew processing being processing of skewing the magnetic head according to the servo band interval.
